(19) United States
(12) Patent Application Publication
(10) Pub. No.: US 2008/0281238 A1
(43) Pub. Date: Nov. 13, 2008

(54) Oscillation representing system for effectively applying hypersonic sound

(76) Inventors: Tsutomu Oohashi, Tokyo (JP); Norie Kawai, Tokyo (JP); Emi Nishina, Tokyo (JP); Manabu Honda, Tokyo (JP); Tadao Maekawa, Tokyo (JP); Masako Morimoto, Tokyo (JP); Reiko Yagi, Tokyo (JP); Osamu Ueno, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/878,284

(22) Filed: Jul. 23, 2007

(30) Foreign Application Priority Data
May 9, 2007 (JP) 2007-124576

(51) Int. Cl. A61H 1/00

(52) U.S. Cl. 601/46

(57) ABSTRACT

A vibration presenting system includes a first vibration applying device for applying a vibration that is generated by a first vibration source and has frequency components within an audible range perceivable as a sound by an auditory sense system of a living body to the auditory sense system of the living body, and a second vibration applying device for applying a vibration that is generated by a second vibration source different from the first vibration source and has superhigh frequency components exceeding the audible range unperceivable by the auditory sense system of the living body to a living body component region other than the auditory sense system of the living body. The living body component region other than the auditory sense system of the living body is a body surface of the living body, which may include a head thereof.

### BACKGROUND OF THE INVENTION

1. Field of the Invention

The present invention relates to an oscillation representing system or vibration presenting system for applying a hypersonic sound simply and effectively to a human being of a test human subject or the like.

2. Description of the Related Art

With regard to scientific researches of the work of human “mind”, a technique to measure the activities at the brain core that is the base of emotions and sensibilities with high accuracy and resolution is important and indispensable as a research apparatus. As a prior art to measure the activities of the human internal organs and the general organization intended for researches and medical treatments, there is a group of systems to utilize the radiation emitted from a minute amount of radioactive substance introduced into blood. Among others, a measurement apparatus (hereinafter referred to as a PET measurement apparatus) that uses a positron emission computed tomography (PET) developed comparatively recently has recently been introduced as adaptable to the demands of brain researches into many institutions since the information of the intended internal organs and the general organization can be simultaneously obtained with innovatively high accuracy and high spatial resolution.

In the PET measurement apparatus, a radioactive element that has a property of emitting positrons is produced by a radioactive nuclide producing apparatus (cyclotron) and introduced into an automatic synthesis apparatus to synthesize a variety of radioactive substances corresponding to the measurement purposes, and the element is introduced into the blood of the test human subject by injection (sometimes by an automatic unit) or inhalation. The test human subject lies on his or her side on a bed integrated with the measurement apparatus and puts his or her body in a cylindrical cavity in which a sensor is placed. The radiations emitted from the radioactive substance moving on the bloodstreams of the test human subject in places inside the body are caught and counted by the sensor of the measurement apparatus. The thus-obtained distribution data of the radioactive substance is imaged by computer processing. The information of small regions obtained by partitioning the body into rectangular parallelepipeds having sides of several millimeters on a millimeter level of the spatial resolution can be simultaneously obtained. In a brain function measurement, a distribution in the brain is measured normally by using radioactive water (H₂¹⁵O), and the amount of bloodstream in each brain region is calculated from the distribution. Since it has been discovered that the amount of bloodstream in each local brain region and the neural activity are correlated, the activeness of the neural activity in each brain region can be known from the bloodstream data. By thus producing a variety of conditions in the test human subject or imposing a task on the subject according to the purposes of researches and comparing and analyzing the amount of cerebral blood flow data measured on each condition, it can be known how and which brain regions the various works and states of “mind” are related to in activities. It is noted that the technique is applied also to animals (apes and the like in the practical range) other than human being.

FIG. 3 shows a state of a PET measurement room 1 including a PET measurement apparatus 10 according to a prior art example, in which a hypersonic sound (described in detail later) generated by a signal generator apparatus 15 is applied to a test human subject 12 on a bed 11 of the PET measurement apparatus 10 by using a supertweeter S1 and a full-range speaker S2. In this case, the bed 11 on which the test human subject 12 is placed on a bed support 10b of the PET measurement apparatus 10 is arranged movable in the depth direction of the PET measurement apparatus 10, and, for example, a head 12A of the test human subject is measured by the PET measurement apparatus 10.

FIG. 4 is a schematic block diagram showing an apparatus configuration of a PET measurement apparatus 20 according to a prior art example. Referring to FIG. 4, a detector ring 21 is provided generally in a center portion of the PET measurement apparatus 20, and an apparatus main unit power supply controlling module 22, a detector power supply module 23, radiation counting and calculating modules 24a and 24b, a trapped radiation quantity and elapsed time display 24c, calculating module power supplies 25a and 25b, operation panels 26a and 26b, a power switch 27, an apparatus main unit controlling board rack 28, an apparatus main unit inclination control motor 29, a drive motor 30, a calibration radiation source loading mechanism 30A, a calibration radiation source orbiting motor 31, cooling air supply fans 41, and fan motors 41m are provided surrounding the ring. In this case, cooling air from outside the PET measurement apparatus 20 is introduced to the inside by the cooling air supply fans 41 driven by the fan motors 41m to thereby cool the parts of the detector ring 21 and so on of the apparatus 20, and then, it is discharged as warm exhaust to the outside. The air-cooled PET measurement apparatus 20 is configured as above.

FIG. 5 is a block diagram showing a configuration of the functional unit of the PET measurement apparatus 20 of FIG. 4. Referring to FIG. 5, the detector ring 21 has such a configuration that a number of radiation detection elements are annularly arranged forming one layer, and a number of the layers are layered. The body of the test human subject who has introduced a test drug containing a radioisotope is inserted into a cavity provided at the center of the detector ring 21, and the ring catches and detects the radiation emitted from the inside of the body of the test human subject. Moreover, the radiation counting and calculating modules 24a and 24b receive and collect electrical signals transmitted every detection of individual radiation from the radiation detection elements of the detector ring 21, counts the radiation detection quantity to calculate the quantity of trapped radiation and executes calculation of a combination of the positions of the detection elements and detection timing to obtain the two-dimensional or three-dimensional position of the radiation source. The calculation data is transmitted to a data image calculating computer 35 that calculates the density distribution of the radioisotope and transforms it into image data.

The functions of the other modules are as follows. The calculating module power supplies 25a and 25b supply powers which are required for the radiation counting and calculating modules 24a and 24b. The trapped radiation quantity and elapsed time display 24c displays an elapsed time from the time point at which the detection of the radiation by the detector ring 21 is started and the quantity of the trapped radiation. A radiation shield plate drive motor 32 is a motor for driving a mechanism that is provided to insert or extract a radiation shield plate between the layers of the radiation detection elements of the detector ring so as to correspond with switchover between two radiograph imaging modes owned by the PET measurement apparatus 20. The operation panels 26a and 26b are manipulating sections for manipulating the control of the main unit of the PET measurement apparatus 20 and the test human subject support bed 11 to instruct all manipulations including the start and stop of the measurement, movement of the bed, adjustment and so on via the operation panels 26a and 26b and includes a power cutoff switch for emergency stop. The power switch 27 is used for turning on and off the power to the PET measurement apparatus 20. The apparatus main unit controlling board rack 28 is a controller such as a computer for controlling the main unit of the PET measurement apparatus 20 and a rack for retaining the controller. The detector power supply module 23 is a module for supplying power to the detector ring for catching and detecting radiation. The apparatus main unit inclination control motor 29 is a motor to be driven to incline the main unit of the PET measurement apparatus 20 when the major axis of the detector ring 21 is inclined with respect to the major axis of the body of the test human subject according to the imaging purpose. The apparatus main unit power supply controlling module 22 controls the overall power supply of the main unit of the PET measurement apparatus 20 and the test human subject supporting bed 11 and to supply powers to various modules other than the principal modules having special power supply modules.

Moreover, in the radiograph imaging by the PET measurement apparatus 20, it is necessary to perform calibration for each test human subject with regard to the degree of attenuation due to absorption of the radiation generated inside the body of the test human subject through the body tissues until reaching the radiation detection elements of the detector ring 21. The calibration radiation source orbiting motor 31 is a motor for orbiting a calibration radiation source that emits radiation with a definite intensity around the body of the test human subject for the purpose. The calibration radiation source loading mechanism 30A and its drive motor 30 are respectively an auto-mechanism provided for taking out the calibration radiation source from a storage casing made of a material that shields radiation, loading it into a carrier and placing it on a circular orbit at the time of calibration and withdrawing and storing the calibration radiation source after the calibration, and a motor for driving the mechanism.

The prior art reference documents related to the present invention are as follows:

Patent Document 1: Japanese patent laid-open publication No. JP-2005-106562 A;

Patent Document 2: Japanese patent laid-open publication No. JP-09-311610 A;

Patent Document 3: Japanese patent laid-open publication No. JP-2003-223174 A;

Patent Document 4: Japanese patent laid-open publication No. JP-2003-032768 A;

Non-Patent Document 1: Abbott and J. G. et al., “Rationale and derivation of MI and TI—a review”, Ultrasound in Medical Biology, Vol. 25, pp. 431-41, 1999;

Non-Patent Document 2: Alenghat and F. J. et al. “Mechanotransduction: all signals point to cytoskeleton, matrix, and integrins”, Science's Signal Transduction Knowledge Environment, Vol. 2002, pp. PE6, 2002;

Non-Patent Document 3: Cullari, S. et al., “music preferences and perception of loudness”, Perceptual and Motor Skills, Vol. 68, pp. 186, 1989;

Non-Patent Document 4: Douglas, P. R. et al., “Coding of information about tactile stimuli by neurones of the cuneate nucleus”, Journal of Physiology, Vol. 285, pp. 493-513, 1978;

Non-Patent Document 5: Duffy, F. H. et al., “Brain electrical activity mapping (BEAM): a method for extending the clinical utility of EEG and evoked potential data”, Annals of Neurology, Vol. 5, pp. 309-321, 1979;

Non-Patent Document 6: Durrant, J. D. et al., “Bases of hearing science”, Hagerstown, Lippincott Williams & Wilkins, 1977;

Non-Patent Document 7: Goldman, R. I. et al., “Simultaneous EEG and fMRI of the alpha rhythm”, Neuroreport, Vol. 13, pp. 2487-2492, 2002;

Non-Patent Document 8: Kanzaki, M. et al., “Molecular identification of a eukaryotic, stretch-activated nonselective cation flow path”, Science, Vol. 285, pp. 882-886, 1999;

Non-Patent Document 9: Lenhardt, M. L. et al., “Human ultrasonic speech perception”, Science, Vol. 253, pp. 82-85, 1991;

Non-Patent Document 10: Muraoka, T. et al., “Sampling-frequency considerations in digital audio”, Journal of Audio Engineering Society, Vol. 26, pp. 252-256, 1978;

Non-Patent Document 11: Nakamura, S. et al., “Electroencephalographic evaluation of the hypersonic effect”, Society for Neuroscience Abstract, pp. 752-814, 2004;

Non-Patent Document 12: Namba, S. et al., “Method of Psychological Measurement for Hearing Research (in Japanese)”, Colona Publishing, in Tokyo Japan, 1988;

Non-Patent Document 13: Oohashi, T. et al., “Multidisciplinary study on the hypersonic effect”, in Inter-areal coupling of human brain function, Shibasaki, H. et al. (Editors), Elsevier Science, Amsterdam. Netherlands, pp. 27-42, 2001;

Non-Patent Document 14: Oohashi, T. et al., “High-frequency sound above the audible range affects brain electric activity and sound perception”, in Proceedings of 91st Audio Engineering Society convention, New York, U.S.A., Audio Engineering Society, 1991;

Non-Patent Document 15: Oohashi, T. et al., “Inaudible high frequency sounds affect brain activity: hypersonic effect”, Journal of Neurophysiology, Vol. 83, pp. 3548-3558, June 2000;

Non-Patent Document 16: Plenge, G. H. et al., “Which bandwidth is necessary for optimal sound transmission”, in Proceedings of 62nd Audio Engineering Society convention”, Brussels, Audio Engineering Society, 1979;

Non-Patent Document 17: Role, L. W. et al., “The brain stem: Cranial nerve nuclei and the monoaminergic systems”, in Principle of Neural Science, Kandel, E. R. et al. (Editors), Appleton & Lange, Connecticut, U.S.A., pp. 869-883, 1991;

Non-Patent Document 18: Sadato, N. et al., “Neural networks for generation and suppression of alpha rhythm: a PET study”, Neuroreport, Vol. 9, pp. 893-897, 1988;

Non-Patent Document 19: Salek-Haddadi, A. et al., “Studying spontaneous EEG activity with fMRI. Brain Research”, Brain Research Reviews, Vol. 43, pp. 110-33, 2003;

Non-Patent Document 20: Snow, W. B., “Audible frequency ranges of music, speech and noise”, Journal of Acoustic Society of America, Vol. 3, pp. 155-166, 1931;

Non-Patent Document 21: Thompson, J. G., et al., “The psychobiology of emotions”, New York, Plenum Press. pp. 24-42, 1988;

Non-Patent Document 22: Ueno, S. et al., “Topographic display of slow wave types of EEG abnormality in patients with brain lesions”, Iyoudenshi To Seitai Kogaku (Medical Electronics and Biological Engineering), Vol. 14, pp. 118-124, 1976;

Non-Patent Document 23: Wegel, R. L., “The physical examination of hearing and binaural aids for deaf”, Proceedings of National Academy of Sciences of the United States of America, Vol. 8, pp. 155-160, 1922;

Non-Patent Document 24: Yagi, R. et al., “A method for behavioral evaluation of the “hypersonic effect””, Acoustic Science and Technology, Vol. 24, pp. 197-200, 2003;

Non-Patent Document 25: Yagi, R. et al., “Modulatory effect of inaudible high frequency sounds on human acoustic perception”, Neuroscience Letters, Vol. 351, pp. 191-195, 2003; and

Non-Patent Document 26: Yagi, R. et al., “Auditory Display for Deep Brain Activation: Hypersonic Effect”, in the 8th International Conference on Auditory Display 2002, Kyoto, 2002.

The present inventor and others discovered that a hypersonic sound, which was an unsteady sound abundantly containing superhigh frequency components exceeding the upper limit of the audible range, had the effect of increasing the amount of bloodstream in the brain core including the thalamus, the hypothalamus and the brain stem, exalting the brain wave a wave power of its index, reducing the stress, rationalizing the activities of the autonomic nerve system, the endocrine system and the immune system, sensitizing a sound as pleasant and beautiful, enhancing the sound listening behavior and totally improving the psychosomatic state (the effect being hereinafter referred to as a hypersonic effect) (See, for example, Non-Patent Documents 2 and 3). In this case, the hypersonic sound is an unsteady sound that has frequencies in a first frequency range of up to a prescribed maximum frequency (e.g., 150 kHz) exceeding the audible frequency range and fluctuations existing in a micro time region within 1 to 1/10 seconds in a second frequency range exceeding 10 kHz (or 20 kHz) and changes in the micro time region in the frequency component (hereinafter referred to as a superhigh frequency component (HFC)). In contrast to this, the frequency component lower than 20 kHz is referred to as an audible range component (LFC).

Further, the present inventor and others discovered that the operation of superhigh frequency vibration or oscillation inducing the hypersonic effect was transmitted to the inside of the body not via the air-conducting auditory system but the skin surface and produced an effect exerted on the brain and nerve systems. FIGS. 6A to 6C show experimental results. FIG. 6A is a graph showing a difference in the brain wave α2 potential between when an audible sound and a superhigh frequency vibration are presented and when only the audible sound is presented in such a case that the audible sound of the hypersonic sound is applied to the test human subject by a loudspeaker and its superhigh frequency vibration is applied to the test human subject by a loudspeaker. FIG. 6B is a graph showing a difference in the brain wave α2 potential between when the audible sound and the superhigh frequency vibration are presented and when only the audible sound is presented in such a case that the audible sound of the hypersonic sound is applied to the test human subject by a headphone and its superhigh frequency vibration is applied to the test human subject by a loudspeaker. FIG. 6C is a graph showing a difference in the brain wave α2 potential between when the audible sound and the superhigh frequency vibration are presented and when only the audible sound is presented in such a case that the audible sound of the hypersonic sound is applied to the test human subject by a headphone and its superhigh frequency vibration is applied to the test human subject by a headphone.

As is apparent from FIGS. 6A and 6B, it was discovered that the brain wave α2 potential was further exalted when the audible sound and the superhigh frequency vibration were simultaneously presented than when only the audible sound was singly presented in such a case that the superhigh frequency vibration was reproduced from the loudspeaker, i.e., the development of the hypersonic effect is confirmed. However, as is apparent from FIG. 6C, it was discovered that the hypersonic effect was not developed in the case of the presentation condition that both the audible sound and the superhigh frequency vibration were reproduced from the headphone.

In performing the brain function measurement by the PET measurement apparatus 20 in order to examine the brain regions related to the hypersonic effect, the present inventor and others recognized that the existing PET measurement apparatus 20 had the following properties inappropriate for the purpose on the basis of the knowledge described above.

(1) The apparatus itself generates ultra-wideband vibration noises exceeding two to four times the upper limit of the audible range, i.e., a superhigh frequency vibration that possibly generates the hypersonic effect with a high sound pressure level from the mechanisms (cooler, cooling fan, etc.) including a cooling system that consistently operates while the apparatus is electrified. The noise power often exceeds by 10 to 20 dB or more the superhigh frequency vibration presented to the test human subject for the purpose of generating the hypersonic effect during the measurement with regard to specific frequencies and propagates in the air or reaches the skin surface of the test human subject via the bed or the like. That is, the measurement space is contaminated by the intense superhigh frequency vibration attributed to the PET measurement apparatus 20, and the intense superhigh frequency vibration attributed to the apparatus is inputted as a noise component by the stimulus although the superhigh frequency vibration is not presented as an experimental condition, resulting in erroneously inducing unexpected hypersonic effect in the brain. For the above reasons, the measurement to examine the relation between the state of existence of the superhigh frequency vibration and the brain activation necessary for the researches cannot obtain clear results.

(2) Since the cylindrical cavity at the center of the measurement apparatus into which the test human subject puts his or her body is deep and the body of the test human subject is surrounded by the cylindrical structure, the sound waves presented to the test human subject are interrupted by the cylindrical structure and become hard to directly reach the body surface where the superhigh frequency vibration receptor mechanisms of the upper half of the body including the head are distributed. Moreover, the disadvantages as to the measurement of the “mind” due to the impairment of the comfortability, such as the occurrence of psychological biases of an oppressive feeling and so on in the test human subject and limitations in the view field cannot also be ignored.

Furthermore, electronic equipment that is optimum for the experiment described above in the PET measurement apparatus 20 and intended to simply effectively apply the hypersonic sound to a human being such as the test human subject is necessary, and new technology and apparatus that enables the measurement appropriate for the purpose by removing the obstructive factors described above need to be developed.

### SUMMARY OF THE INVENTION

An object of the present invention is to provide an oscillation representing system or vibration presenting system for simply effectively applying a hypersonic sound to a human being such as a test human subject.

According to the first aspect of the present invention, there is provided a vibration presenting system including first and second vibration applying devices. The first vibration applying device apples a vibration that is generated by a first vibration source and has frequency components within an audible range perceivable as a sound by an auditory sense system of a living body to the auditory sense system of the living body. The second vibration applying device applies a vibration that is generated by a second vibration source different from the first vibration source and has superhigh frequency components exceeding the audible range unperceivable by the auditory sense system of the living body to a living body component region other than the auditory sense system of the living body.

In the above-mentioned vibration presenting system, the living body component region other than the auditory sense system of the living body is a body surface of the living body.

In addition, in the above-mentioned vibration presenting system, the body surface of the living body includes a head of the living body.

Further, in the above-mentioned vibration presenting system, a cerebral blood flow at a fundamental brain, which is a region in charge of fundamental functions of a brain including a brain stem, a thalamus and a hypothalamus of the living body, increases as compared with such a case that no vibration is applied by the first vibration applying device and the second vibration applying device by applying the vibration that has the frequency components within the audible range by the first vibration applying device to the auditory sense system of the living body and applying the vibration that has the superhigh frequency components exceeding the audible range by the second vibration applying device to the living body component region regions other than the auditory sense system of the living body. On the other hand, the cerebral blood flow of the fundamental brain of the living body is lowered as compared with such a case that no vibration is applied by the first vibration applying device and the second vibration applying device when the vibration that has the frequency components within the audible range is applied by the first vibration applying device to the auditory sense system of the living body and the vibration that has the superhigh frequency components exceeding the audible range is not applied by the second vibration applying device to the living body component region regions other than the auditory sense system of the living body.

Furthermore, the above-mentioned vibration presenting system preferably further includes a detecting and analyzing device, and a first controlling device. The detecting and analyzing device detects the vibrations applied by the first vibration applying device and the second vibration applying device, analyzes structures of detected audible range frequency components and superhigh frequency vibration components, and outputs the analytical results. The first controlling device judges a degree of risk of a decline in the cerebral blood flow of the fundamental brain of the living body, and then, performs one of outputting a warning on the basis of the judgment results, and controlling the first and second vibration applying devices.

In addition, the above-mentioned vibration presenting system preferably further includes a measuring device, an analyzing device, and a second controlling device. The measuring device measures a responsive reaction of the living body that responds to the vibration applied to the living body by the first vibration applying device and the second vibration applying device. The analyzing device analyzes the responsive reaction measured by the measuring device, and outputs the analytical results. The second controlling device judges a degree of risk of a decline in the cerebral blood flow of the fundamental brain of the living body, and then, performs one of outputting a warning on the basis of the judgment results, and controlling the first and second vibration applying devices.

Further, in the above-mentioned vibration presenting system, the first vibration applying device prevents a risk of a decline in the cerebral blood flow of the fundamental brain of the living body when a trouble occurs in the second vibration applying device by further generating at least a partial component of the vibration that has the superhigh frequency components exceeding the audible range and applying the component to the living body.

Furthermore, in the above-mentioned vibration presenting system, the second vibration applying device allows the living body to recognize by auditory that a trouble has occurred in the second vibration applying device by further generating at least a partial component of the frequency components that have a frequency range in the audible range, thereby preventing a risk of a decline in the cerebral blood flow of the fundamental brain of the living body.

According to the second aspect of the present invention, there is provided a vibration presenting system includes first and second vibration applying devices. The first vibration applying device applies a vibration that has frequency components within an audible range perceivable as a sound by an auditory sense system of a living body to living body component regions including the auditory sense system of the living body. The second vibration applying device applies a vibration that has superhigh frequency components exceeding the audible range unperceivable as a sound by the auditory sense system of the living body to living body component regions (excluding a head) including at least part of the body (excluding the head) of the living body.

In the above-mentioned vibration presenting system, the activity of the fundamental brain, which is a region in charge of fundamental functions of a brain including a brain stem, a thalamus and a hypothalamus of the living body, is increased by applying the vibration that has the superhigh frequency components exceeding the audible range to at least part of the body (excluding the head) of the living body by the second vibration applying device.

In addition, in the above-mentioned vibration presenting system, the vibration applied by the first vibration applying device is generated by a first vibration source, and the vibration applied by the second vibration applying device is generated by a second vibration source different from the first vibration source.

Accordingly, the vibration presenting system of the present invention includes the first vibration applying device for applying a vibration that is generated by a first vibration source and has frequency components within the audible range perceivable as a sound by the auditory sense system of the living body to the auditory sense system of the living body, and the second vibration applying device for applying a vibration that is generated by a second vibration source different from the first vibration source and has superhigh frequency components exceeding the audible range unperceivable by the auditory sense system of the living body to a living body component region other than the auditory sense system of the living body. By presenting the two kinds of vibrations preferably simultaneously to the living body by using the two vibration applying devices, a hypersonic effect can be effectively enjoyed by the mutual interaction.

Moreover, the vibration presenting system of the present invention includes a first vibration applying device for applying a vibration that has frequency components within the audible range perceivable as a sound by the auditory sense system of the living body to living body component regions including the auditory sense system of the living body, and a second vibration applying device for applying a vibration that has superhigh frequency components exceeding the audible range that is unperceivable as a sound by the auditory sense system of the living body to living body component regions (excluding the head) including at least part of the body (excluding the head) of the living body. By presenting the two kinds of vibrations preferably simultaneously to the living body by using the two vibration applying devices, a hypersonic effect can be effectively enjoyed by the mutual interaction.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a schematic view showing such a state that a hypersonic sound from a signal generator apparatus 15 is applied to a test human subject 12 on a bed 11 of a PET measurement apparatus 10A by a supertweeter S1 and a full-range speaker S2 in a PET measurement room 1 including the PET measurement apparatus 10A according to a first preferred embodiment of the present invention;

FIG. 2 is a schematic view showing such a state that the hypersonic sound from the signal generator apparatus 15 is applied to the test human subject 12 on a bending seat 13 of the PET measurement apparatus 10A by the supertweeter S1 and the full-range speaker S2 in the PET measurement room 1 including the PET measurement apparatus 10A according to a modified preferred embodiment of the first preferred embodiment of the present invention;

FIG. 3 is a schematic view showing such a state that the hypersonic sound from the signal generator apparatus 15 is applied to the test human subject 12 on the bed 11 of the PET measurement apparatus 10 by the supertweeter S1 and the full-range speaker S2 in the PET measurement room 1 including a PET measurement apparatus 10 according to a prior art example;

FIG. 4 is a schematic block diagram showing an apparatus configuration of a PET measurement apparatus 20 according to a prior art example;

FIG. 5 is a block diagram showing a configuration of the functional unit of the PET measurement apparatus 20 of FIG. 4;

FIG. 6A is a graph of experimental results of the prior art, showing a difference in the brain wave α2 potential between when an audible sound and superhigh frequency vibration are presented and when only the audible sound is presented in such a case that the audible sound of the hypersonic sound is applied to the test human subject by a loudspeaker and its superhigh frequency vibration is applied to the test human subject by a loudspeaker;

FIG. 6B is a graph of experimental results of the prior art, showing a difference in the brain wave α2 potential between when the audible sound and the superhigh frequency vibration are presented and when only the audible sound is presented in such a case that the audible sound of the hypersonic sound is applied to the test human subject by a headphone and its superhigh frequency vibration is applied to the test human subject by the loudspeaker;

FIG. 6C is a graph of experimental results of the prior art, showing a difference in the brain wave α2 potential between when the audible sound and the superhigh frequency vibration are presented and when only the audible sound is presented in such a case that the audible sound of the hypersonic sound is applied to the test human subject by the headphone and its superhigh frequency vibration is applied to the test human subject by the headphone;

FIG. 7 is a schematic block diagram of a PET measurement apparatus 20A according to a second preferred embodiment of the present invention;

FIG. 8 is a schematic block diagram of a PET measurement apparatus 20B according to a first modified preferred embodiment of the second preferred embodiment of the present invention;

FIG. 9 is a schematic block diagram of a PET measurement apparatus 20C according to a second modified preferred embodiment of the second preferred embodiment of the present invention;

FIG. 10A is a graph of experimental results disclosed in Non-Patent Document 15, showing an amount of cerebral blood flow when sounds of various frequency components are applied to the brain stem of the test human subject;

FIG. 10B is a graph of experimental results disclosed in Non-Patent Document 15, showing an amount of cerebral blood flow when sounds of various frequency components are applied to the thalamus of the test human subject;

FIG. 11 is a spectrum chart showing a frequency response of an audio signal reproduced by a signal reproducing apparatus according to a third preferred embodiment of the present invention;

FIG. 12 is a block diagram showing a configuration of a signal reproducing apparatus according to the third preferred embodiment of the present invention;

FIG. 13 is a block diagram showing a configuration of a signal recording and reproducing apparatus according to a first modified preferred embodiment of the third preferred embodiment of the present invention;

FIG. 14 is a block diagram showing a configuration of a signal recording and reproducing apparatus according to a second modified preferred embodiment of the third preferred embodiment of the present invention;

FIG. 15 is a block diagram showing a configuration of a signal recording and reproducing system according to an implemental example 1 of the third preferred embodiment of the present invention;

FIG. 16 is a block diagram showing a configuration of a signal recording and reproducing system according to an implemental example 2 of the third preferred embodiment of the present invention;

FIG. 17 is a graph of experimental results of the prior art, showing a difference in the brain wave α2 potential between when the audible sound and the superhigh frequency vibration are presented and when only the audible sound is presented in such a case that the audible sound of the hypersonic sound is applied to the test human subject by a headphone and its superhigh frequency vibration is applied by a headphone to the test human subject whose body is wholly acoustically insulated;

FIG. 18A is an appearance diagram and a block diagram showing a configuration of a signal reproducing apparatus 90 of a cap mounting type according to a fourth preferred embodiment of the present invention;

FIG. 18B is an appearance diagram and a block diagram showing a configuration of a signal reproducing apparatus 90a of an eyeglass mounting type according to the fourth preferred embodiment of the present invention;

FIG. 19 is a block diagram showing a configuration of a signal recording and reproducing apparatus 90A according to a first modified preferred embodiment of the fourth preferred embodiment of the present invention;

FIG. 20 is a block diagram showing a configuration of a signal recording and reproducing apparatus 90B according to a second modified preferred embodiment of the fourth preferred embodiment of the present invention;

FIG. 21 is an appearance diagram and a block diagram showing a configuration of a headphone according to a fifth preferred embodiment of the present invention;

FIG. 22 is a block diagram showing a configuration of a signal reproducing apparatus used in the headphone of FIG. 21;

FIG. 23 is an appearance diagram and a block diagram showing a configuration of a signal reproducing apparatus of the cap mounting type according to a first modified preferred embodiment of the fifth preferred embodiment of the present invention;

FIG. 24 is a block diagram showing a configuration of a signal reproducing apparatus 131 of FIG. 23;

FIG. 25 is an appearance diagram and a block diagram showing a configuration of a signal reproducing apparatus of the eyeglass mounting type according to a second modified preferred embodiment of the fifth preferred embodiment of the present invention;

FIG. 26 is a block diagram showing a configuration of the portable signal reproducing apparatus 140 of FIG. 25;

FIG. 27A is a front view of a broach 160 including a signal reproducing apparatus according to a sixth preferred embodiment of the present invention;

FIG. 27B is a right side view of the broach 160;

FIG. 27C is a rear view of the broach 160;

FIG. 28A is an appearance diagram of a bracelet 170 including a signal reproducing apparatus according to a seventh preferred embodiment of the present invention;

FIG. 28B is a side view of the bracelet 170;

FIG. 29A is a front view of an earring 180 including a signal reproducing apparatus according to an eighth preferred embodiment of the present invention;

FIG. 29B is a right side view of the earring 180;

FIG. 29C is a rear view of the earring 180;

FIG. 30A is a front view of a barrette 190 including a signal reproducing apparatus according to a ninth preferred embodiment of the present invention;

FIG. 30B is a rear view of the barrette 190;

FIG. 30C is a top view of the barrette 190;

FIG. 31 is a block diagram showing a configuration of a signal reproducing apparatus 200 of FIGS. 27A to 27C, FIGS. 28A to 28C, FIGS. 29A to 29C and FIGS. 30A to 30C;

FIG. 32A is a front view showing a external surface of a shirt 210 including a signal reproducing apparatus 200 according to a tenth preferred embodiment of the present invention;

FIG. 32B is a front view showing an internal surface of the shirt 210;

FIG. 33A is a front view showing a external surface and the lower surface (body contact surface) of an ordinary type bedclothing (rug, blanket) 230A including a signal reproducing apparatus 200 according to an eleventh preferred embodiment of the present invention;

FIG. 33B is a front view showing a external surface and the lower surface (body contact surface) of a neckline type bedclothing (rug, blanket) 230B including the signal reproducing apparatus 200 according to the tenth preferred embodiment of the present invention;

FIG. 33C is a front view showing a external surface and the lower surface (body contact surface) of a reversible bedclothing (rug, blanket) 230C including the signal reproducing apparatus 200 according to the tenth preferred embodiment of the present invention;

FIG. 34 is an appearance diagram of a pillow 240 including a signal reproducing apparatus 200 according to a twelfth preferred embodiment of the present invention;

FIG. 35A is a top view of a bed 250 including a signal reproducing apparatus 200 according to a thirteenth preferred embodiment of the present invention;

FIG. 35B is a right side view of the bed 250;

FIG. 35C is a front view of the bed 250;

FIG. 36 is a block diagram showing a configuration of a signal recording and reproducing system according to an implemental example 1 of the present invention;

FIG. 37A is a spectrum chart showing an electrical signal of a sound source in the signal recording and reproducing system of FIG. 36;

FIG. 37B is a spectrum chart of a sound via a loudspeaker system in the signal recording and reproducing system;

FIG. 37C is a spectrum chart of an attenuated superhigh frequency component (HFC) via the loudspeaker system in the signal recording and reproducing system;

FIG. 37D is a spectrum chart of a sound via an earphone system in the signal recording and reproducing system;

FIG. 38A is a graph of experimental results of the signal recording and reproducing system of FIG. 36, showing a normalized power of αEEG, a listening level and a comfortable listening level (ΔCLL) when the audible range component (LFC) is applied to the test human subject via the loudspeaker system and the superhigh frequency component (HFC) is applied to the test human subject via the earphone system;

FIG. 38B is a graph of experimental results of the signal recording and reproducing system of FIG. 36, showing a normalized power of αEEG, the listening level and the comfortable listening level (ΔCLL) when the audible range component (LFC) is applied to the test human subject via the earphone system and the superhigh frequency component (HFC) is applied to the test human subject via the earphone system;

FIG. 38C is a graph of experimental results of the signal recording and reproducing system of FIG. 36, showing a normalized power of αEEG, the listening level and the comfortable listening level (ΔCLL) when the audible range component (LFC) is applied to the test human subject via the earphone system and the superhigh frequency component (HFC) is applied to the test human subject via the loudspeaker system;

FIG. 38D is a graph of experimental results of the signal recording and reproducing system of FIG. 36, showing a normalized power of αEEG, the listening level and the comfortable listening level (ΔCLL) when the audible range component (LFC) is applied to the test human subject via the earphone system and the superhigh frequency component (HFC) is applied to the acoustically insulated test human subject via the loudspeaker system;

FIG. 39 is a view showing a Z score (lower part of the figure shows a gray scale of the Z score) of an α2 band component intensity in the head of the test human subject in the case of FIG. 38A;

FIG. 40 is a view showing a Z score (lower part of the figure shows a gray scale of the Z score) of the α2 band component intensity in the head of the test human subject in the case of FIG. 38B;

FIG. 41 is a view showing a Z score (lower part of the figure shows a gray scale of the Z score) of the α2 band component intensity in the head of the test human subject in the case of FIG. 38C;

FIG. 42 is a view showing a Z score (lower part of the figure shows a gray scale of the Z score) of the α2 band component intensity in the head of the test human subject in the case of FIG. 38D;

FIG. 43A is a spectrum chart of the electrical signal of the sound source used for the experiment, showing a experimental results by the PET measurement apparatus according to a prior art example;

FIG. 43B is a spectrum chart of the electrical signal in the listening position of the experiment, showing a experimental results by the PET measurement apparatus according to a prior art example;

FIG. 43C is a graph showing an adjusted rCBF with respect to various sounds in the brain stem of the test human subject, or the experimental results by the PET measurement apparatus according to a prior art example;

FIG. 43D is a graph showing an adjusted rCBF with respect to various sounds in the thalamus of the test human subject, or the experimental results by the PET measurement apparatus according to a prior art example;

FIG. 44A is a spectrum chart of the electrical signal of the sound source used for the experiment, showing an experimental results by the PET measurement apparatus of FIG. 1 according to the first preferred embodiment;

FIG. 44B is a spectrum chart of the electrical signal in the listening position of the experiment, showing a experimental results by the PET measurement apparatus of FIG. 1 according to the first preferred embodiment;

FIG. 44C is a graph showing an adjusted rCBF with respect to various sounds in the brain stem of the test human subject, or the experimental results by the PET measurement apparatus of FIG. 1 according to the first preferred embodiment;

FIG. 44D is a graph showing an adjusted rCBF with respect to various sounds in the thalamus of the test human subject, or the experimental results by the PET measurement apparatus of FIG. 1 according to the first preferred embodiment;

FIG. 45 is a graph of experimental results concerning the hypersonic sound by the inventor and others, showing a change in the degree of the hypersonic effect when the superhigh frequency component in the hypersonic sound is boosted and an average value (α-EEG) of five occipital electrodes of the brain wave a wave potential;

FIG. 46 is a graph of experimental results concerning the hypersonic sound by the inventor and others, showing a change in the degree of the hypersonic effect when the superhigh frequency component in the hypersonic sound is boosted and an audible sound listening volume as the result of an adjustment action;

FIG. 47 is a block diagram showing a configuration of a PET measurement apparatus 10B according to a fourteenth preferred embodiment of the present invention;

FIG. 48 is a block diagram showing an implemental example in the case of optical signal wired transmission in the PET measurement apparatus 10B of FIG. 47;

FIG. 49 is a block diagram showing an implemental example in the case of electrical signal wired transmission in the PET measurement apparatus 10B of FIG. 47;

FIG. 50 is a block diagram showing an implemental example in the case of electrical signal wireless transmission in the PET measurement apparatus 10B of FIG. 47;

FIG. 51 is a block diagram showing a configuration of a PET measurement apparatus 10C according to a fifteenth preferred embodiment of the present invention;

FIG. 52A is a block diagram showing a detailed configuration of the PET measurement apparatus 10C of FIG. 51;

FIG. 52B is a block diagram showing a detailed configuration of a brain wave measurement apparatus 500 of FIG. 51;

FIG. 52C is a block diagram showing a detailed configuration of a vibration presenting system 600 of FIG. 51;

FIG. 53 is a block diagram showing a configuration of a PET measurement apparatus 10D according to a sixteenth preferred embodiment of the present invention;

FIG. 54A is a block diagram showing a detailed configuration of the PET measurement apparatus 10D of FIG. 53;

FIG. 54B is a block diagram showing a detailed configuration of a magneto-encephalographic measurement apparatus 700 of FIG. 53;

FIG. 55 is a block diagram showing a configuration of a PET measurement apparatus 10E according to a seventeenth preferred embodiment of the present invention;

FIG. 56 is a block diagram showing a detailed configuration of the PET measurement apparatus 10E of FIG. 55;

FIG. 57 is a block diagram showing a configuration when a plurality of test human subjects 12 are subjected to PET measurement by a high frequency supra-perceptive vibration reproducing apparatus 800 according to an eighteenth preferred embodiment of the present invention;

FIG. 58 is a block diagram showing a configuration when a plurality of test human subjects 12 are subjected to PET measurement by using a high frequency supra-perceptive vibration reproducing apparatus 800 according to a nineteenth preferred embodiment of the present invention;

FIG. 59 is a block diagram showing a configuration when a plurality of test human subjects 12 are subjected to PET measurement in a train car by using a high frequency supra-perceptive vibration reproducing apparatus 800 according to a twentieth preferred embodiment of the present invention;

FIG. 60 is an appearance diagram showing a configuration of a headset 820 with a high frequency supra-perceptive vibration generator apparatus 830, a sheet type vibration emitter 831 and a mobile phone 840 with a high frequency supra-perceptive vibration generator apparatus 830 according to a twenty-first preferred embodiment of the present invention;

FIG. 61 is an appearance diagram showing a configuration of an earphone 821 with a high frequency supra-perceptive vibration generator apparatus 830 and a portable music player 850 with a high frequency supra-perceptive vibration generator apparatus 830 according to a twenty-second preferred embodiment of the present invention;

FIG. 62 is an appearance diagram showing a configuration of a pendant type high frequency supra-perceptive vibration generator apparatus 830p according to a twenty-third preferred embodiment of the present invention;

FIG. 63 is an appearance diagram showing a configuration of a high frequency supra-perceptive vibration generator apparatus employing a piezoelectric fiber 836 according to a twenty-fourth preferred embodiment of the present invention;

FIG. 64 is a block diagram showing a configuration of a high frequency supra-perceptive vibration presenting system 860 for a test human subject 12 in a bathtub 860C according to a twenty-fifth preferred embodiment of the present invention;

FIG. 65 is an appearance diagram showing a configuration of a high frequency supra-perceptive vibration generator apparatus employing a skin-contact type superhigh frequency emitter 832a according to a twenty-sixth preferred embodiment of the present invention;

FIG. 66 is an appearance diagram and a sectional view showing a configuration of a high frequency supra-perceptive vibration generator apparatus employing a sheet type supra-perspective vibration emitter 832s inserted in a nasal cavity 12c of the test human subject 12 according to a twenty-seventh preferred embodiment of the present invention;

FIG. 67 is an appearance diagram and a sectional view showing a configuration of a capsule type vibration generator system 830c used by being administered in the body of the test human subject 12 according to a twenty-eighth preferred embodiment of the present invention;

FIG. 68 is an appearance diagram and a sectional view showing a configuration of a toffee type vibration generator system 830a used by being administered in the body of the test human subject 12 according to a twenty-ninth preferred embodiment of the present invention;

FIG. 69 is an appearance diagram and a sectional view showing a configuration of a particulate type vibration presentation apparatus used by being administered in the body of the test human subject 12 according to a thirtieth preferred embodiment of the present invention;

FIG. 70 is a schematic view showing one example of the superhigh frequency reproducing apparatus 860a according to an implemental example 3 of the present invention;

FIG. 71 is a table showing a relation between an aural listening audible range music and an inaudible corporeal listening superhigh frequency opus according to the implemental example 3 of FIG. 70;

FIG. 72A is a graph showing an adjusted rCBF value in the brain stem, or the experimental results in the implemental example 3 of FIG. 70;

FIG. 72B is a graph showing an adjusted rCBF value in the left thalamus, or the experimental results in the implemental example 3 of FIG. 70;

FIG. 73A is an appearance diagram showing a configuration of a loudspeaker 870 used in a thirty-first preferred embodiment of the present invention;

FIG. 73B is a graph showing a frequency response of a supertweeter 871 in charge of an inaudible superhigh frequency range of FIG. 73A;

FIG. 73C is a graph showing a frequency response of a squawker 872 in charge of an audible range of FIG. 73A;

FIG. 73D is a graph showing a frequency response of a woofer 873 in charge of an audible range of FIG. 73A;

FIG. 74 is a block diagram showing an implemental example of a superhigh frequency vibration monitoring system with a feedback control mechanism by sound structure information according to a thirty-second preferred embodiment of the present invention;

FIG. 75 is a block diagram showing a detailed configuration of the superhigh frequency vibration monitoring system of FIG. 74;

FIG. 76 is a flow chart showing a first part of the detailed processing of the superhigh frequency vibration monitoring system of FIG. 74;

FIG. 77 is a flow chart showing a second part of the detailed processing of the superhigh frequency vibration monitoring system of FIG. 74;

FIG. 78 is a flow chart showing a third part of the detailed processing of the superhigh frequency vibration monitoring system of FIG. 74;

FIG. 79 is a block diagram showing an implemental example of a superhigh frequency vibration monitoring system with a feedback control mechanism by deep brain region activation information according to a thirty-third preferred embodiment of the present invention;

FIG. 80 is a block diagram showing a detailed configuration of the superhigh frequency vibration monitoring system of FIG. 79;

FIG. 81 is a block diagram showing a configuration when a plurality of test human subjects 12 are subjected to PEI measurement in a car by using high frequency supra-perceptive vibration reproducing apparatuses 800a, 800b, 800c according to a thirty-fourth preferred embodiment of the present invention;

FIG. 82 is an appearance diagram and a sectional view showing a configuration of a vibration presenting system embedded in a muscle 12k of a test human subject 12 according to a thirty-fifth preferred embodiment of the present invention;

FIG. 83 is a graph of an implemental example according to a thirty-sixth performed embodiment of the present invention, showing a measurement results of the deep brain activity index (DBA-index) averaged in last half 200 seconds after presentation for 400 seconds when a gamelan music containing a superhigh frequency is presented to the human body lower than the neck and when the gamelan music including a superhigh frequency is presented to the head;

FIG. 84 is an appearance diagram and a sectional view of a vibration presenting system of a bodysuit 951 having a plurality of superhigh frequency emitters 832a according to a thirty-seventh preferred embodiment of the present invention;

FIG. 85 is an appearance diagram of a sauna type vibration presenting system having a plurality of superhigh frequency emitters 952a according to a thirty-eighth preferred embodiment of the present invention;

FIG. 86 is an appearance diagram of a sleeping bag type vibration presenting system having a plurality of superhigh frequency emitters 953a according to a thirty-ninth preferred embodiment of the present invention;

FIG. 87 is a partially removed appearance diagram of a driver's seat of a car 954 having a plurality of superhigh frequency vibration presenting systems 954a to 954d according to a fortieth preferred embodiment of the present invention;

FIG. 88 is an appearance diagram and a sectional view of a plurality of shower type vibration presenting systems according to a forty-first preferred embodiment of the present invention;

FIG. 89 is an appearance diagram of a bone-conducting headphone 956 and a necklace type superhigh frequency vibration presenting system according to a forty-second preferred embodiment of the present invention;

FIG. 90 is an appearance diagram and a sectional view of a piezoelectric fiber material clothing type superhigh frequency vibration presenting system according to a forty-third preferred embodiment of the present invention; and

FIGS. 91A and 91B are views showing portions to which vibration should be applied by the vibration applying apparatus of the present invention and implemental examples of the vibration applying apparatuses corresponding to the portions.

### DETAILED DESCRIPTION OF THE PREFERRED EMBODIMENTS

Preferred embodiments of the present invention will be described below with reference to the drawings. It is noted that like components are denoted by like numerals in each of the preferred embodiments.

### First Preferred Embodiment

FIG. 1 is a schematic view showing such a state that a hypersonic sound from a signal generator apparatus 15 is applied to a test human subject 12 on a bed 11 of a PET measurement apparatus 10A by a supertweeter S1 and a full-range speaker S2 of a PET measurement room 1 including the PET measurement apparatus 10A according to the first preferred embodiment of the present invention.

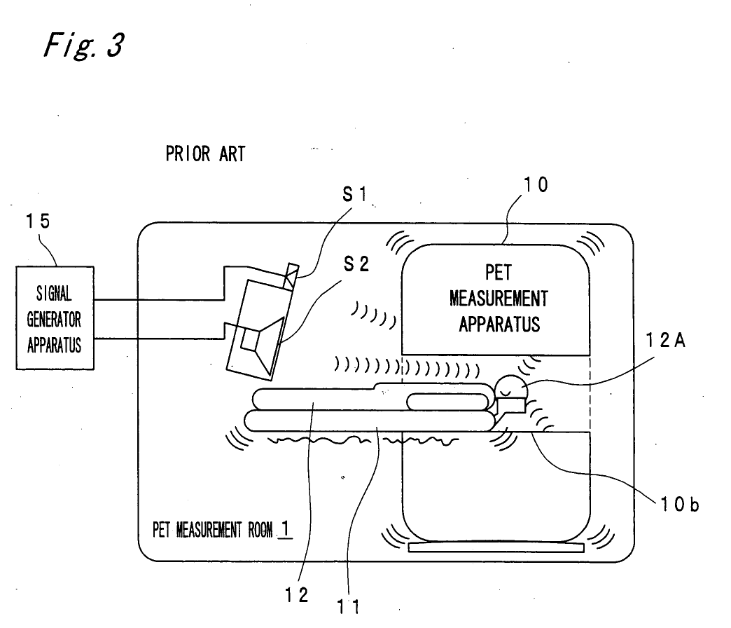

Referring to FIG. 1, the PET measurement apparatus 10A of the first preferred embodiment is installed in the PET measurement room 1. The PET measurement apparatus 10A is characterized in that the length in the movement direction of the bed 11 (i.e., a depth direction of the apparatus) is shortened as compared with the prior art example of FIG. 3, the external surface of the housing of the PET measurement apparatus 10A is covered with a vibration insulating material 10a, and further the lower rear surface of the bed 11 is formed of a vibration insulating member 11a. A superhigh frequency vibration sound exceeding, for example, 20 kHz of a hypersonic sound generated by the signal generator apparatus 15 is applied to (particularly his or her head 12A on the test human subject 12 on the bed 11 via the supertweeter S1, and an audible range component or a low frequency component (LFC) lower than, for example, 20 kHz is applied to (in particular, his or her head 12A of) the test human subject 12 on the bed 11 via the full-range speaker S2. In the above state, the bed 11 is moved so that the head 12A of the test human subject 12 is positioned in the detector ring of the PET measurement apparatus 10A. In the first preferred embodiment, the hypersonic sounds emitted from the loudspeakers S1 and S2 are directly applied to the head 12A of the test human subject by shortening the depth of the apparatus as compared with the prior art example and enlarging the opening of the detector ring as compared with the prior art example. Moreover, the degree that the head 12A to the upper half of the body of the test human subject is covered with the apparatus 10A can be sufficiently reduced.

In the first preferred embodiment, the main unit housing (registered trademark) is covered with a vibration insulating material 10a and a vibration insulating member 11a (hereinafter referred to as a vibration insulating material and the like), preventing the internal vibration from leaking to the outside. The vibration insulating material and the like is the material for the sound insulation and vibration control, and the required minimum conditions are the following two points. In this case, the candidate materials considered to conform to the conditions are additionally indicated.

(1) The materials must have the performances of sufficiently insulating and suppressing the noise vibration. The candidate materials are foamed polyurethane resin, foamed polypropylene resin, foamed phenol resin and so on. Among these, the soft materials such as foamed polyurethane are considered to be used for parts such as a mat that comes in contact with the body of the test human subject to support the test human subject, and the materials that have hardness such as foamed polypropylene and foamed phenol (used for core materials of the impact absorption parts of passenger cars and so on) are considered to be used for the cover shell of the apparatus main unit. The latter is considered to further improve the sound insulation property by being formed into a two-layer structure with interposition of an air layer.

(2) The materials must permit the penetration of gamma rays and be not deteriorated by the rays. The candidate materials are polyethylene terephthalate resin (PET), gamma ray proof polyvinylchloride resin and so on. Since the gamma rays have the highest penetrating power among radiations, there are few materials that obstruct the purpose of the measurement apparatus by preventing the penetration. It is considered that the service life of the apparatus parts can be lengthened by covering or coating the sound insulating and vibration control member with a material having an excellent gamma ray proof performance.

Next, the details of the structure of the PET measurement apparatus are described below mainly about the placement of the vibration insulating material and the like. The PET measurement apparatus is divided into two sections of the main unit of the measurement apparatus and the test human subject supporting apparatus. A cylindrical cavity that accommodates the body of the test human subject is located at the center of the apparatus main unit, and the detector ring of the radiation detectors are built in the apparatus in a form of a ring-shaped arrangement. In the present preferred embodiment, the surface of the apparatus main unit is assumed to be entirely covered with the vibration insulating material 10a and the like for suppressing the propagation of noise vibration generated from the apparatus to the test human subject (See FIG. 1). At this time, the inner surface of the cylindrical cavity that faces the body of the test human subject 12 should preferably be covered with the vibration insulating material 10a. This is presumably because the gamma rays, which have a very intense penetrating power, do not obstruct the measurement since the attenuation due to the penetration through the vibration insulating material 10a is limited to an ignorable extent.

With regard to the bed 11 that is the test human subject supporting apparatus, the entire surface brought in contact with the test human subject is covered with the vibration insulating member 11a (See FIG. 1). The bed may concurrently serve as a soft mat using a foamed urethane resin as a core material. Moreover, in order to suppress the noise vibration generated from the form adjusting motor of the bed 11, a structure in which the motor is peripherally enclosed by the vibration insulating member 10a is provided. Heat radiation of the motor should preferably be secured by, for example, water cooling.

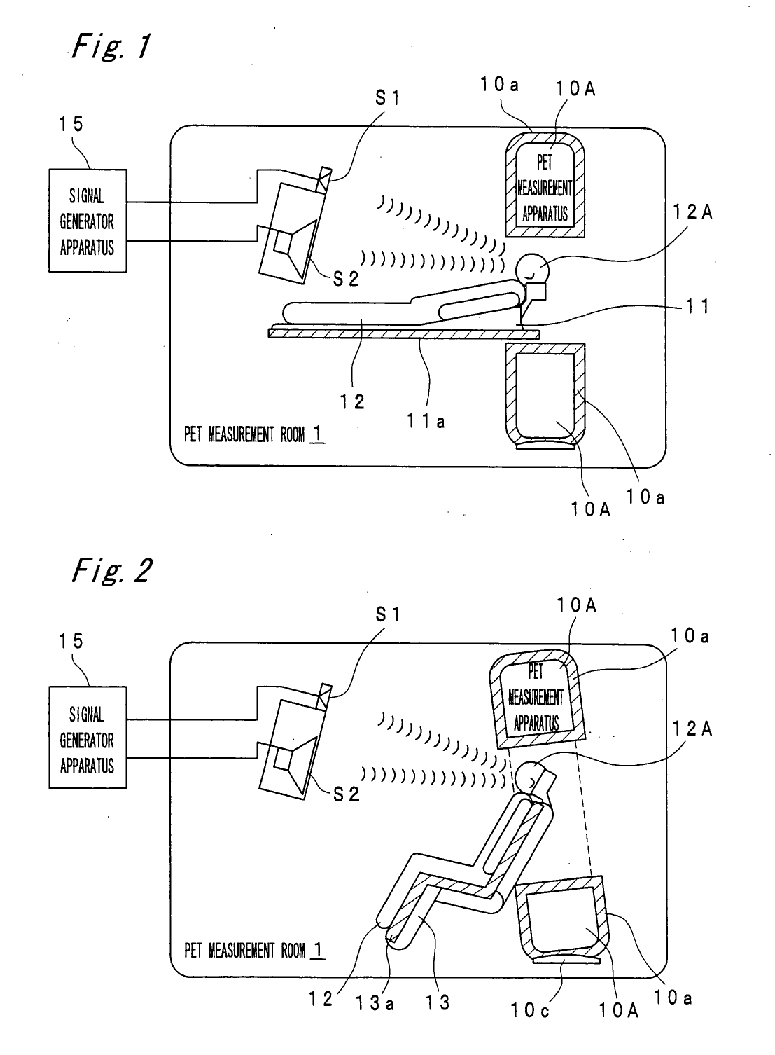

FIG. 2 is a schematic view showing such a state that the hypersonic sound from the signal generator apparatus 15 is applied to the test human subject 12 on a bending seat 13 of the PET measurement apparatus 10A by the supertweeter S1 and the full-range speaker S2 in the PET measurement room 1 including the PET measurement apparatus 10A according to a modified preferred embodiment of the first preferred embodiment of the present invention. In comparison with the first preferred embodiment of FIG. 1, the modified preferred embodiment of FIG. 2 is characterized in that the bending seat 13 whose surface is covered with a vibration insulating member 13a is employed in place of the bed 11 for supporting the test human subject, and an apparatus inclining mechanism 10c that inclines the main unit housing of the apparatus 10A at a prescribed angle is further provided so that the hypersonic sound from the loudspeakers S1 and S2 can be directly applied to the head 12A of the test human subject. The measurement of the PET measurement apparatus 20 can be performed in such a state that the test human subject 12 sits on the bending seat 13. Moreover, the degree that the head 12A and the upper half of the body of the test human subject are covered with the apparatus 10A can be sufficiently reduced. Furthermore, the hypersonic sound from the loudspeakers S1 and S2 can easily be applied directly to the head 12A of the test human subject by the apparatus inclining mechanism 10c. Furthermore, the bending seat 13 enables the setting to various postures to allow the test human subject 12 to undergo the PET measurement with relaxation.

The first preferred embodiment and the modified preferred embodiment thereof configured as above have features originated and devised as follows as compared with the prior art example of FIG. 3.

(1) Since the apparatus is covered with the vibration insulating material 10a and the vibration insulating member 13a, the sound and vibration that are generated from the PET measurement apparatus itself and transmitted to the test human subject are configured to have a sound pressure level being small to an ignorable extent (ideally zero) (hereinafter referred to as a feature 1).

(2) The depth of the apparatus is shortened as compared with the prior art example, and the opening of the detector ring is enlarged as compared with the prior art example. Therefore, the body surface including the head 12A of the test human subject is opened to the measurement information space, and the physical phenomena of sound, light and so on presented for the measurement directly reach the test human subject without being interrupted by anything (hereinafter referred to as a feature 2).

(3) As in the first preferred embodiment and the modified preferred embodiment, employing the bending seat 13 makes it possible to support the test human subject 12 in such a state that the test human subject takes a variety of postures including the standing, sitting and decubitus postures (ideally all the postures that a human being can take) without compelling the test human subject to suffer from efforts, endurance and pain and to perform the measurement of the test human subject 12 who takes the postures (hereinafter referred to as a feature 3).

The apparatus that suppresses the generation of noise vibration from the apparatus itself according to the feature 1 is described below. The most principal one of the mechanisms and so on that possibly constitute the PET measurement apparatus 20 according to the prior art example and are able to generate the noise vibration, which possibly obstruct the sensibility measurement by operating during measurement data collection, is the cooling system. Since the PET measurement apparatus is itself an integration of large-scale elements including the scintillation electronic circuit, a large quantity of heat is generated. Accordingly, cooling is needed for circuit protection and normal operation maintenance. The cooling system needs to consistently operate at least during apparatus electrification including the measurement time in terms of its purpose. Conventionally, the general cooling system has been a simple air-cooled system employing an air blower or a combination of a cooler and an air blower, and a compressor and fans become the sources of generating a noise vibration. If this is provided by, for example, a water-cooled system as in a second preferred embodiment described in detail later, the noise can be largely reduced. Furthermore, if an electronic circuit system employing a semiconductor thermo-mechanism is employed, advanced elimination of the noise vibration is expected since neither a motor nor a pump is needed. It is noted that the present invention is not limited to the above system so long as the purpose of generating no noise vibration can be achieved. A calibration related apparatus system that operates in collecting radiolucent characteristic data inherent to each test human subject necessary for imaging the measurement data performed before measurement, a measurement apparatus posture and bed position adjustment system for adjusting the positions and postures of the measurement apparatus and the test human subject and positional relations between both of them according to the purpose and situation of the measurement and so on, which include mechanisms that perform mechanical operation of a motor or the like, are therefore possibly become sources of generating noise vibration besides the cooling system. Although they are normally in an inoperative standby state during the measurement, minute noise vibration generated from these apparatuses in the standby state possibly become obstructions in the brain core activity measurement, and therefore, the vibration need to be similarly suppressed.

Next, the apparatus that suppresses the transmission of the noise vibration from the measurement apparatus to the test human subject according to the feature 2 is described below. Even if the measurement apparatus itself generates the noise vibration, the transmission of the noise vibration to the test human subject can be suppressed by interrupting the path through which the noise vibration is emitted from the apparatus into the air or propagates through the apparatus and reaches the test human subject by appropriately employing sound insulating and vibration absorbing materials and so on.

Further, the apparatus that secures an open structure in which the presentation information easily reaches the head and the body of the test human subject according to the feature 3 is described below. In order to make the whole body including the brain scannable in the PET measurement apparatus, the cavity of the sensor section of the detector ring that accommodates the test human subject has a cylindrical structure that is elongate and deep in the direction of the body axis and disturbs the presentation sound and optical information that contain abundant superhigh frequency vibrations of a strong straight propagation property from sufficiently reaching the body of the test human subject. In the present preferred embodiment, a thin type structure in which the thickness of the sensor section is limited to the range of covering the brain is provided by making the measurement apparatus usable specially for the brain. Additionally, by constituting the inside diameter of the opening as large as possible as compared with the prior art example, the presented superhigh frequency vibration and optical information having the strong straight propagation properties can directly reach a wide range of the body surface including the head of the test human subject.

The present inventor and others have conducted the experiments of applying and measuring the hypersonic sound by using the PET measurement apparatus 10A according to the preferred embodiment of FIG. 1, and the experimental results are described in the implemental example 2 described later.

### Second Preferred Embodiment

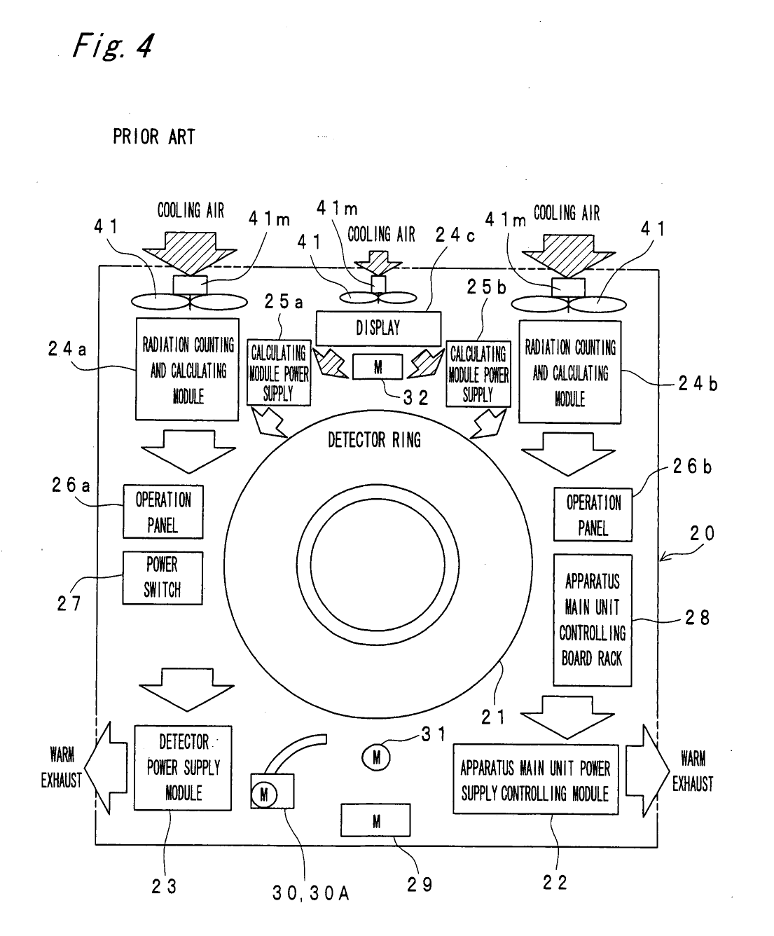

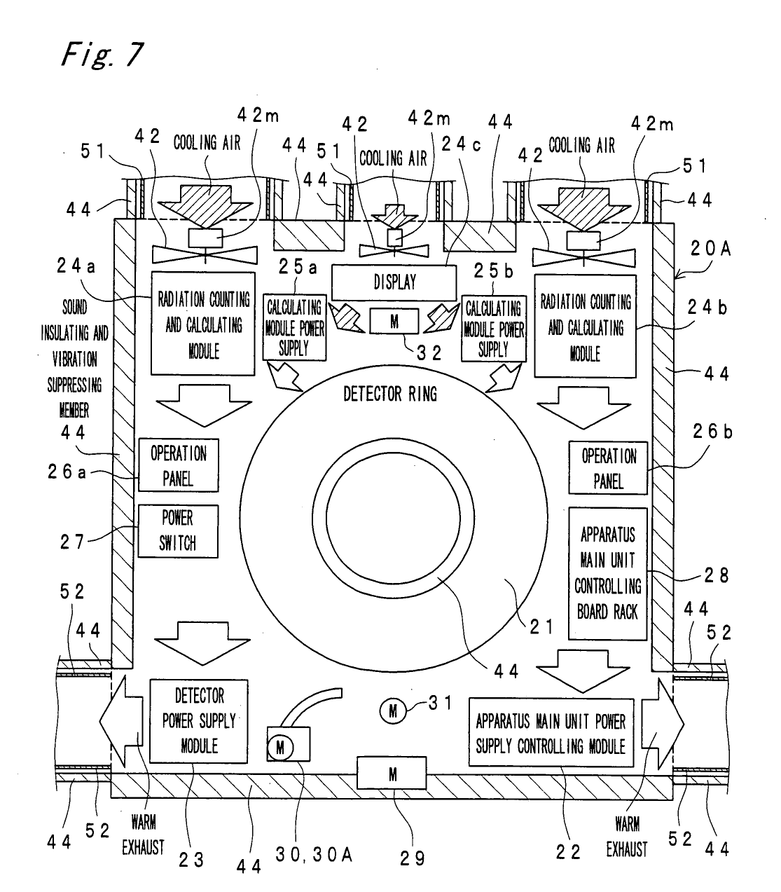

FIG. 7 is a schematic block diagram of a PET measurement apparatus 20A according to the second preferred embodiment of the present invention. In the PET measurement apparatus 20 according to the prior art example of FIG. 4, the motors and fans consistently operating also during the measurement in the apparatus main unit and the bed that is the test human subject supporting apparatus are only the cooling air supply fans 42 in the apparatus main unit and fan motors 42m for driving the fans. It is considered that the rotations of the motors 42m and fans 42 and turbulent flows of air caused by them become the principal sources of the noise vibration generated from the apparatus during the measurement.

The PET measurement apparatus 20A according to the second preferred embodiment is the apparatus that can cope with the noise vibration sources in the prior art example without largely changing the structure of the main unit of the measurement apparatus and is characterized by being configured as follows. The cooling air supply fans 42 of the main unit of the measurement apparatus are made to have a fan shape of a little wind noise, and its drive motors 42m are made motors of a low noise design. Inner surfaces outside the main unit of the measurement apparatus housing are wholly covered with a vibration insulating material 44 excluding air inlet and outlet openings. Cooling air introduction pipes 51 and warm exhaust pipes 52 that are ducts covered with the vibration insulating material 44 are piped from outside the measurement room to the air inlet and outlet openings of the apparatus main unit to supply and discharge air, the air flow of the cooling system is completely interrupted from the air inside the measurement room, so that the noise vibration generated from the air flow is hard to emit to the inside of the measurement room. According to the first air-cooled PET measurement apparatus 20A as configured as above, the vibration generated in the apparatus main unit can be substantially prevented from being transmitted to the outside, and the vibration can be substantially largely reduced as compared with the prior art example.

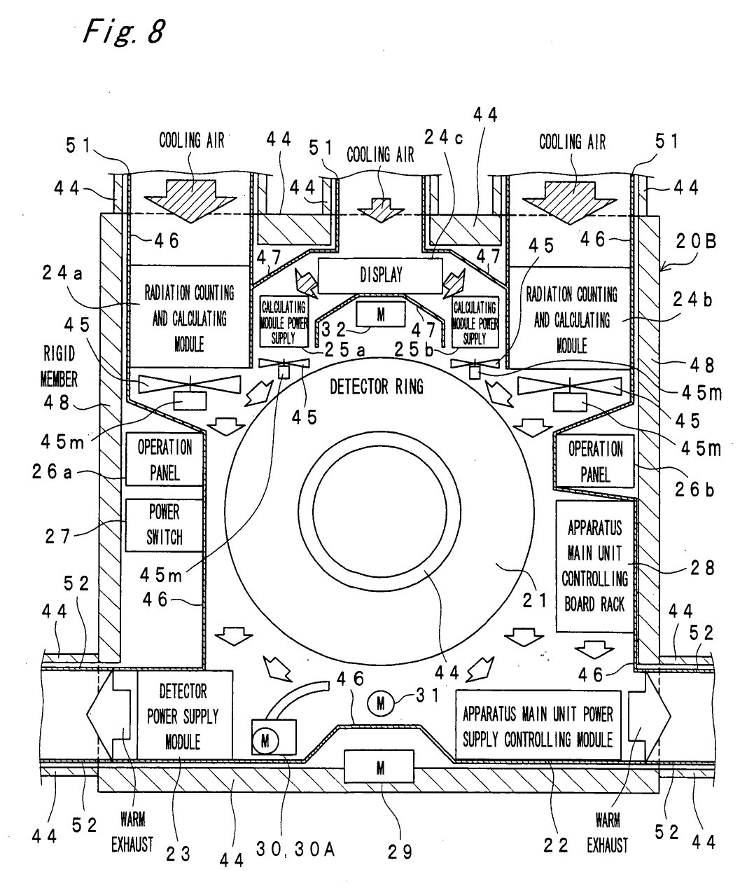

FIG. 8 is a schematic block diagram of a PET measurement apparatus 20B according to the first modified preferred embodiment of the second preferred embodiment of the present invention. Referring to FIG. 8, the following countermeasures are taken in addition to the PET measurement apparatus 20B of FIG. 7. The ducts 46 are piped to the inside of the main unit of the measurement apparatus to surround the flow path of the cooling air, so that the vibration generated from the turbulent flow is hard to propagate to the outside of the housing of the apparatus main unit. The straightening vanes 47 are placed inside the ducts 46 to suppress the generation of the turbulent flow. The cooling air supply fans 45 and motors 45m therefor are placed in deep portions of the main unit of the measurement apparatus, so that the noise vibration generated from them are hard to leak to the outside of the apparatus. The housing exterior of the main unit of the measurement apparatus is formed of rigid members 48 that have a double structure with interposition of an air layer and high rigidity, so that the noise vibration generated in the apparatus is hard to propagate to the outside of the apparatus. According to the second air-cooled PET measurement apparatus 20B as configured as above, the vibration generated in the apparatus main unit can be substantially prevented from being transmitted to the outside further than in the first air-cooled PET measurement apparatus 20A, and the vibration can be substantially largely reduced as compared with the prior art example.

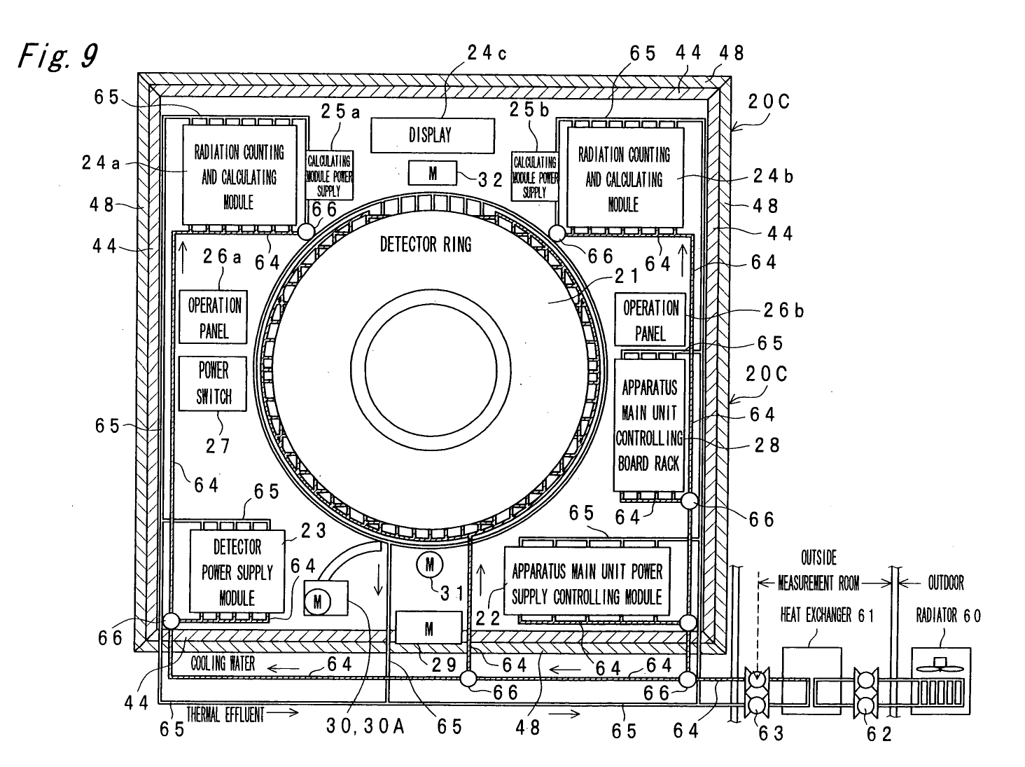

FIG. 9 is a schematic block diagram of a PET measurement apparatus 20C according to a second modified preferred embodiment of the second preferred embodiment of the present invention. In the second modified preferred embodiment of the second preferred embodiment, instead of providing the air cooling fans 42 and 45, the fan motors 42m and 45m in the air-cooled apparatus described above, heat generated from electronic circuits of the modules that need positive cooling is removed by electronic cooling by using a Peltier device, and cooling water pipes 64 are piped in each module to discharge the heat to the outside of the apparatus via warm water pipes 65 by circulating cooling water from an outdoor radiator 60 to the cooling water pipes 64 via a pump 62, a heat exchanger 61 and a pump 63. In this case, when valves 66 are necessary for controlling the flow of the cooling water in the apparatus and the measurement room, it is preferable to employ a valve 66 such as a solenoid valve that is hard to generate noise vibration. The housing exterior of the main unit of the measurement apparatus is formed of the rigid members 48 that have a double structure with interposition of an air layer and high rigidity, and the inner surfaces are entirely covered with a vibration insulating material 44, so that the noise vibration generated in the apparatus is hard to propagate to the outside of the apparatus. It is preferable to employ a pump of a low noise design for the pumps 62 and 63 that generate the motive power of the cooling water circulation. It is acceptable to place the pumps outside the measurement room in order to secure the noise vibration control. According to the water-cooled PET measurement apparatus 20C as configured as above, the vibration generated in the apparatus main unit can be substantially prevented from being transmitted to the outside further than in the air-cooled PET measurement apparatuses 20A and 20B, and the vibration can be substantially largely reduced as compared with the prior art example.

### Fields of Applications of First and Second Preferred Embodiment

With regard to the fields of applications of the PET measurement apparatuses according to the first and second preferred embodiments, the apparatuses can be utilized for the following various sorts of researches without being limited to the researches concerning the brain functions using a hypersonic sound.

(1) Brain science researches: Sensibility brain function researches, cognition brain function researches, psychophysiology researches, aesthete-physiology researches, etc.

(2) Evaluations (commodity evaluations etc.) concerning various external approaches to human being:

<Application of information> music, video images, TV programs, various performances, learning materials, various relaxation techniques, etc.

<Application of material> foods, beverages, seasonings, spices, liquors, tobaccos, cosmetics, etc.

<Application of energy> air-conducting, hyperthermia therapy, acupuncture and moxibustion, etc.

(3) Evaluations concerning various conscious cognitive activities of human beings (study and training business etc.) In concrete, various intellectual trainings, meditations, etc.

(4) Evaluations of intracerebral dynamics of medications (medication researches and developments): Blood/brain tissue distribution dynamics, receptor binding/dissociation dynamics, etc.

(5) Evaluations of health conditions: Utilization in brain health screening, etc.

(6) Evaluations of growth and development of children: Brain development medical examinations, etc.

(7) Evaluations of abilities: “Brain ability” diagnosis (measurement of information processing ability of brain), etc.

(8) Diagnoses of diseases and clinical studies: Cranial nerve diseases, cerebrovascular diseases, psychiatric disorders, tumors in head, neck and cranium, endocrine diseases, other diseases occurring in head, neck and cranium, etc.

### Third Preferred Embodiment

In a third preferred embodiment, a signal reproducing apparatus for converting a signal from a recording medium that stores an audio signal exceeding the upper limit of the audible range into a superhigh frequency aerial vibration and reproducing the same is described.

In the third preferred embodiment, by applying the superhigh frequency aerial vibration exceeding the upper limit of the audible range is applied to a space, where many unspecified people gather, such as a public facility, a commercial facility or a public conveyance to synthesize the vibration with a sound in the audible range from a portable music player carried by a user in the space, a sound presentation apparatus of a background music or the like installed in the space, the hypersonic effect is effectively produced in the listener. In this case, the “hypersonic effect” means the effect of increasing the amount of bloodstream in the brain core including the thalamus, hypothalamus and the brain stem, exalting the brain wave a wave power of its index, reducing the stress, rationalizing the activities of the autonomic nerve system, the endocrine system and the immune system, sensitizing a sound as pleasant and beautiful, enhancing the sound listening behavior and totally improving the psychosomatic states by an unsteady sound (hypersonic sound) that contains abundant superhigh frequency components exceeding the upper limit of the audible range as described above.

The present preferred embodiment is related to a signal reproducing apparatus that presents aerial vibrations in objective spaces such as public spaces, various facilities and transportation facilities used by many people.

The acoustic environments in the current cities have conventionally been significantly covered with noises that originate in the industrial machines and transportation facilities and induce strong unpleasantness and stress in human beings, possibly causing impairment of the psychosomatic health. The circumstances have conventionally been managed concurrently in two ways socially and technically.

(1) The first is to suppress the noise generating sources and insulate the transmission paths. Although the management has produced advanced effects, it is recognized that an almost soundless acoustic environment that mainly appears in an indoor space as a result still induces strong unpleasantness and stress in human beings.

(2) The second is to suppress the unpleasantness and stress occurring in human beings by positively supplying sounds of high effectiveness paying attention mainly to the psychological effects of the sounds (also to cope with the soundless space caused by the first management). As the kind of sound used for the purpose, music is mainly selected. In spaces such as public spaces and various facilities that many people use, a variety of music is widely presented as a back ground music (hereinafter referred to as BGM), and certain effects have been produced in improving the acoustic environments.

However, a variety of spaces in cities are currently flooded with BGM's, which become sources of new acoustic environment problems that many unspecified people are compelled to listen to the BGM's. In the new circumferences, there is an increasing number of people “who listen to (only) the favorite music (only) in the desired occasions” by utilizing portable music players to prevent the limitations of BGM's on the backgrounds of the music industry and media technologies that provide the music for amusement and appreciation developed contemporarily. However, the researches of the present inventor and others discovered that problems attributed to the frequency components of the listening sounds exist in common to both the people who listened to BGM's within the frame of the prior art and the people who listened to the music by portable music players.

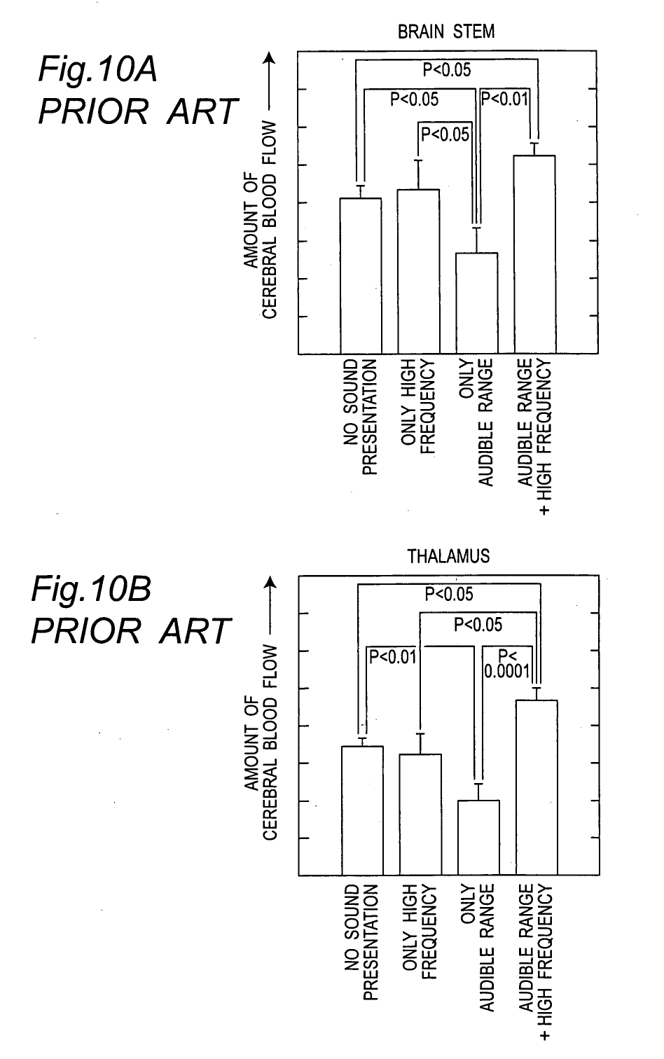

First of all, the present inventor and others have clarified the fact that the activities of the brain stem and the thalamus are lowered when only the audible range component of the sound is presented to the test human subject's listening as compared with such a case that no sound is presented through experiments (See, for example, Non-Patent Document 15 and FIGS. 10A and 10B reprinted from Non-Patent Document 15). In this case, FIGS. 10A and 10B show experimental results disclosed in Non-Patent Document 15. FIG. 10A is a graph showing an amount of cerebral blood flow when sounds of various frequency components are applied to the brain stem of the test human subject. FIG. 10B is a graph showing an amount of cerebral blood flow when sounds of various frequency components are applied to the thalamus of the test human subject. Then, the possibility of the occurrence of a negative influence on the psychosomatic health was indicated by the experimental results. The sounds sent from conventional BGM's and portable music players are generally limited to the audible range, and a concern that the psychosomatic health is impaired cannot be denied when listening to the music is continued by them.

That is, in order to prevent the negative influence of health on the listeners of the BGM's or the like and the users of portable music players or the like attributed to listening to the sound limited to the audible range, a new technology paying attention to the frequency component of the sound to be presented needs to be developed.

In order to examine in detail the apparatus for solving the problems, the present inventor and others conducted the experiments of examining the state of the development of the hypersonic effect by independently reproducing and presenting various combinations of the audible range component and the superhigh frequency component of the hypersonic sound by a loudspeaker and a headphone capable of reproducing an ultra-wideband sound ranging up to a superhigh frequency band exceeding the upper limit of the audible range of human beings and obtained the following results.

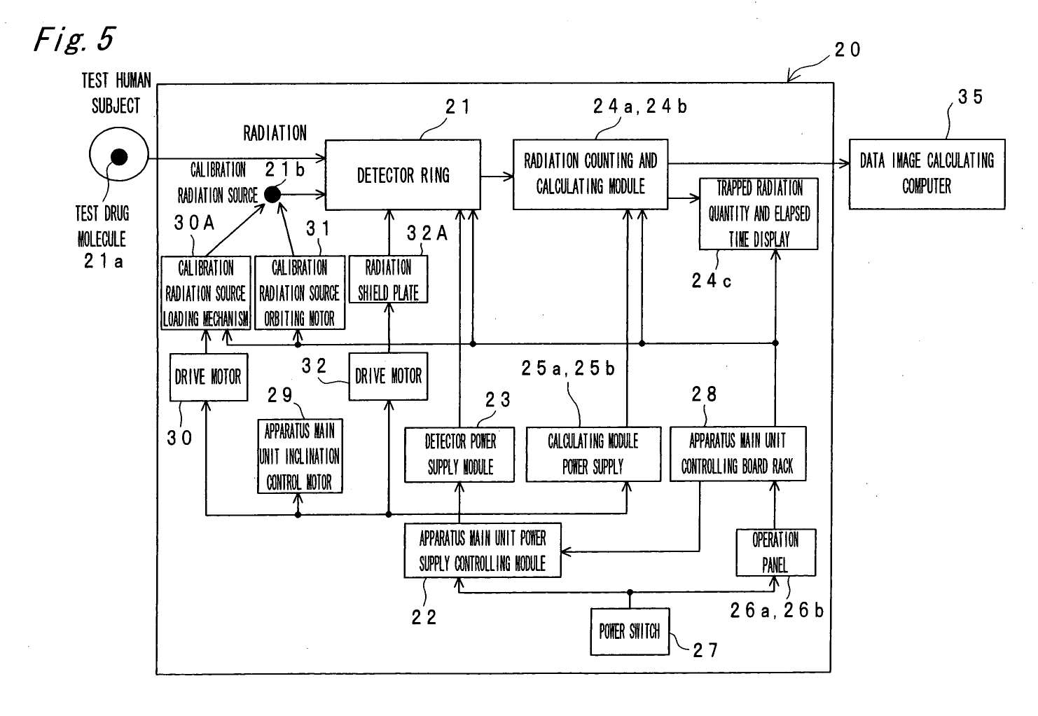

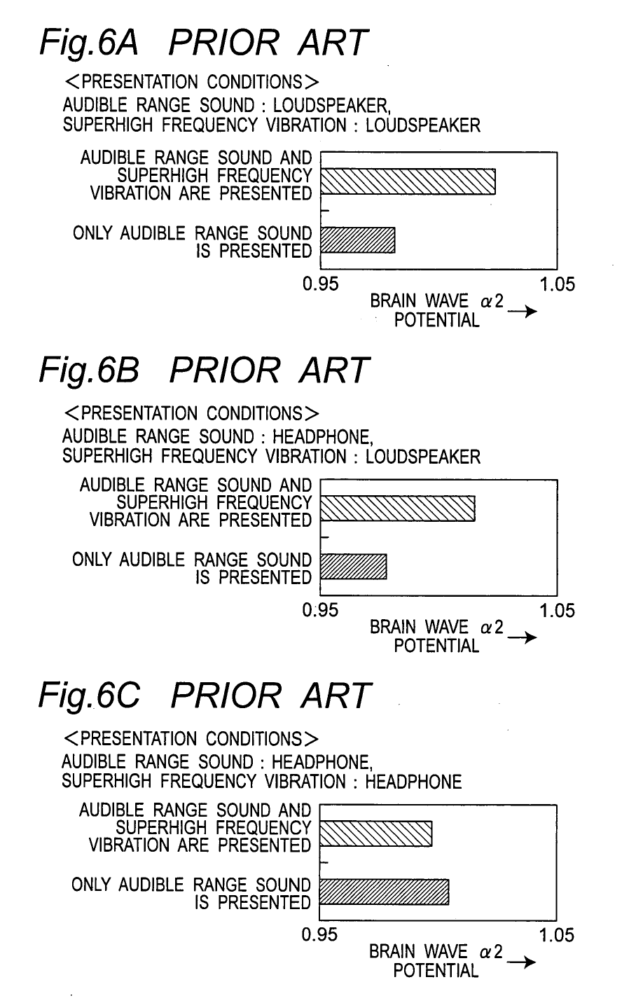

First of all, the experiments were conducted on the presentation condition that both the audible range sound and the superhigh frequency vibration constituting the hypersonic sound were presented from the loudspeaker. As a result, the brain wave α2 potential was increased, i.e., the development of the hypersonic effect was confirmed when the audible range sound and the superhigh frequency vibration were simultaneously presented as compared with such a case that only the audible range sound was singly presented (See FIG. 6A). Next, when similar experiments were conducted on the presentation condition that the reproduction of the audible range sound was changed to the reproduction by the headphone and the superhigh frequency vibration was reproduced from the loudspeaker, the hypersonic effect was similarly developed also in this case (See FIG. 6B). However, on the presentation condition that both the audible range sound and the superhigh frequency vibration were presented from the headphone, the hypersonic effect was not developed (See FIG. 6C).

The results suggest that the hypersonic effect can be produced when the superhigh frequency vibration is applied from the loudspeaker to the listener in both the cases where the listener is listening to the audible range sound from the loudspeaker (corresponding to the BGM) and such a case that the listener is listening to the audible range sound from the headphone (corresponding to the portable music player) but the development of the hypersonic effect is impossible when the superhigh frequency vibration is applied from the headphone limitedly to the air-conducting auditory system of the listener.

Accordingly, in order to solve the above problems on the basis of these knowledges, the present preferred embodiment is characterized in that the superhigh frequency vibration of which the effectiveness of inducing the hypersonic effect in the listener when combined with the (audible range component on a music or environmental sound containing those reproduced by the existing BGM or portable music player, or an audio signal that produces a superhigh frequency vibration capable of rationally providing the effectiveness is recorded into a recording apparatus or a recording medium, and the superhigh frequency audio signal is presented by being reproduced from the recording apparatus or the recording medium and converted into aerial vibration.

Since no change is observed in the blood flow of the brain core when the audible range sound is not presented but only the superhigh frequency vibration is presented to the test human subject in the experiments conducted by the present inventor and others (See, for example, Non-Patent Document 4 and FIGS. 10A and 10B), it is considered that there is no concern about the influences exerted on the mind and the body when only the superhigh frequency vibration is applied from the signal reproducing apparatus according to the present preferred embodiment to the person who is not listening to a BGM or a music from the portable music player and it is safe.

Next, a concrete implemental example according to the present preferred embodiment is described below. FIG. 11 shows one example of the FFT frequency power spectrum of the audio signal recorded in a signal recording and reproducing apparatus or a recording medium according to the third preferred embodiment. The contents of the audio signal are provided by a signal with track records as a superhigh frequency component that induces the hypersonic effect (hypersonic sound) or combinations of such signals. For example, the superhigh frequency components of a natural environmental sound in the tropical rain forest, a folk instrument sound, polyphony, a high frequency synthesizer and so on are used.

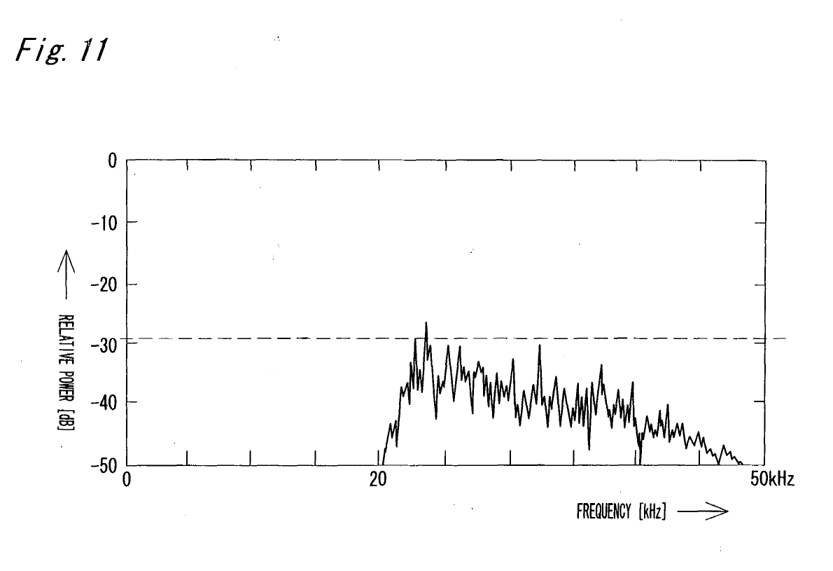

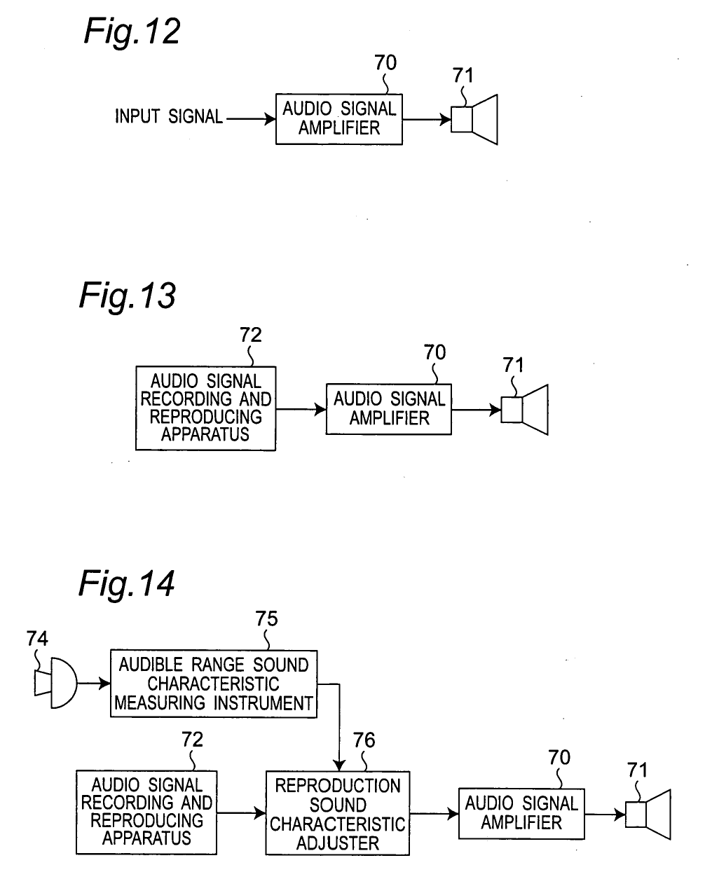

FIG. 12 is a block diagram showing a configuration of a signal reproducing apparatus according to the third preferred embodiment of the present invention. Referring to FIG. 12, an input signal of the hypersonic sound is inputted to an audio signal amplifier 70 and amplified in power, and then, the amplified hypersonic sound is emitted from a loudspeaker 71. In this case, the hypersonic sound contains a superhigh frequency aerial vibration.

FIG. 13 is a block diagram showing a configuration of a signal recording and reproducing apparatus according to the first modified preferred embodiment of the third preferred embodiment of the present invention. Referring to FIG. 13, the electrical signal of the hypersonic sound is preparatorily recorded in a recording medium such as CD-ROM or a memory, and then, the recorded electrical signal is reproduced by an audio signal recording and reproducing apparatus 72. Next, the reproduced electrical signal of the hypersonic sound is inputted to the audio signal amplifier 70 and amplified in power, and then, the amplified hypersonic sound is emitted from the loudspeaker 71. In this case, the hypersonic sound contains a superhigh frequency aerial vibration.

FIG. 14 is a block diagram showing a configuration of a signal recording and reproducing apparatus according to the second modified preferred embodiment of the third preferred embodiment of the present invention. Referring to FIG. 14, the electrical signal of the hypersonic sound is preparatorily recorded in a recording medium such as CD-ROM or a memory, the recorded electrical signal of the hypersonic sound is reproduced by the audio signal recording and reproducing apparatus 72, and the reproduced electrical signal of the hypersonic sound is inputted to a reproduction sound characteristic adjuster 76. On the other hand, an audible range sound characteristic measuring instrument 75 collects the audible range sound existing in the surrounding environment of the test human subject by a microphone 74, subjects the collected audible range sound to A/D conversion, analyzes analysis data of the acoustic structure of the frequency spectrum, power, fluctuations and so on by using the techniques of FFT, MEM and the like on the basis of the converted digital signal data, and outputs the obtained analysis data of the acoustic structure to the reproduction sound characteristic adjuster 76. The reproduction sound characteristic adjuster 76 adjusts the characteristics of the reproduction sound so that the signal data of the preparatorily recorded hypersonic sound is reproduced as a superhigh frequency aerial vibration in the optimal state in conformity to the analysis data of the acoustic structure of the audible range sound, and outputs the adjusted signal data to the audio signal amplifier 70. The audio signal amplifier 70 subjects the inputted signal data to D/A conversion, then amplifies the resulting signal, and outputs and emits the same via the loudspeaker 71. In this case, the hypersonic sound contains a superhigh frequency vibration, and therefore, the sound and vibration outputted from the loudspeaker 71 also contain the superhigh frequency aerial vibration and are optimally adjusted as described above.

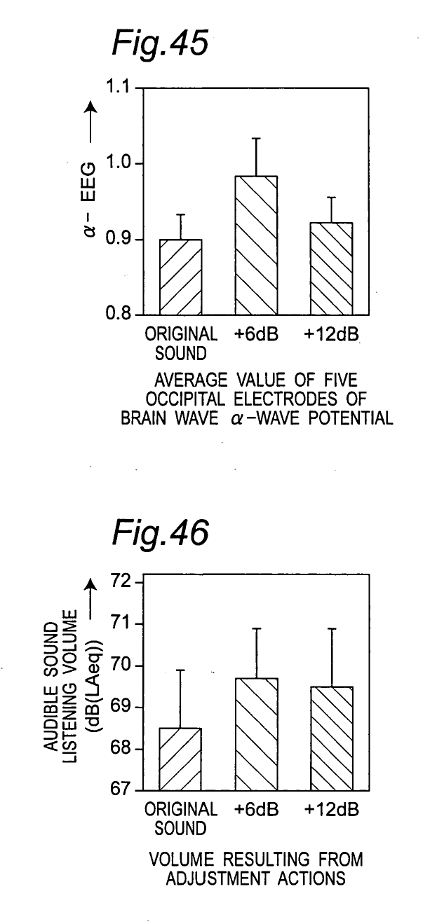

Further, the reproduction sound characteristic adjuster 76 adjusts the reproducing level of the superhigh frequency vibration so that, for example, the superhigh frequency vibration is increased or decreased at a certain ratio to the power of the audible range sound measured by the audible range sound characteristic measuring instrument 75. FIG. 45 is a graph of experimental results concerning the hypersonic sound by the inventor and others, showing a change in the degree of the hypersonic effect when the superhigh frequency component in the hypersonic sound is boosted and an average value (α-EEG) of five occipital electrodes of the brain wave a wave potential. FIG. 46 is a graph of experimental results concerning the hypersonic sound by the inventor and others, showing a change in the degree of the hypersonic effect when the superhigh frequency component in the hypersonic sound is boosted and an audible sound listening volume as the result of an adjustment action. Therefore, according to the experimental results (FIGS. 45 and 46) by the present inventor and others, it has been clarified that, when the superhigh frequency component in the hypersonic sound is increased and decreased, the degree of the hypersonic effect is increased and decreased in conformity to it. Accordingly, reproduction should preferably be achieved by adjusting the power of the superhigh frequency vibration to the most effective level. Moreover, it is acceptable to equalize the frequency spectrum of the superhigh frequency into a state of a high adaptability to the frequency spectrum structure and the fluctuation structure of the audible range sound measured by using the audible range sound characteristic measuring instrument 75 or to emphasize or suppress the fluctuation structure.

Although the superhigh frequency component is radiated substantially to the whole body of the test human subject via the loudspeaker 71 in the signal recording and reproducing apparatus of FIG. 14, it is acceptable to provide such a configuration that the audible range component of the hypersonic sound is applied only to the auditory sense of the test human subject via the earphone. This can be applied also to the signal recording and reproducing apparatus of FIG. 20 described later.

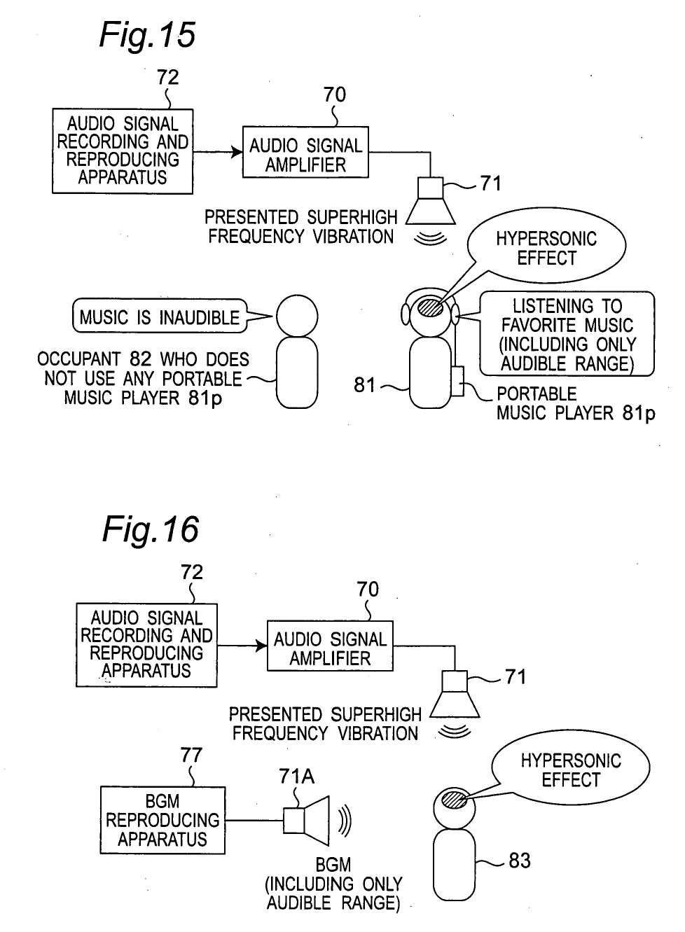

FIG. 15 is a block diagram showing a configuration of a signal recording and reproducing system according to the implemental example 1 of the third preferred embodiment of the present invention. FIG. 15 shows such a case that a user 81 listens to his or her favorite music by a portable music player 81p that the user carries in, for example, a space where the superhigh frequency audio signal from the audio signal recording and reproducing apparatus 72 of FIG. 13 is presented as a superhigh frequency aerial vibration from the loudspeaker 71 via the audio signal amplifier 70. In the present implemental example, by a hypersonic effect induced by a combination of an audible range sound from the ears and the superhigh frequency vibration from the body surface, the user 81 is able to enjoy a better sound quality while listening to his or her favorite music without any new investment to the apparatus and to prevent the adverse effect on his or her health concerned when the user listens to only the audible range component. Furthermore, since the superhigh frequency vibration presented in the present implemental example is not perceived, an occupant 82 who does not use the portable music player 81p or the like feels the space indistinguishable from the background noise when a BGM reproducing apparatus 77 of FIG. 16 or the like that presents an audible range sound in the space is not installed, so that the compulsory listening situation caused by the conventional BGM can be eliminated.

FIG. 16 is a block diagram showing a configuration of a signal recording and reproducing system according to the implemental example 2 of the third preferred embodiment of the present invention. FIG. 16 shows such a case that the conventional BGM reproducing apparatus 77 is concurrently used in, for example, the space where the superhigh frequency audio signal from the audio signal recording and reproducing apparatus 72 of FIG. 13 is presented as a superhigh frequency aerial vibration from the loudspeaker 71 via the audio signal amplifier 70. In the present implemental example, by a hypersonic effect induced by a combination of the superhigh frequency vibration from the loudspeaker 71 and the audible range sound of the BGM (in only the audible range) radiated from the BGM reproducing apparatus 77 of the prior art via a loudspeaker 77A, a user 83 who is staying in the space is able to enjoy a better sound quality while listening to the conventional BGM music and to prevent the adverse effect on his or her health concerned when the user listens to only the audible range sound.

Although the one recording medium or recording and reproducing apparatus having one channel has been described for the sake of simplicity of description in the above implemental example, it is acceptable to record and reproduce the superhigh frequency audio signal over a plurality of channels or to provide two or more recording and reproducing apparatuses.

As described above, according to the present preferred embodiment, a method effective for reproducing an audio signal from a recording medium in which the audio signal exceeding the upper limit of the audible range is recorded, converting the signal into a superhigh frequency aerial vibration and presenting the same is provided. By applying the superhigh frequency aerial vibration exceeding the upper limit of the audible range to a space such as a public facility, a commercial facility, a public conveyance where many unspecified people gather and integrating the vibration with the audible range sound from the portable music player that the user in the space carries or from a sound presentation apparatus or the like of a BGM or the like installed in the space, it is effectively produced to induce the hypersonic effect in the user.

### Fourth Preferred Embodiment

In the fourth preferred embodiment, a superhigh frequency vibration reproducing apparatus that can be carried by being worn on a body is described below. By effectively applying a superhigh frequency vibration exceeding the upper limit of the audible range to the human body surface and integrating the vibration with the audible range sound existing in the space where the user is located, a hypersonic effect is effectively developed in the user. Since the apparatus generates no audible range sound, it becomes possible to improve the psychosomatic state without conflicting with any daily life.

The present preferred embodiment is related to the vibration reproducing apparatus among the apparatuses that effectively produce the hypersonic effect.

The acoustic environments in the current cities are significantly covered with noises that originate in the industrial machines and public conveyances and induce strong unpleasantness and stress in human beings, possibly causing impairment of the psychosomatic health. Against the situations, it has been taken the measures of suppressing the unpleasantness and stress occurring in human beings by positively supplying sounds of high effectiveness paying attention mainly to the psychological effects of the sounds. For this purpose, it is widely performed to present a variety of music as BGM's in the spaces such as public spaces and various facilities that many people use. Although the BGM's are producing certain effects in improving the acoustic environments, a variety of spaces in cities are currently flooded with BGM's, which become sources of new acoustic environment problems that many unspecified people are compelled to listen to the BGM's. In order to prevent the problems of BGM's, there is an increasing number of people “who listen to (only) the favorite music (only) in the desired occasions” by utilizing portable music players to prevent the limitations of BGM's.

However, the researches of the present inventor and others clarified the fact that problems attributed to the frequency components of the listening sound existed in common to both the people who listened to a BGM and the people who listened to the music by portable music players within the frame of the prior art. The present inventor and others clarified the fact that the activities of the brain core including the thalamus, hypothalamus and the brain stem were lowered as compared with such a case that no sound was presented when only the audible range component of the sound was presented to the test human subject's listening (See, for example, Non-Patent Document 15), and indicated the possibility of the generation of a negative influence on the psychosomatic health. The sounds sent from the conventional BGM presentation apparatus and the portable music player are generally limited to the inside of the audible range, and when the listening to the music by the media is continued, a concern that the psychosomatic health of the listener is impaired cannot be denied. On the other hand, the present inventor and others discovered that the activities of the brain core were improved as compared with such a case that no sound was presented or when only the audible range sound was presented by presenting the superhigh frequency components exceeding the upper limit of the audible range in accompaniment with the audible range component (See, for example, Non-Patent Document 15).

Accordingly, on the basis of the discovery, the present inventor and others proposed the “sound generator apparatus, sound generating space and sound” characterized in that the amount of cerebral blood flow of a human being is increased by generating a sound, or an unsteady sound that had a frequency in a first frequency range up to a prescribed maximum frequency exceeding the audible frequency range and changed in a micro time region in a second frequency range exceeding 10 kHz, applying the sound in the audible frequency range of the sound to the human auditory sense and applying the sound having the frequency range exceeding the audible frequency range of the sound to the human being in Patent Documents 2 and 3.

However, since the apparatuses conventionally put into practical use among the apparatuses described in Patent Documents 2 and 3 are floor types, their effects can be given only in a limited specific space. Therefore, it has not yet been achieved to induce an effective change in the situation, in which many people in a public space or the like are exposed to the risks of impairing the psychosomatic health without consciousness while being surrounded by only the audible range sound, regardless of the presence or absence of a BGM and the use or nonuse of a portable music player.

Accordingly, in order to solve the above problems, the present inventor and others considered to produce an effect equivalent in quality to the effect of being surrounded by the tropical rain forest environmental sound by supplementing the environmental sound of only the audible range sound in urban spaces with superhigh frequency vibration nonexistent there by a superhigh frequency vibration reproducing apparatus of a type that could be portable worn on individual bodies. In order to examine the apparatus in detail, the present inventor and others conducted the experiments of examining the state of development of a hypersonic effect by independently reproducing and presenting the audible range component and the superhigh frequency component of the hypersonic sound in a variety of combinations by using a loudspeaker and a headphone capable of reproducing an ultra-wideband sound ranging up to the superhigh frequency band exceeding the upper limit of the audible range of human beings and obtained the effects as follows.

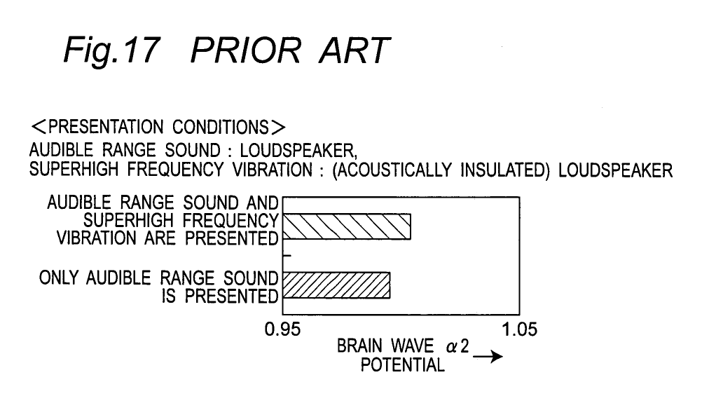

First of all, as in the experiments already conducted by the present inventor and others, the experiments were conducted on the presentation condition that both the audible range sound and the superhigh frequency vibration constituting the hypersonic sound were reproduced from the loudspeaker. As a result, the brain wave α2 potential was boosted when the audible range sound and the superhigh frequency vibration were simultaneously presented as compared with such a case that only the audible range sound was singly presented, i.e., the development of a hypersonic effect was confirmed (See FIG. 6A). Next, similar experiments were conducted on the presentation condition that the superhigh frequency vibration were reproduced from the loudspeaker by changing the reproduction of the audible range sound to reproduction by the headphone, and the development of a hypersonic effect was similarly confirmed also in this case (See FIG. 6B). However, no hypersonic effect was developed on the presentation condition that both the audible range sound and the superhigh frequency vibration were reproduced from the headphone (See FIG. 6C). Further, when an advanced shield is provided between the loudspeaker and the human body while the audible range sound is reproduced from the headphone and the superhigh frequency component is reproduced from the loudspeaker (condition of FIG. 6B), no hypersonic effect is developed (See FIG. 17).

The above experiments clarified that the indispensable presentation condition for the development of the hypersonic effect was the superhigh frequency component sufficiently reaching the body surface other than the ears simultaneously with the presentation of the audible range component to the auditory sense system. Accordingly, in order to solve the above problems on the basis of the knowledge, the present preferred embodiment is characterized by manufacturing a superhigh frequency vibration reproducing apparatus of the type that is portable worn on the body, supplementing the superhigh frequency vibration nonexistent in urban spaces by applying superhigh frequency vibration that induces the hypersonic effect or is rationally expected to induce the effect as aerial vibration to the surface of the human body, and this leads to production of an effect equivalent in quality to the effect of being surrounded by a hypersonic sound of a good quality.

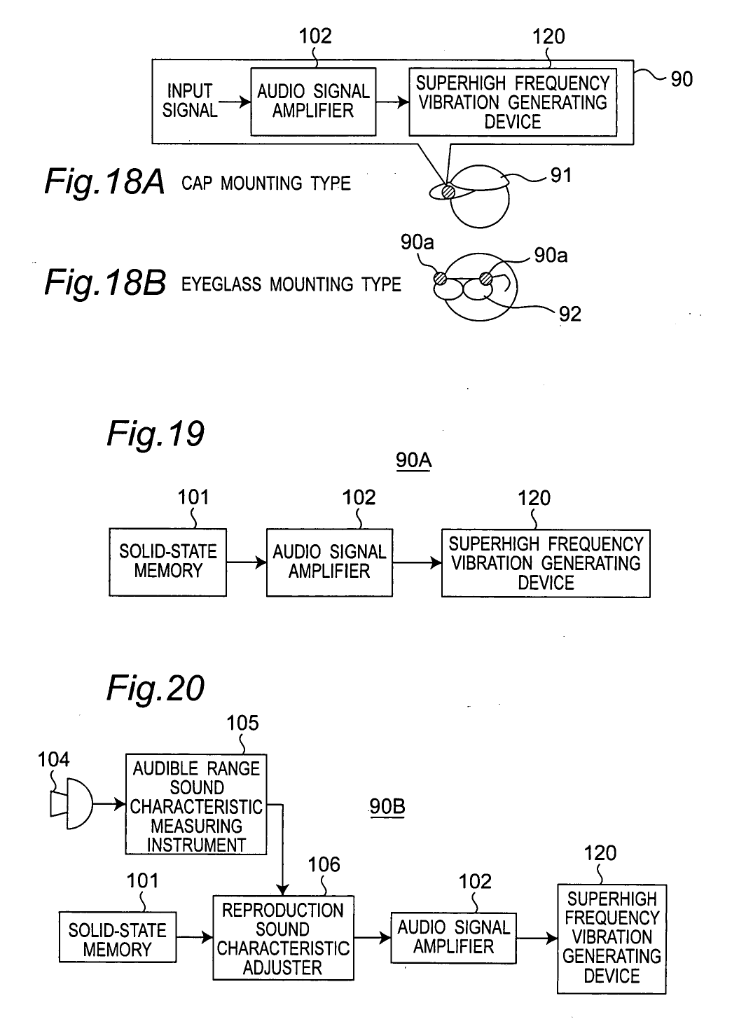

FIG. 18A is an appearance diagram and a block diagram showing a configuration of a signal reproducing apparatus 90 of a cap mounting type according to the fourth preferred embodiment of the present invention, and FIG. 18B is an appearance diagram and a block diagram showing a configuration of a signal reproducing apparatus 90a of an eyeglass mounting type according to the fourth preferred embodiment of the present invention. In the signal reproducing apparatus 90 of FIG. 18A, an input signal of a hypersonic sound is inputted to and amplified in an audio signal amplifier 102, and then, it is inputted to a superhigh frequency vibration generating device 120. The superhigh frequency vibration generating device 120 generates and radiates not only the audible range sound contained in the hypersonic sound but also the superhigh frequency vibration. In the signal reproducing apparatus of the cap mounting type of FIG. 18A, the signal reproducing apparatus 90 is provided at, for example, a visor portion of the cap, and the sound and vibration of the hypersonic sound are radiated mainly to the head of the test human subject 91. Moreover, the signal reproducing apparatus 90a of the eyeglass mounting type of FIG. 18B has a configuration similar to that of the signal reproducing apparatus 90, and the signal reproducing apparatus 90a is provided at, for example, both ends of the horizontal frame at the front of the eyeglasses. The signal reproducing apparatus 90a generates and radiates not only the audible range sound but also the superhigh frequency vibration contained in the hypersonic sound, and this leads to radiation of the sound and vibration of the hypersonic sound mainly to the head of the test human subject 92.

FIG. 19 is a block diagram showing a configuration of a signal recording and reproducing apparatus 90A according to the first modified preferred embodiment of the fourth preferred embodiment of the present invention. In comparison with the signal reproducing apparatus 90 of FIGS. 18A and 18B, the signal recording and reproducing apparatus 90A of FIG. 19 subjects the electrical signal of the hypersonic sound to A/D conversion, stores the data in, for example, a fixed memory 101 that is a nonvolatile memory such as a flash memory. The solid-state memory 101 outputs the data of the hypersonic sound to the audio signal amplifier 102. The audio signal amplifier 102 subjects the inputted data to D/A conversion, amplifies the data in power, outputs the resulting signal to the superhigh frequency vibration generating device 120 and emits the sound and vibration of the hypersonic sound.

FIG. 20 is a block diagram showing a configuration of a signal recording and reproducing apparatus 90B according to a second modified preferred embodiment of the fourth preferred embodiment of the present invention. In comparison with the signal recording and reproducing apparatus 90A of FIG. 19, the signal recording and reproducing apparatus 90B of FIG. 20 is characterized in that a microphone 104, an audible range sound characteristic measuring instrument 105 and a reproduction sound characteristic adjuster 106 are further provided. They operate similarly to those of the corresponding apparatus of FIG. 14.

As described above, the signal reproducing apparatus 90 and the signal recording and reproducing apparatuses 90A and 90B are each made a very small apparatus and mounted on, for example, the brim of the cap or the frame of the eyeglasses to effectively apply the superhigh frequency aerial vibration to the human body surface including the face. With this arrangement, it is expected to induce the development of the hypersonic effect as a consequence of the superimposition of the effect of the superhigh frequency aerial vibration on the music in the audible range or the like to which the listener is listening from a BGM in a facility, a headphone stereo or the like in the daily life.

The objects on which the apparatus is mounted are only required to be those worn on the body, such as accessories of an earring, a necklace, a pendant, a broach, a bracelet, an anklet and the like, a wristwatch, a belt, a glove, a shoe, a bag and the like besides the cap and eyeglasses described above. Moreover, the equipment constituting the apparatus is not required to be mounted on the cap or the like in an integrated state, and it is acceptable to provide a preferred embodiment in which a vibration reproducing apparatus connected by a cable or wirelessly to the apparatus partially put in a waist pouch or the like is mounted on the cap or the like. Furthermore, the apparatus is not required to be a distinct one independent from the articles described above as the objective mounting bases, and it is acceptable that the apparatus is built in as part of the articles and that the apparatus itself concurrently has the functions and designs of the articles. An exemplified apparatus is an apparatus usable as a pendant top processed in decorative colors and forms. If a piezoelectric effect fiber or the like is used, it is considerable to provide an apparatus in a form of clothing.

Although the one reproducing apparatus having one channel has been described for the sake of simplicity in description in the present preferred embodiment, it is acceptable to reproduce the superhigh frequency audio signal over a plurality of channels or to provide two or more reproducing apparatuses. The contents of the superhigh frequency audio signal are provided by a signal with track records as a superhigh frequency component that induces the hypersonic effect or combinations of such signals. For implemental example, the superhigh frequency components of a natural environmental sound in the tropical rain forest, a folk instrument sound, a song, a synthesizer and so on are used.

As described above, according to the present preferred embodiment, by supplementing the superhigh frequency vibration nonexistent in current cities by the superhigh frequency vibration reproducing apparatus that is portable worn on the body and producing the hypersonic effect even in deteriorated sound spaces, an effect equivalent in quality to the effect of being surrounded by the tropical rain forest environmental sound is produced. Since the present apparatus generates no audible range sound, individuals become able to control the acoustic environment more comfortably without conflict with the daily life and to improve the psychosomatic state. In particular, since it is effective to expose the human body other than the human auditory sense system to high frequency vibration, it becomes possible to uniformly apply the high frequency vibration from the lower side of the brim to the whole body by providing the apparatus with the structure and to effectively produce the hypersonic effect.

### Fifth Preferred Embodiment

In the fifth preferred embodiment, electronic equipment such as a headphone into which a signal reproducing apparatus that reproduces a superhigh frequency aerial vibration exceeding the upper limit of the audible range from an electronically inputted audio signal and effectively applies the vibration to the human body surface is described below.

The invention according to the fifth preferred embodiment is related to a signal reproducing apparatus such as a headphone by the technique of effectively producing a hypersonic effect (the effect of increasing the amount of bloodstream in the brain core including the thalamus, the hypothalamus and the brain stem, exalting the brain wave a wave power of its index, reducing the stress, rationalizing the activities of the autonomic nerve system, the endocrine system and the immune system, sensitizing a sound as pleasant and beautiful, enhancing the sound listening behavior and totally improving the psychosomatic state by an unsteady sound (hypersonic sound) containing abundant superhigh frequency components exceeding the upper limit of the audible range).

The present inventor and others discovered the existence of the hypersonic effect (See, for example, Non-Patent Document 15 and so on). Based on the discovery, a sound generator apparatus or the like to develop the hypersonic effect has been devised (See, for example, Patent Documents 2 and 3). However, the sound generator apparatus or the like according to the prior arts described above need one or more loudspeaker systems as a reproducing apparatus installed in a certain space. For the above reasons, there are limitations in carrying the apparatus that develops the hypersonic effect and using the apparatus individually by a plurality of persons who are located in an identical space. In order to solve the problems, a technique for simply producing a hypersonic effect by using only the headphone as the reproducing apparatus is desired to be developed.

However, the experiments conducted by the present inventor and others proved that simply extending the reproduction frequency response of the headphone according to the prior art to the superhigh frequency band did not lead to the development of the hypersonic effect. That is, a hypersonic effect appears when both the audible range sound and the superhigh frequency vibration constituting the hypersonic sound are reproduced from a loudspeaker (See FIG. 6A). In contrast to this, no hypersonic effect is developed when the reproduction system is switched to the headphone of which the reproduction frequency response is expanded to the superhigh frequency band and both the audible range sound and the superhigh frequency vibration are reproduced from the headphone under the same experimental conditions (See FIG. 6B). The bar graphs in FIGS. 6A and 6B show changes represented by the potential of the α2 band component of the spontaneous brain wave recorded from the occipital of the listener (brain wave α2 potential) depending on a difference in the acoustic condition (such a case that only the audible range sound is singly presented and such a case that the audible range sound and the superhigh frequency vibration are simultaneously presented). It is known that the brain wave α2 potential becomes the index of the hypersonic effect in parallel with the deep brain activity. Therefore, in order to effectively produce the hypersonic effect by a headphone, a new technique for application to the listener in a manner similar to that when the superhigh frequency vibration is reproduced from a loudspeaker needs to be developed.

In order to solve the above problems, according to the experiments conducted by the present inventor and others, a hypersonic effect is extremely remarkably developed when the audible range sound is reproduced by the headphone and the superhigh frequency vibration is reproduced from the loudspeaker (See FIG. 6C). In contrast to this, no hypersonic effect is developed when an advanced shield is provided between the loudspeaker and the human body by using a sound insulation material under the same condition (See FIG. 6D). That is, the necessary condition of the development of the hypersonic effect is that the superhigh frequency vibration constituting the hypersonic sound sufficiently reaches the body surface.

Accordingly, in order to solve the above problems, the electronic equipment such as a headphone according to the present preferred embodiment is characterized in that the audible range sound is applied to the air-conducting auditory system by being reproduced by an apparatus similar to the conventional headphone, and the aerial vibration of the superhigh frequency component is effectively applied to the human body surface in reproducing a hypersonic sound.

A headphone with a built-in piezoelectric transducer for transmitting the superhigh frequency vibration by bone-conducting in an ear pad is devised against the problem that the hypersonic effect cannot be produced by the system that uses the headphone according to the prior art as a signal reproducing apparatus (See, for example, Patent Document 4). However, in contrast to the fact that the superhigh frequency component needs to be received on the body surface to develop the hypersonic effect as indicated by the results of the experiments described above, the superhigh frequency vibration does not reach the body surface since the piezoelectric for generating the superhigh frequency vibration is included in the ear pad according to the present system. Moreover, since the air and the body tissues have remarkably different physical properties, it is difficult to consider that the superhigh frequency vibration transmitted as an aerial vibration from the loudspeaker causes bone conduction by the conventional apparatus that produces the hypersonic effect. Therefore, it cannot be expected to induce the hypersonic effect by the headphone that generates bone conduction of the superhigh frequency vibration around the ears.

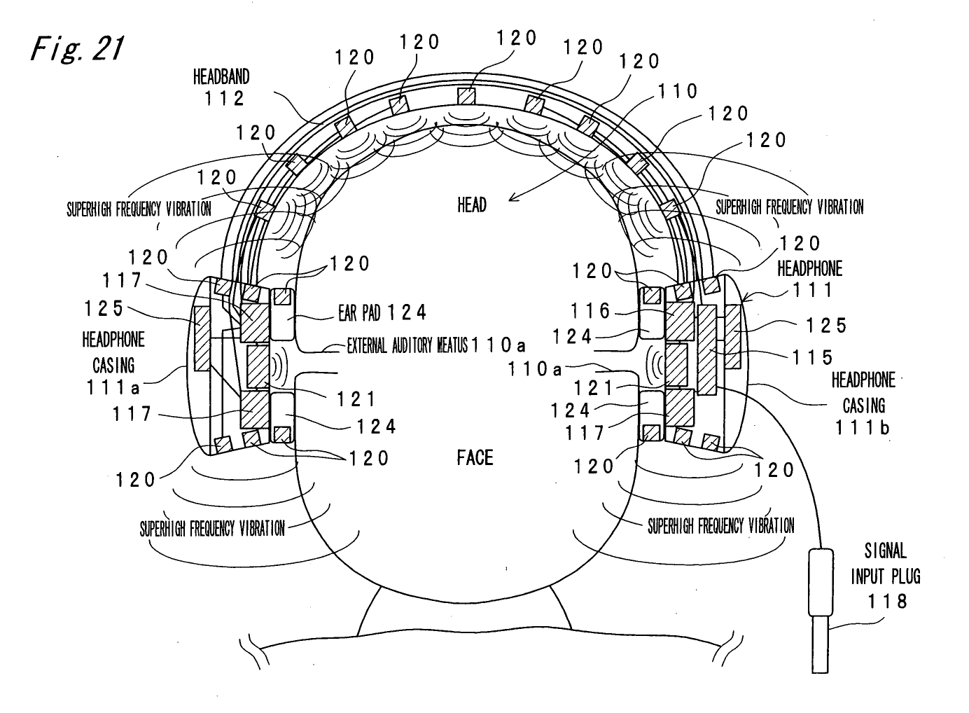

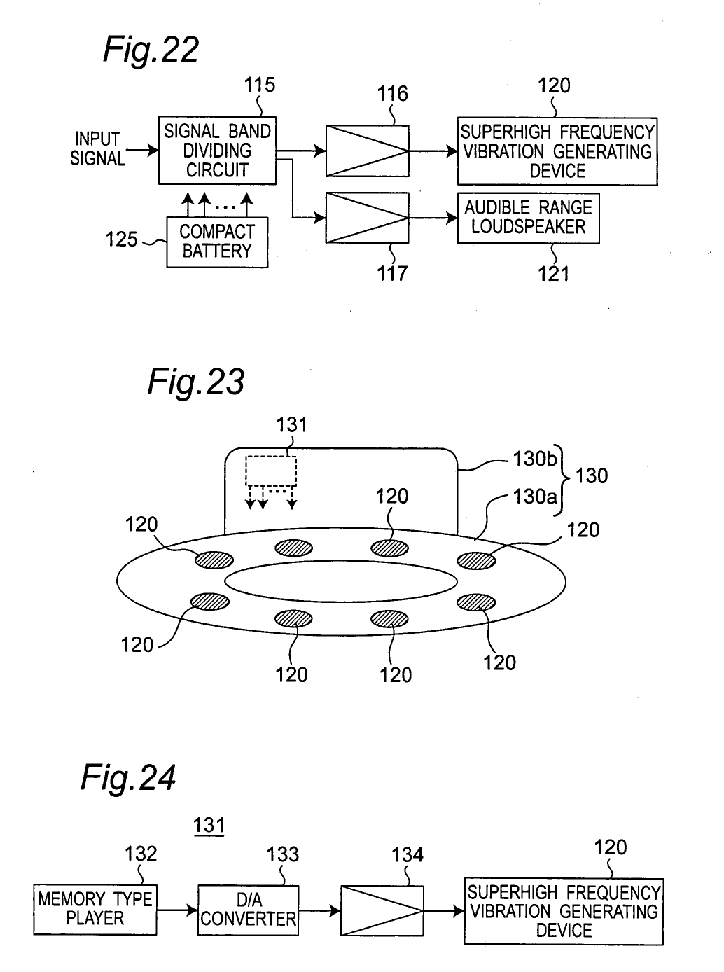

FIG. 21 is an appearance diagram and a block diagram showing a configuration of a headphone 111 according to the fifth preferred embodiment of the present invention, and FIG. 22 is a block diagram showing a configuration of a signal reproducing apparatus employed in the headphone 111 of FIG. 21.

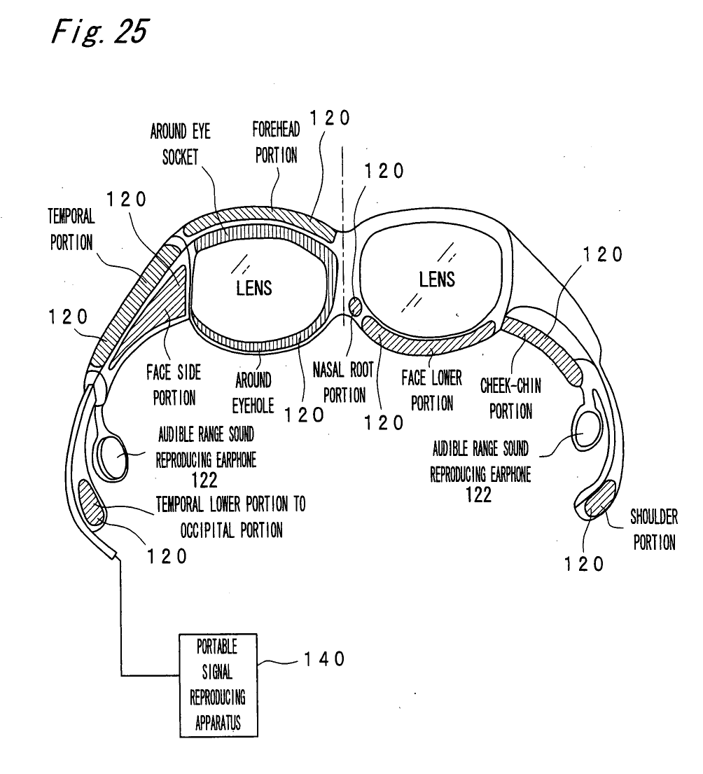

Referring to FIG. 21, the headphone 111 is configured by including a pair of generally cylindrical headphone casings 111a and 111b placed so as to oppose to cover both the ears of a test human subject, and a headband 112 for mechanically connecting the headphone casings 111a and 111b together and placing them on the head 110 of the test human subject. Ring-shaped ear pads 124 are provided for the headphone casings 111a and 111b on the side surfaces of the headphone casings 111a and 111b on the test human subject side so as to be brought in close contact with the surroundings of the entrances of the external auditory meatuses 110a, and high frequency generating devices 120 are provided at the peripheries of the ear pads 124. Moreover, a number of high frequency generating devices 120 are provided at regular intervals on the surface of the headband 112 on the test human subject head 110 side. Further, a plurality of high frequency generating devices 120 are provided at the peripheries of the headphone casings 111a and 111b, and audible range loudspeakers 121 are provided in places corresponding to the external auditory meatuses 110a on the inner side surfaces of the headphone casings 111a and 111b. The circuits and devices 115, 115, 117, 120, 121 and 125 of the signal reproducing apparatus of FIG. 22 are placed in the headphone casings 111a and 111b, and a signal input plug 118 is connected to the input terminal of the signal band dividing circuit 115 of the signal reproducing apparatus. The signal input plug 118 is connected to, for example, the signal reproducing apparatus 90 or the signal reproducing apparatuses 90A and 90B of FIGS. 18A and 18B to 20 or the portable signal reproducing apparatus 140 of FIG. 25.

Referring to FIG. 22, an electrical signal of a hypersonic sound from, for example, the signal reproducing apparatus 90 or the signal reproducing apparatuses 90A and 90B of FIGS. 18A and 18B to 20 or the portable signal reproducing apparatus 140 of FIG. 25 is inputted to the signal band dividing circuit 115 configured by including two filters, and the signal band dividing circuit 115 filters the signal into a superhigh frequency signal exceeding, for example, 20 kHz and an audible range signal lower than, for example, 20 kHz. The former superhigh frequency signal is outputted to a high frequency generating device 120 via the signal amplifier 116 to generate and radiate a superhigh frequency vibration by the superhigh frequency signal by the high frequency generating device 120 and to radiate the vibration not only to the test human subject head 110 but also to the whole body. On the other hand, an audible range sound by the latter audible range signal is generated and radiated by the audible range loudspeaker 121 and radiated to the auditory sense of the test human subject via the external auditory meatuses 110a. It is noted that a power supply voltage from a compact battery 125 of, for example, a button battery is supplied to the parts 115 to 117 of the signal reproducing apparatus.

That is, the audible range component of the components that constitute the hypersonic sound is reproduced by the plurality of audible range loudspeakers 121 mounted in the casing portions in a manner similar to that of the ordinary headphone, and the superhigh frequency components exceeding the upper limit of the audible range are reproduced by a number of high frequency generating devices 120 provided at the headphone casings 111a and 111b and the headband 112. Therefore, the audible range sound constituting the hypersonic sound is applied to the auditory sense system, and the superhigh frequency vibration exceeding the upper limit of the audible range is applied widely to the human body surfaces including the head and the face, so that the hypersonic effect is effectively developed.

In the preferred embodiment of FIG. 21, a part of the high frequency generating devices 120 is obliquely disposed at an angle of, for example, about 75 degrees with respect to the side surface of the face of the listener, and a part of them is placed perpendicular to the face. The disposition angle may be another angle in correspondence with the sensitivity distribution of the superhigh frequency vibration or customized to the listener, and the high frequency generating devices 120 may be all disposed at an identical angle or disposed individually at different angles.

FIG. 23 is an appearance diagram and a block diagram showing a configuration of a signal reproducing apparatus of the cap mounting type according to the first modified preferred embodiment of the fifth preferred embodiment of the present invention, and FIG. 24 is a block diagram showing a configuration of the signal reproducing apparatus 131 of FIG. 23.

Referring to FIG. 23, a cap 130 is configured by including a visor portion 130a and a head accommodating cylindrical portion 130b, a number of high frequency generating devices 120 are provided on the lower surface of the visor portion 130a, and the signal reproducing apparatus 131 of FIG. 24 is built in a generally upper portion of the head accommodating cylindrical portion 130b. In the signal reproducing apparatus 131 of FIG. 24, a memory type player 132 preparatorily stores signal data of a hypersonic sound in a nonvolatile fixed memory of, for example, a flash memory. At the time of reproducing the signal data, the signal data is subjected to D/A conversion into an analog hypersonic sound signal by a D/A converter 133, and then, it is outputted to the high frequency generating devices 120 via a signal amplifier 134, so that the superhigh frequency vibration of the hypersonic sound is generated and radiated by the superhigh frequency generating devices 120. In this case, a number of high frequency generating devices 120 are provided on the lower surface of the visor portion 130a of the cap 130, and the superhigh frequency vibration of the hypersonic sound is generated and radiated substantially downward. Therefore, the superhigh frequency vibration is radiated toward the head, particularly his or her face and the whole body of the test human subject.

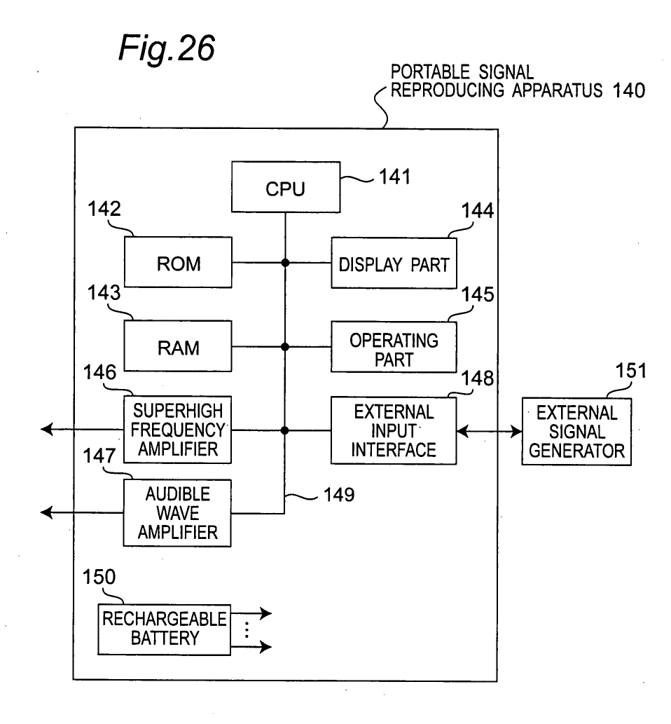

FIG. 25 is an appearance diagram and a block diagram showing a configuration of a signal reproducing apparatus of the eyeglass mounting type according to the second modified preferred embodiment of the fifth preferred embodiment of the present invention, and FIG. 26 is a block diagram showing a configuration of a portable signal reproducing apparatus 140 of FIG. 25. Among the superhigh frequency signal and the audible range signal from the portable signal reproducing apparatus 140 of FIG. 26, the superhigh frequency signal of the former is outputted to a plurality of high frequency generating devices 120 and radiated, while the audible range signal of the latter is outputted to a pair of audible range sound earphones 122 and radiated. In this case, the high frequency generating devices 120 are provided at a number of portions such as a temporal lower portion to an occipital portion of the eyeglasses, a face side portion, a temporal portion, an eyehole peripheral portion, a forehead, a nasal root portion, a face lower portion, a cheek to chin portion, a shoulder portion and so on. Moreover, the audible range sound reproducing earphones 122 are used by being inserted in the external auditory meatuses of the test human subject.

The portable signal reproducing apparatus 140 of FIG. 26 includes a CPU 141 that is a main control part for controlling the overall operation processing of the apparatus, a ROM 142 that stores a control program and data necessary for executing the program, a RAM 143 used as a working memory or a signal data memory, a display part 144 such as a liquid crystal display part for displaying the state of operation and so on, an operating part 145 including simple operation keys, a superhigh frequency amplifier 146, an audible wave amplifier 147 and an external input interface 148. These parts 141 to 148 are connected via a bus 149, and a power supply voltage is supplied to the parts 141 to 148 from a rechargeable battery 150. The signal data of the hypersonic sound generated by the external signal generator 151 is preparatorily inputted and stored into the RAM 143 via an external input interface 148. At the time of reproducing the hypersonic sound, the external signal generator 151 is separated from the apparatus 140, and the CPU 141 reads the signal data of the hypersonic sound stored in the RAM 143 by executing the control program stored in the ROM 142, and then, outputs the data to the superhigh frequency amplifier 146 and the audible wave amplifier 147. The superhigh frequency amplifier 146 filters the superhigh frequency signal exceeding the audible range of the signal data of the inputted hypersonic sound, then subjects the data to D/A conversion and power amplification, and outputs the resulting signal to the high frequency generating devices 120 to generate and radiate a superhigh frequency vibration. On the other hand, the audible wave amplifier 147 filters the audible range signal of the signal data of the inputted hypersonic sound, then subjects the data to D/A conversion and power amplification, and outputs the resulting signal to, for example, the earphone 122 to generate and radiate an audible range sound.

As described above, according to the present preferred embodiment, the method intended for effectively producing the hypersonic effect by using the headphone, applying the audible range sound that constitutes the hypersonic sound to the air-conducting auditory system and applying the superhigh frequency vibration exceeding the upper limit of the audible range to the human body surface is provided. That is, by placing a number of high frequency generating devices 120 on the headphone casings 111a and 111b, eyeglasses or the like simultaneously with reproducing the audible range sound by using a technique similar to that of the ordinary headphone and effectively applying the superhigh frequency vibration to the human body surface, the hypersonic effect is produced simply and effectively without using any loudspeaker system. That is, since it is effective to expose the high frequency vibration to the human body other than the human auditory sense system, it becomes possible to radiate the superhigh frequency vibration from the casings and the headband uniformly to the whole body by providing the apparatus with the structure, and the hypersonic effect can be effectively produced.

### Sixth Preferred Embodiment

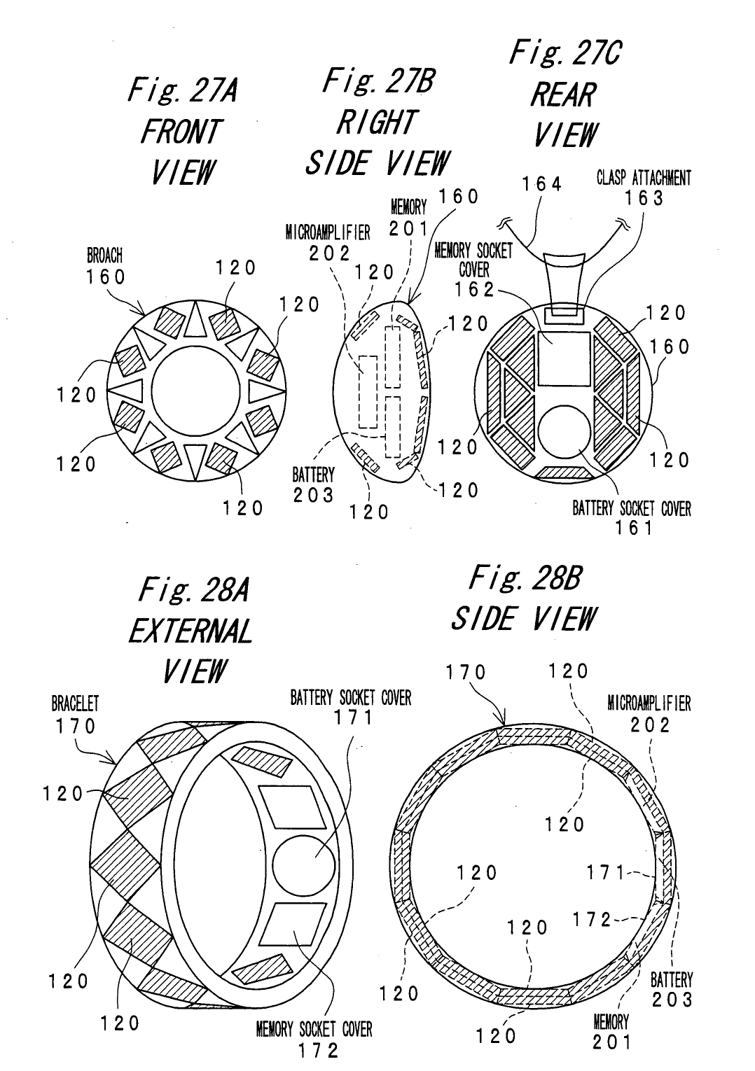

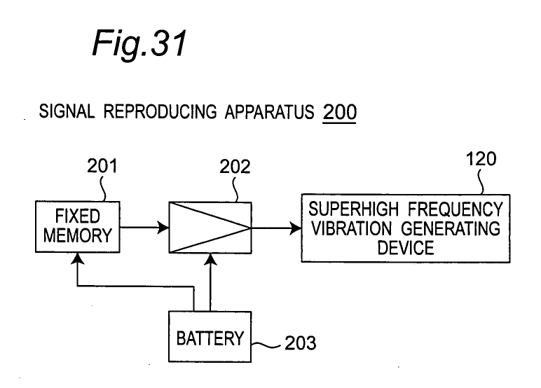

FIG. 27A is a front view of a broach 160 including the signal reproducing apparatus according to the sixth preferred embodiment of the present invention. FIG. 27B is a right side view of the broach 160, and FIG. 27C is a rear view of the broach 160. FIG. 31 is a block diagram of a signal reproducing apparatus 200 that generates a superhigh frequency vibration signal of a hypersonic sound to the superhigh frequency vibration generating devices 120 of the broach 160 of FIGS. 27A to 27C.

Referring to FIGS. 27A to 27C, a plurality of superhigh frequency vibration generating devices 120 are provided embedded in the front surface and the rear surface of the broach 160. Moreover, parts 201 to 203 of the signal reproducing apparatus 200 of FIG. 31 are provided embedded in the broach 160. A battery socket cover 161 and a memory socket cover 162 are provided on the rear surface of the broach 160, and a broach dangling clasp 164 is connected to a clasp attachment 163 located in an upper portion of the broach 160. In the signal reproducing apparatus 200 of FIG. 31, signal data of a hypersonic sound is preparatorily stored in a nonvolatile fixed memory 201 of, for example, a flash memory. At the time of reproduction, the signal data of the hypersonic sound read from the solid-state memory 201 is subjected to D/A conversion and power amplification in a microamplifier 202, and then, the resulting signal is outputted to the superhigh frequency vibration generating devices 120 to generate and radiate a superhigh frequency vibration.

As described above, according to the present preferred embodiment, the superhigh frequency vibration can be effectively applied to the human body surface by embedding a number of high frequency generating devices 120 in the broach 160, and the hypersonic effect is produced simply and effectively without using any loudspeaker system. Although the broach 160 is described in the preferred embodiment of FIGS. 27A to 27C, the present invention is not limited to this but allowed to be an accessory such as a pendant head or a loop-tie clip.

### Seventh Preferred Embodiment

FIG. 28A is an appearance diagram of a bracelet 170 including a signal reproducing apparatus according to the seventh preferred embodiment of the present invention, and FIG. 28B is a side view of the bracelet 170. Referring to FIGS. 28A and 28B, a number of superhigh frequency vibration generating devices 120 are provided embedded in a cylindrical peripheral portion of the bracelet 170 of a cylindrical shape, and the parts 201 to 203 of the signal reproducing apparatus 200 of FIG. 31 are provided embedded in the cylindrical inner peripheral portion. As shown in FIGS. 28A and 28B, a battery socket cover 171 and a memory socket cover 172 are provided in the cylindrical inner peripheral portions.

As described above, according to the present preferred embodiment, by embedding a number of high frequency generating devices 120 in the bracelet 170, the superhigh frequency vibration can be effectively applied to the human body surface, and the hypersonic effect is produced simply and effectively without using any loudspeaker system.

### Eighth Preferred Embodiment

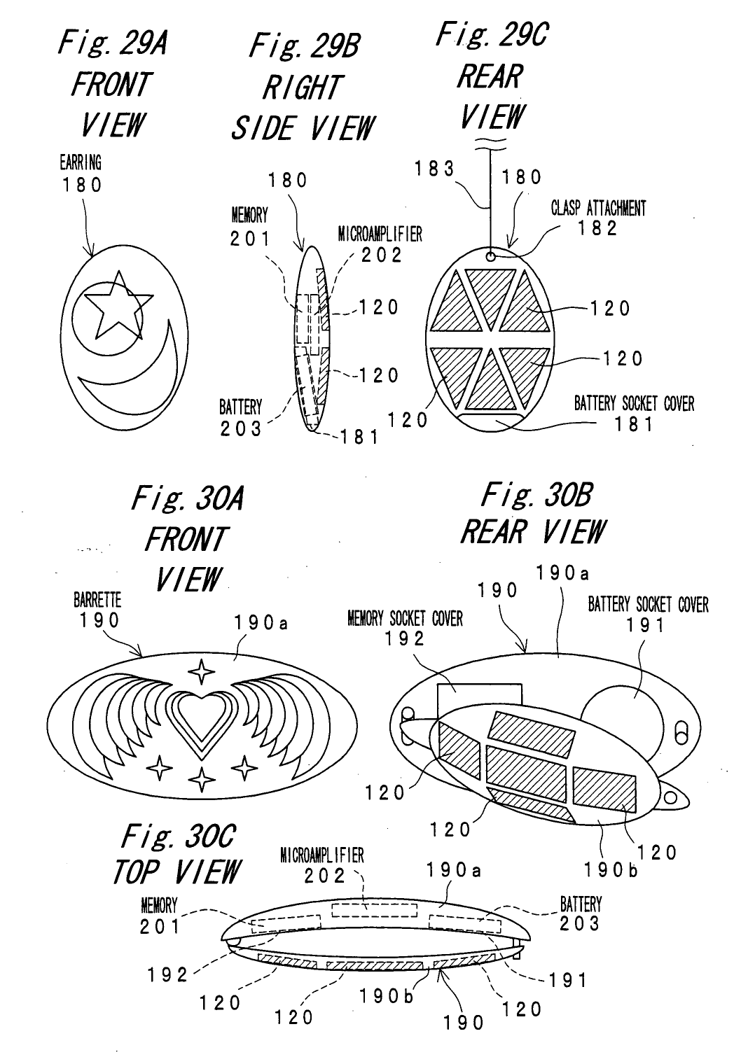

FIG. 29A is a front view of an earring 180 including a signal reproducing apparatus according to the eighth preferred embodiment of the present invention. FIG. 29B is a right side view of the earring 180, and FIG. 29C is a rear view of the earring 180. Referring to FIGS. 29A to 29C, the parts 201 to 203 of the signal reproducing apparatus 200 of FIG. 31 are provided embedded in the front surface, and a number of superhigh frequency vibration generating devices 120 are provided embedded in the rear surface of the earring 180. As shown in FIGS. 29A to 29C, a battery socket cover 181 is provided in its lower portion. A clasp attachment 182 is provided in its upper portion, and a dangling clasp 183 is connected to the clasp attachment 182.

As described above, according to the present preferred embodiment, by embedding a number of high frequency generating devices 120 in the earring 180, the superhigh frequency vibration can be effectively applied to the human body surface, and the hypersonic effect is produced simply and effectively without using any loudspeaker system.

### Ninth Preferred Embodiment

FIG. 30A is a front view of a barrette 190 including a signal reproducing apparatus according to the ninth preferred embodiment of the present invention. FIG. 30B is a rear view of the barrette 190, and FIG. 30C is a top view of the barrette 190. Referring to FIGS. 30A to 30C, a front surface portion 190a and a rear surface portion 190b are provided to be opened and closed via a hinge portion of the barrette 190. The parts 201 to 203 of the signal reproducing apparatus 200 of FIG. 31 are provided embedded in the front surface portion 190a, and a number of superhigh frequency vibration generating devices 120 are provided embedded in the rear surface of the rear surface portion 190b. As shown in FIGS. 30A to 30C, a battery socket cover 191 and a memory socket cover 192 are provided on the inner surface side of the front surface 190a.

As described above, according to the present preferred embodiment, by embedding a number of high frequency generating devices 120 in the barrette 190, the superhigh frequency vibration can be effectively applied to the human body surface, and the hypersonic effect is produced simply and effectively without using any loudspeaker system.

### Tenth Preferred Embodiment

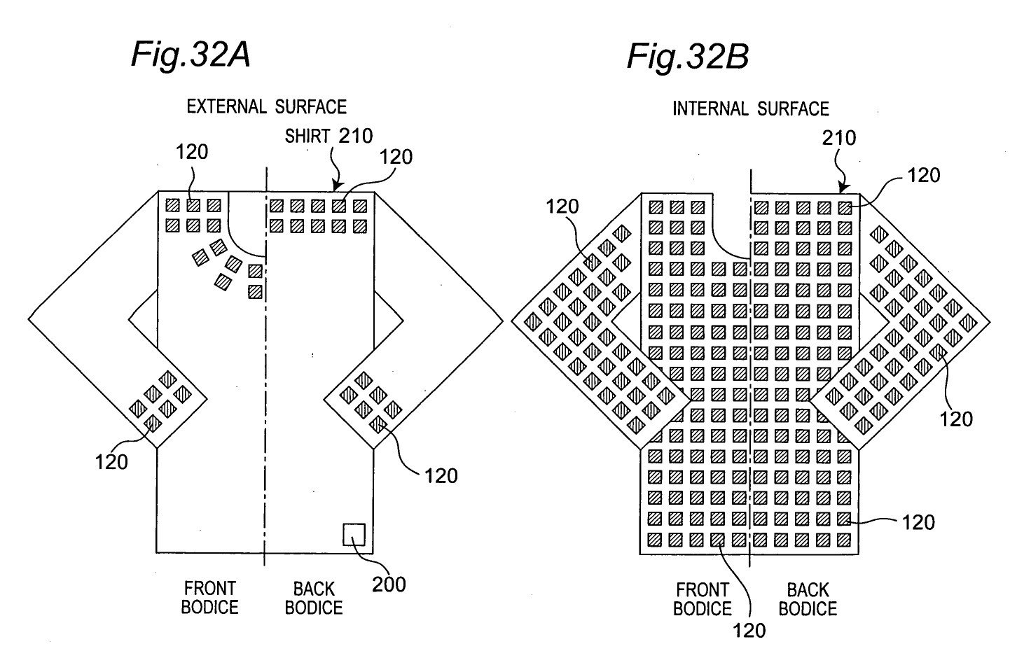

FIG. 32A is a front view showing an external surface of a shirt 210 including a signal reproducing apparatus 200 according to the tenth preferred embodiment of the present invention, and FIG. 32B is a front view showing an internal surface of the shirt 210.

Referring to FIGS. 32A and 32B, a number of superhigh frequency vibration generating devices 120 are provided substantially on the entire surface of the inside of the shirt 210 and at a sleeve portion, a collar portion and the like on the outside. Moreover, the signal reproducing apparatus 200 of FIG. 31 is provided in the vicinity of a hem portion of the shirt 210. In the shirt 210, concretely, a conductive plastic fiber coated with a nonconductive plastic is woven into a cloth, and part of the conductive plastic fiber is used as wiring between the signal reproducing apparatus 200 and each of the superhigh frequency vibration generating devices 120.

As described above, according to the shirt 210 of the present preferred embodiment as configured as above, a number of high frequency generating devices 120 are embedded in the shirt 210, and the superhigh frequency vibration can be generated in the whole body and effectively applied, so that the hypersonic effect is produced simply and effectively without using any loudspeaker system.

### Eleventh Preferred Embodiment

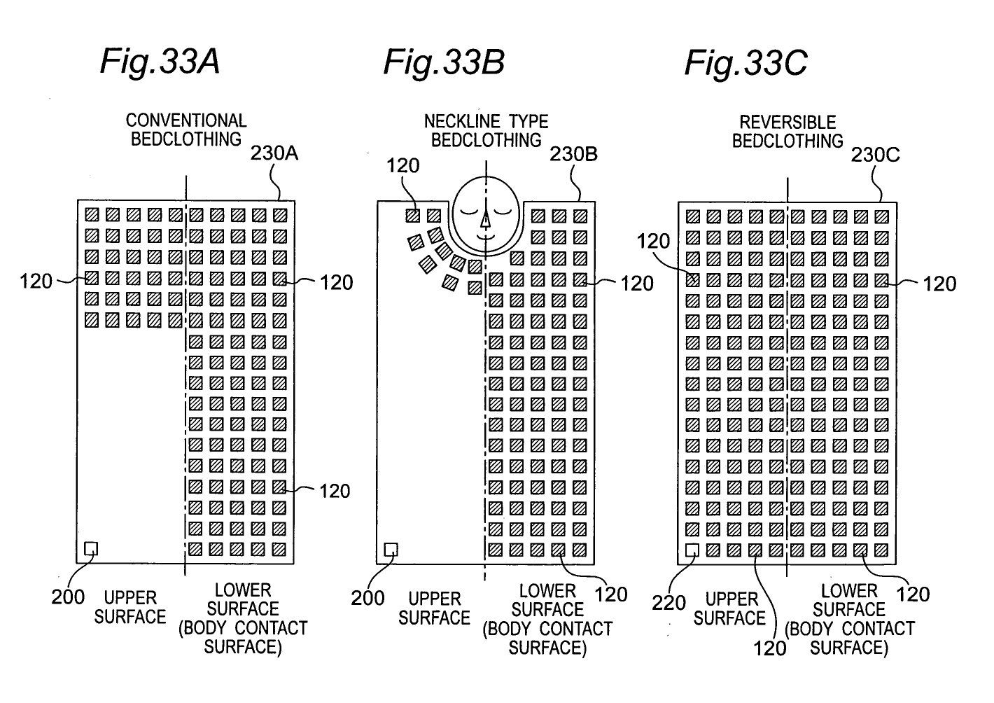

FIG. 33A is a front view showing an upper surface and the lower surface (body contact surface) of an ordinary type bedclothing (rug, blanket) 230A including a signal reproducing apparatus 200 according to the eleventh preferred embodiment of the present invention. FIG. 33B is a front view showing an upper surface and the lower surface (body contact surface) of a neckline type bedclothing (rug, blanket) 230B including the signal reproducing apparatus 200 according to the tenth preferred embodiment of the present invention. FIG. 33C is a front view showing an upper surface and the lower surface (body contact surface) of a reversible bedclothing (rug, blanket) 230C including the signal reproducing apparatus 200 according to the tenth preferred embodiment of the present invention.

In each of FIGS. 33A to 33C, a number of superhigh frequency vibration generating devices 120 are provided substantially on the entire surfaces of the inside and the outside of the bedclothes 230A, 230B and 230C. Moreover, the signal reproducing apparatus 200 of FIG. 31 is provided in the vicinity of, for example, the lower portions of the bedclothes 230A, 230B and 230C. In the bedclothes 230A, 230B and 230C, concretely, a conductive plastic fiber coated with a nonconductive plastic is woven into a cloth, and part of the conductive plastic fiber is used as wiring between the signal reproducing apparatus 200 and each of the superhigh frequency vibration generating devices 120 in a manner similar to that of the tenth preferred embodiment.

According to the bedclothes 230A, 230B and 230C of the present preferred embodiment as configured as above, a number of high frequency generating devices 120 are embedded in the bedclothes 230A, 230B and 230C, and the superhigh frequency vibration can be generated in the whole body and effectively applied, so that the hypersonic effect is produced simply and effectively without using any loudspeaker system.

### Twelfth Preferred Embodiment

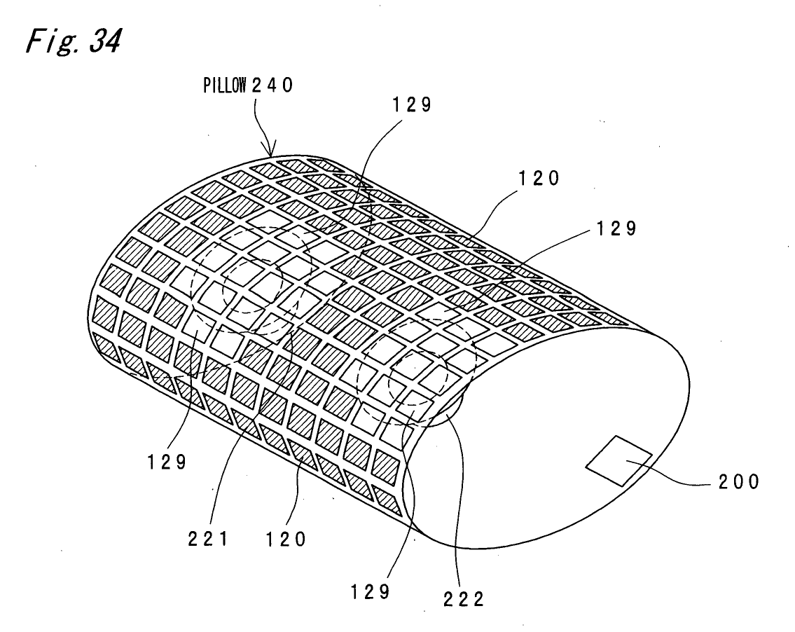

FIG. 34 is an appearance diagram of a pillow 240 including a signal reproducing apparatus 200 according to the twelfth preferred embodiment of the present invention. Referring to FIG. 34, a number of superhigh frequency vibration generating devices 120 are provided substantially on the entire surface of a cylindrical peripheral portion of the generally cylindrical pillow 240, and audible range sound reproducing loudspeakers 221 and 222 for reproducing the audible range sound are provided inside a device unmounted portion 219 where no superhigh frequency vibration generating device 120 is partially provided. Moreover, the signal reproducing apparatus 200 of FIG. 31 is provided inside the cylinder of the pillow 240. In concrete, a conductive plastic fiber coated with a nonconductive plastic is woven into a cloth, and part of the conductive plastic fiber is used as wiring between the signal reproducing apparatus 200 and each of the superhigh frequency vibration generating devices 120 in a manner similar to that of the tenth and eleventh preferred embodiments. It is noted that the loudspeakers 221 and 222 need not be provided.

According to the pillow 240 of the present preferred embodiment as configured as above, a number of high frequency generating devices 120 are embedded in the pillow 240, and the superhigh frequency vibration can be generated in the whole body and effectively applied, so that the hypersonic effect is produced simply and effectively without using any loudspeaker system.

### Thirteenth Preferred Embodiment

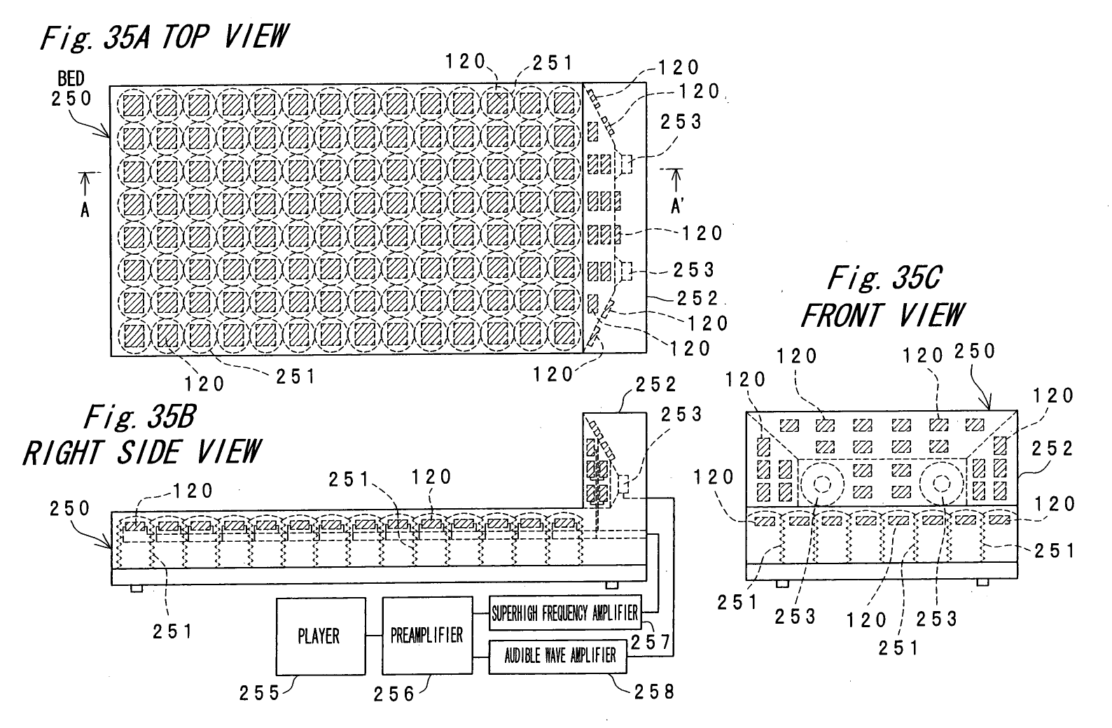

FIG. 35A is a top view of a bed 250 including a signal reproducing apparatus 200 according to the thirteenth preferred embodiment of the present invention. FIG. 35B is a right side view of the bed 250, and FIG. 35C is a front view of the bed 250.

Referring to FIGS. 35A to 35C, superhigh frequency vibration generating devices 120 are provided inside a plurality of bed springs 251 of the bed 250, and a number of superhigh frequency vibration generating devices 120 are provided also for a headboard 252. In this case, the superhigh frequency vibration generating devices 120 should preferably be placed in positions surrounded by the bed springs 251 in order to prevent troubles caused by the weight load of the user. Moreover, audible range reproduction loudspeakers 253, 253 for reproducing the audible range sound are provided for the headboard 252.

As shown in FIGS. 35A to 35C, the signal reproducing apparatus for the bed is configured by including a player 255, a preamplifier 256, a superhigh frequency amplifier 257 and an audible wave amplifier 258. The player 255 reproduces an electrical signal of a hypersonic sound, and outputs the signal to the preamplifier 256. The preamplifier 256 pre-amplifies the inputted electrical signal, and then, separates and filters the resulting signal into a superhigh frequency signal and an audible range signal by a prescribed filter. The superhigh frequency signal of the former is outputted to each of the superhigh frequency vibration generating devices 120 via the superhigh frequency amplifier 257 to generate and radiate a superhigh frequency vibration, and the audible range signal of the latter is outputted to the loudspeakers 253 and 253 via the audible wave amplifier 258 to generate and radiate an audible range sound.

According to the bed 250 of the present preferred embodiment as configured as above, a number of high frequency generating devices 120 are embedded in the bed 250, and the superhigh frequency vibration can be generated in the whole body and effectively applied, so that the hypersonic effect is simply and effectively produced without using any loudspeaker system.

### Modified Preferred Embodiment

In the above preferred embodiment, it is sometimes such a case that an apparatus having only a superhigh frequency vibration generating device or the like of the superhigh frequency component (HFC) is disclosed, the present invention is not limited to this but allowed to be configured to apply the superhigh frequency component (HFC) to only the auditory sense of the test human subject by a device such as an earphone.

Although the test human subject is a human being in the above preferred embodiment, the present invention is not limited to this but allowed to be applied to a living body such as an animal other than human being.

### Operational Effects of Combination of the Pet Measurement Device According to the First and Second Preferred Embodiments and Electronic Equipment and the Like According to the Third Through Thirteenth Embodiment

When electronic equipment or the like such as the headphones according to the third to thirteenth embodiments is measured by the PET measurement apparatus, noises from the PET measurement apparatus can be largely reduced. Therefore, the experiments can be conducted more accurately than in the prior art in the experiments by means of the electronic equipment or the like, and the superhigh frequency vibration generated by the high frequency generating devices 120 can be generated in the whole body and effectively applied to the test human subject, so that the experiments can be executed by producing the hypersonic effect simply and effectively without using any loudspeaker system. It is noted that the present invention is not limited to this but allowed to be configured by including only the electronic equipment of the latter without any combination.

### Concrete Examples of the Superhigh Frequency Vibration Generating Device 120

A detailed description and concrete examples of the superhigh frequency vibration generating device 120 employed in the above preferred embodiments are described below.

The high frequency components exceeding the audible range limit can be converted from an electrical signal into an elastic wave signal, and the superhigh frequency vibration generating devices 120 applicable to preferred embodiments are shown in the table below. Among them are included a number of components of supertweeters that have already been currently put to practical use and commercialized and those currently in researches and prototype manufacturing stages. These are each able to generate a high frequency vibration of not lower than several tens of kilohertz. Among others, some piezoelectric type ceramic vibration generating devices are able to generate a frequency up to 100 kHz, and some piezo-films are able to generate a frequency up to 300 kHz. Moreover, a nano-silicon vibration generating device that is currently under researches and developments is able to theoretically generate a superhigh frequency vibration ranging up to several gigahertzes (GHz).

TABLE 1

| | Diaphragm | Minimum | Gross Unit | Driving |
|---|---|---|---|---|
| Name | Material | Diameter | Weight | Method |
| Dome Type | Metal, Resin, | Several | Tens of Grams | Ordinary |
| | Ceramics, and | Centimeters | to Several | Amplifier |
| | Diamond | | Kilograms | |
| Cone Type | Metal, Resin, | Several | Tens of Grams | Ordinary |
| | and Ceramics | Centimeters | to Several | Amplifier |
| | | | Kilograms | |
| Printed | Resin Thin | Several | Hundreds of | Ordinary |
| Ribbon Type | Film | Centimeters | Grams to | Amplifier |
| | | | Several | |
| | | | Kilograms | |
| Ribbon Type | Metal Thin | Several | Several | Ordinary |
| | Film | Centimeters | Kilograms | Amplifier |
| Piezoelectric | Ceramic Piezo | Several | Tens of Grams | Ordinary |
| Type | Film | Centimeters | to Several | Amplifier |
| | | | Kilograms | |
| Capacitor | Resin Thin | Several | Tens of Grams | Amplifier |
| Type | Film | Centimeters | to Several | for special |
| | | | Kilograms | use |
| Nano-silicon | None | Several | Several Grams | Ordinary |
| Type | | Millimeters | to Tens of | Amplifier |
| | | | Grams | |

The superhigh frequency vibration generating devices 120 are described in detail below.

The dome type superhigh frequency vibration generating device is a device used also for the tweeter headphone of the most popularized type. Its principle is that, when an ac current proportional to an audio signal is flowed through a coil connected directly to a diaphragm, a force proportional to the audio signal is exerted by an electromagnetic force in the coil placed in a magnetic field to transduce the force into a physical movement of the diaphragm, and the vibration is transduced into an aerial vibration.

The cone type superhigh frequency vibration generating device, whose high frequency response is hard to extend as the most popularized tweeter for a midrange to low frequency range, is a minority used for headphones. Its principle is that, when an ac current proportional to an audio signal is flowed through a coil connected directly to a diaphragm, a force proportional to the audio signal is exerted by an electromagnetic force in the coil placed in a magnetic field to transduce the force into a physical movement of the diaphragm, and the vibration is transduced into an aerial vibration.

The printed ribbon type superhigh frequency vibration generating device, which has a thin light diaphragm, is therefore popularized as a supertweeter. Its principle is that, when an ac current proportional to an audio signal is flowed through a coil-shaped electrode line embedded in a diaphragm thin film, a force proportional to the audio signal is exerted by an electromagnetic force in the electrode line placed in a magnetic field to transduce the force into a physical movement of the vibration thin film, and the vibration is transduced into an aerial vibration.

The ribbon type superhigh frequency vibration generating device, which has a thin light diaphragm, is therefore popularized as a supertweeter and is disadvantageously heavier and larger than the printed ribbon type superhigh frequency vibration generating device. Its principle is that, when an ac current proportional to an audio signal is flowed through a metal thin film, a force proportional to the audio signal is exerted by an electromagnetic force in the metal thin film placed in a magnetic field to transduce the force into a physical movement of the metal thin film, and the vibration is transduced into an aerial vibration.

The piezoelectric type superhigh frequency vibration generating device, which has small examples in the product form, is, however, a device that can easily be reduced in weight since it needs no magnet. Its principle is that, when an ac current proportional to an audio signal is flowed through a piezoelectric device such as a ceramic or a piezofilm, the piezoelectric device is deformed to contract in proportion to the audio signal, and the deformation is transduced into an aerial vibration.

The capacitor type superhigh frequency vibration generating device, which needs a special amplifier for supplying a bias voltage and also has a good high frequency response, has many product examples as headphones and large-area full-range speakers than as a tweeter. Its principle is that, when an ac voltage proportional to an audio signal is applied to electrodes embedded in a vibration thin film, a force proportional to the audio signal is exerted by an electrostatic force between the thin film surface and a high voltage bias applied in the vertical direction to transduce the force into a physical movement of the vibration thin film, and the vibration is transduced into an aerial vibration.

The nano-silicon type superhigh frequency vibration generating device, which is in researches and prototype manufacturing stages, is a device that is theoretically capable of reproduction up to gigahertz and has a wide directivity characteristic since no physical vibration is exerted. Its principle is that, when an ac current proportional to an audio signal is flowed through a fixed electrode layer on the surface of the nano-silicon taking advantage of a superinsulation property of a nano-crystal porous silicon, the fixed electrode is heated in proportion to the audio signal, and the heat is totally transduced into a wave of condensation and rarefaction of air due to the adiabatic expansion of air.

### Implemental Example 1

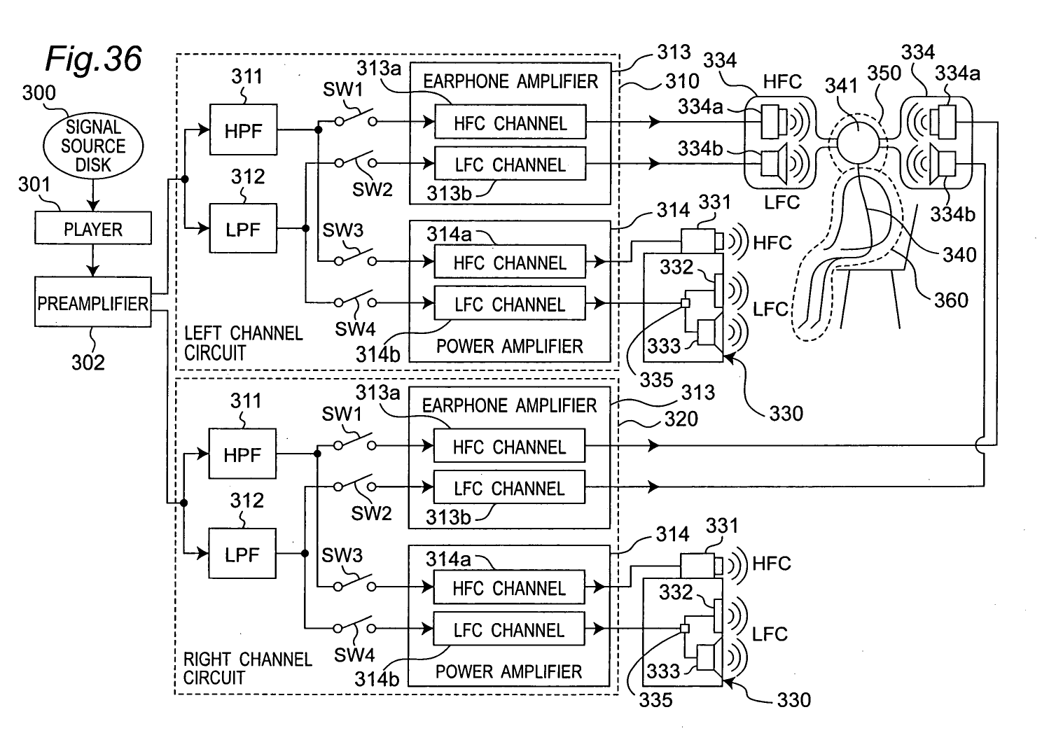

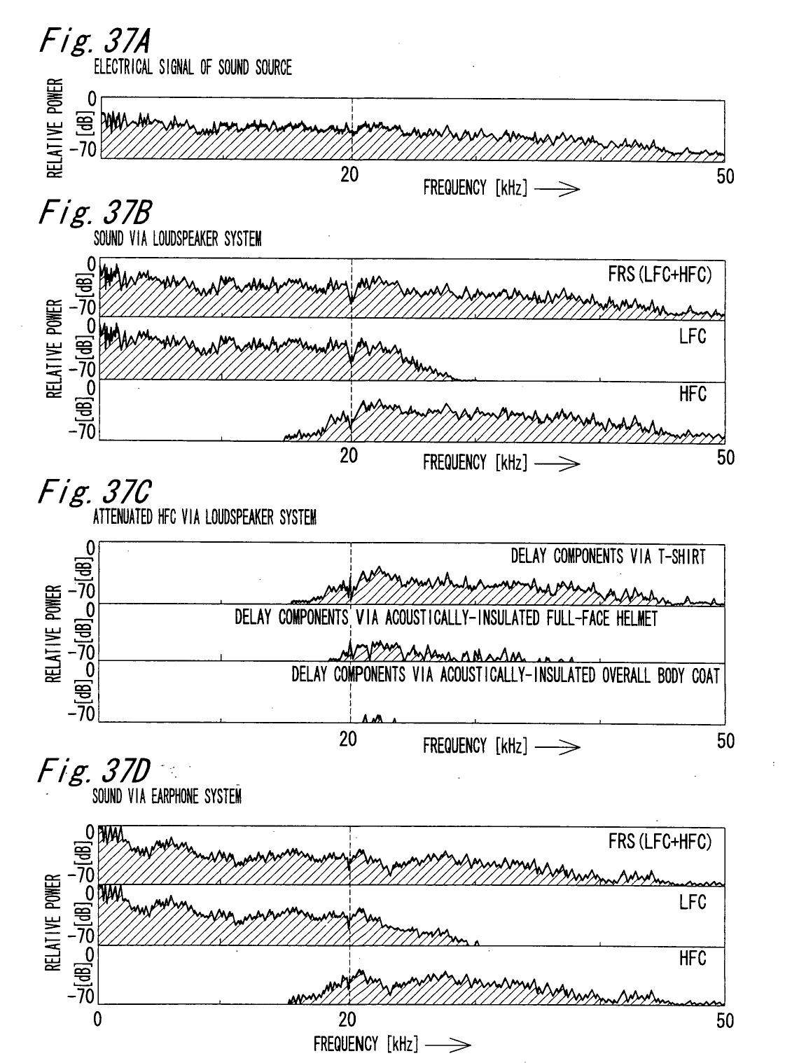

The present inventor and others conducted experiments using a hypersonic sound as follows and obtained the following experimental results. Therefore, the results are described below. In this case, the role of the biological system other than the air-conducting auditory system in the development of the hypersonic effect is particularly described with reference to FIGS. 36 to 42.

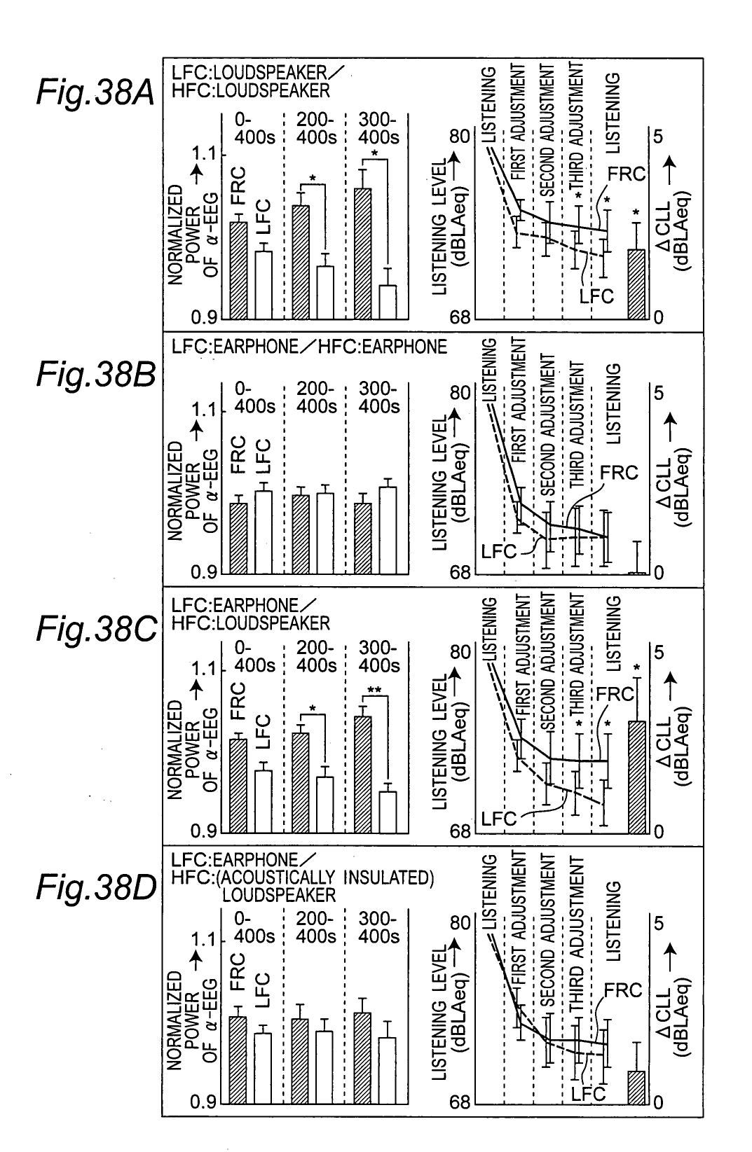

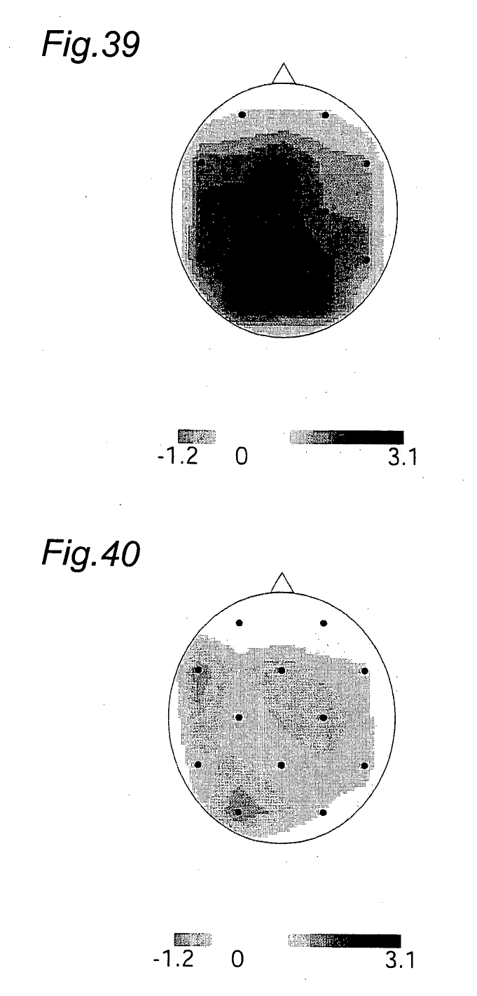

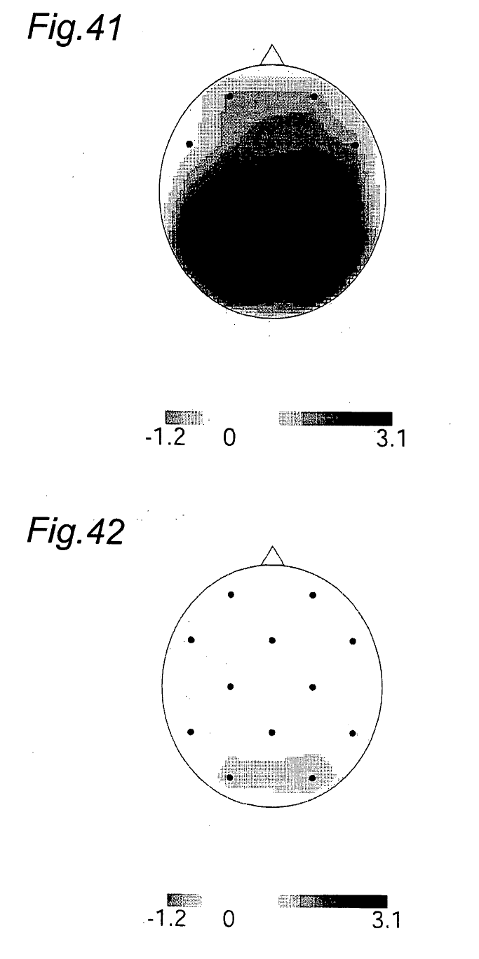

FIG. 36 is a block diagram showing a configuration of a signal recording and reproducing system according to the implemental example 1 of the present invention. FIG. 37A is a spectrum chart showing an electrical signal of a sound source in the signal recording and reproducing system of FIG. 36. FIG. 37B is a spectrum chart of a sound via a loudspeaker system in the signal recording and reproducing system. FIG. 37C is a spectrum chart of an attenuated superhigh frequency component (HFC) via the loudspeaker system in the signal recording and reproducing system. FIG. 37D is a spectrum chart of a sound via an earphone system in the signal recording and reproducing system. FIGS. 38A to 38D are experimental results of the signal recording and reproducing system of FIG. 36. FIG. 38A is a graph showing a normalized power of αEEG, a listening level and a comfortable listening level (ΔCLL) when the audible range component (LFC) is applied to the test human subject via the loudspeaker system and the superhigh frequency component (HFC) is applied to the test human subject via the earphone system. FIG. 38B is a graph showing a normalized power of αEEG, the listening level and the comfortable listening level (ΔCLL) when the audible range component (LFC) is applied to the test human subject via the earphone system and the superhigh frequency component (HFC) is applied to the test human subject via the earphone system. FIG. 38C is a graph showing a normalized power of αEEG, the listening level and the comfortable listening level (ΔCLL) when the audible range component (LFC) is applied to the test human subject via the earphone system and the superhigh frequency component (HFC) is applied to the test human subject via the loudspeaker system. FIG. 38D is a graph showing a normalized power of αEEG, the listening level and the comfortable listening level (ΔCLL) when the audible range component (LFC) is applied to the test human subject via the earphone system and the superhigh frequency component (HFC) is applied to the acoustically insulated test human subject via the loudspeaker system. FIG. 39 is a view showing a Z score (lower part of the figure shows a gray scale of the Z score) of an α2 band component intensity in the head of the test human subject in the case of FIG. 38A. FIG. 40 is a view showing a Z score (lower part of the figure shows a gray scale of the Z score) of the α2 band component intensity in the head of the test human subject in the case of FIG. 38B. FIG. 41 is a view showing a Z score (lower part of the figure shows a gray scale of the Z score) of the α2 band component intensity in the head of the test human subject in the case of FIG. 38C. FIG. 42 is a view showing a Z score (lower part of the figure shows a gray scale of the Z score) of the α2 band component intensity in the head of the test human subject in the case of FIG. 38D.

That is, FIG. 36 shows experimental system used in the experiments according to the present implemental example 1. Each stereo sound source signal was separated and filtered into the audible range component (LFC) and the superhigh frequency component (HFC) by high-pass and low-pass filters 311 and 312 having an attenuation factor of 80 db/octave and a frequency pass-band ripple of ±1 dB with a frequency of 22 kHz set as a crossover frequency. Both the signals were independently amplified and presented separately or simultaneously via the earphones 334 and 334 and/or the loudspeaker systems 330 and 330.

FIGS. 37A to 37D are average power spectrums calculated from all sound presentation periods of various acoustic materials, showing only the data of the left channel. FIG. 37A shows spectrum of the electrical signal of sound source, and FIG. 37B shows spectrums of the sound reproduced via the loudspeaker in a bi-channel reproduction system. The power was calculated on the basis of data recorded in the position of the test human subject 340. FIG. 37C shows spectrums of attenuated superhigh frequency component (HFC) presented via the loudspeaker systems 330 and 330 through clothing and a shield. The test human subject 340 wore a T-shirt in all the experiments except for the condition of wearing an acoustically insulated whole body coat 360 for acoustic shielding. FIG. 37D shows spectrums of a sound reproduced via the earphones 334 and 334 in the bi-channel reproduction system. In this case, the power was calculated from a signal recorded in a position apart by 3.5 cm that is an average length of the auditory meatus of adult men via the earphones 334 and 334.

FIGS. 38A to 38D and FIG. 42 show brain wave activities and the listening volume adjusted by the test human subject measured on different experimental conditions. FIGS. 38A and 39 show such a case that both the audible range component (LFC) and the superhigh frequency component (HFC) are presented via the loudspeaker systems 330 and 330, and FIGS. 38B and 40 show such a case that both the audible range component (LFC) and the superhigh frequency component (HFC) are presented via the earphones 334 and 334. FIGS. 39C and 41 show such a case that the audible range component (LFC) is presented via the earphones 334 and 334 and the superhigh frequency component (HFC) is presented via the loudspeaker systems 330 and 330. FIGS. 38D and 42 show such a case that the audible range component (LFC) is presented via the earphones 334 and 334, and the superhigh frequency component (HFC) is presented via the loudspeaker systems 330 and 330. Acoustic shielding was effected in order to prevent the body surface of the test human subject 340 from being exposed to the superhigh frequency component (HFC) (described in detail later). In this case, the left side graphs of FIGS. 38A to 38D show average values of the normalized spontaneous brain wave α components (α-EEG) of all the test human subjects and standard errors. Moreover, the mapping charts of FIGS. 39 to 42 show distributions on the scalp of the head 341 of the test human subject 340 of a value obtained by converting a statistic “t” value through pairwise comparison into a “z” value that does not depend on the degree of freedom with regard to the intensity of the α2 band component at each electrode in the last 100 seconds of sound presentation. FIGS. 39 to 42 show that the α2 band power is significantly higher than the single condition of the audible range component (LFC) on a FRS condition described later. Further, the right side graphs of FIGS. 38A to 38D show transitions of the average listening level of all the test human subjects 340, and the bar graphs show an averaged value (and standard error) of a difference (ΔCLL) between CLL on the FRS condition and the comfortable listening level (CLL) on the single condition of the audible range component (LFC). The positive values show that the comfortable listening level (CLL) has been higher on the FRS condition.

First of all, the outline of the implemental example 1 is described below. Despite that the human being cannot perceive the elastic vibration exceeding 20 kHz, an unsteady sound that abundantly contains the superhigh frequency component (HFC) activates the deep brain portions including the brain stem and the thalamus of the listener and causes various physiological, psychological and behavioral actions. The present inventor and others have reported these phenomena generically as the “hypersonic effect”. However, it is not clear whether the vibratory stimulation exceeding the upper limit of the audible range is perceived only via the classical auditory sense system or some other mechanisms are concerned in the transformation and perception. In the experiments according to the implemental example 1, it was examined how the development of the hypersonic effect differed depending on when the inaudible HFC and the audible LFC were selectively presented to the ears corresponding to the air-conducting auditory system and when they were presented to the human body surface of the whole body including the head that possibly included some other vibration receptor mechanisms by using two independent measurement indexes based on different principles, i.e., (1) the α2 component of the spontaneous brain wave recorded from the parieto-occipital center portion and (2) the spontaneous adjustment actions of the comfortable listening volume. With regard to those coincidental results, the hypersonic effect was generated only when the body surface including the head of the listener was exposed to HFC and not generated when HFC was selectively presented to the air-conducting auditory system. The results lead to difficulties in considering that the conventionally known air-conducting auditory system is singly concerned in the generation of the hypersonic effect and suggest that it is necessary to additionally consider the possibility of some biological systems different from the air-conducting auditory system concerned in the reception and transformation of the elastic vibration exceeding the upper limit of the human audible range.

Next, the background art of the implemental example 1 is described below. It is widely accepted that the human being cannot perceive the elastic vibration exceeding 20 kHz as a sound. Nevertheless, it is reported that the unsteady sound abundantly containing the superhigh frequency component (HFC) further increases the amount of bloodstream in the brain stem and the thalamus of the listener and further increases the power of the occipital a band component of the spontaneous brain wave as compared with quite the same sound except for the removal of the superhigh frequency component (HFC) from the sound (See, for example, Non-Patent Documents 13 to 15, 25 and 26). In addition, with the superhigh frequency component (HFC) contained, the listener comes to appreciate the sound listening more beautifully and pleasantly and spontaneously behaves to adjust the sound volume larger for comfortable listening, i.e., to select a larger comfortable listening level (CLL) (See, for example, Non-Patent Documents 13, 14, and 24 to 26). The present inventor and others generically named these phenomena the hypersonic effect. The discovery of the phenomena (See, for example, Non-Patent Document 14) has given a big impact to the acoustic industry and urged the development of new digital sound media of SACD, DVD-Audio and so on capable of recording a sound that contains the frequency components exceeding the upper limit of the audible range. However, the biological base concerning the production of the hypersonic effect is not yet clear.

The hypersonic effect has characteristics that are hard to explain by the conventional auditory sense physiology despite that it is a phenomenon closely related to the functions of the human auditory sense system. For example, in the case of the human being, an aerial vibration of a frequency exceeding 20 kHz is scarcely transmitted to the inner ear due to the mechanical characteristics of the auditory ossicles existing in the middle ear and the basilar membrane existing in the inner ear. Further, none of the wide reactions that cover the physiology, psychology and behaviors caused by the hypersonic effect can be caused by singly presenting HFC. This fact indicates that the effects produced by the superhigh frequency component (HFC) in the living body are generated not as a pure stimulus response to the elastic vibration having a specific frequency band but by complicated interactions with the audible range component (LFC) (meaning a sound in the audible range, and so forth). These facts make it difficult to explain the mechanism of generation of the hypersonic effect by the knowledges of the known auditory sense physiology without conflict at least at the present time point.

Accordingly, in the experiments of the implemental example 1, it was decided to examine whether the unique phenomenon of the hypersonic effect was the sole response of the ordinary air-conducting auditory nerve system as a first step to clarify the biological mechanism of the phenomenon and whether the concern of other reception and response systems could be denied or ignored. For the above purpose, by preparatorily separating and filtering the frequency components of a sound source that had been confirmed to be able to generate the hypersonic effect (See, for example, Non-Patent Document 15) into the audible range component (LFC) and the superhigh frequency component (HFC) exceeding the audible range and selectively producing the superhigh frequency component (HFC) to the air-conducting auditory system or, on the contrary, presenting the superhigh frequency component (HFC) to the human body surface that might have contained various vibration receptor systems excluding the air-conducting auditory system on the condition that the audible range component (LFC) was presented to the air conduction auditory system, it was decided to compare and examine whether a difference was generated in the hypersonic effect between both of them and what sort of difference it was if the difference was generated.

In the examination, if the possibility that some vibration receptor systems owned by the human body besides the airway auditory nerve system are concerned exist is taken into consideration, the whole body surface of the test human subject needs to be satisfactorily exposed to the superhigh frequency component (HFC) in order not to overlook them as far as possible. At the same time, in order to effectively achieve the comparison and examination, all sorts of elastic vibration noises other than those presented as the experimental conditions must sufficiently be excluded or interrupted from the experimental system. It was discovered through preliminary investigations that very serious limitations to disturb effective experiments existed in the functional magnetic resonance imaging (fMRI) and the positron-emission tomography (PET) that were currently the most powerful noninvasive brain function measurement method with regard to these points. That is, the detector portion of the MRI apparatus or the PET measurement apparatus, in which the test human subject must lie down during imaging generally has a cylindrical structure, and the structure prevents at an unignorable level the presentation sound or, above all, the superhigh frequency component (HFC) from directly reaching the body surface including the head. Additionally, in the MRI apparatus, a huge vibration generated by rapid switching of the inclined magnetic field reaches a sound volume much larger than that of the presentation sound and buries the presentation sound itself in the vibration, causing a decisive obstacle. Also, in the PET measurement apparatus, mechanical vibration noises including fan noises, which are emitted from the apparatus into the air or transmitted to the test human subject via the bed, contain a considerable amount of high frequency components (HFC) ranging beyond the upper limit of the audible range and intensely contaminate the presentation sound, obscuring the boundary between the presence and absence of the superhigh frequency component (HFC). Moreover, it is extremely difficult to remove these noises at present. It was discovered that the differences in the experimental conditions were not clearly reflected on the results by the preliminary experiments using the MRI apparatus and the PET measurement apparatus and it was extremely difficult to conduct experiments effective for the experimental purpose by using the ordinary MRI apparatus and the PET measurement apparatus at present.

Accordingly, in order to overcome the problem in the experiments according to the present implemental example, it was decided to conduct experiments by selecting a plurality of indexes free from the aforementioned obstacle observed in the MRI apparatus and the PET measurement apparatus from a plurality of indexes, which subtly perceived the occurrence of the hypersonic effect and was proved to be able to accurately measure the occurrence by track records and reported. From this point of view, mutually different two measurements and evaluation methods based on mutually different principles, which were a physiological measurement method using the spontaneous brain waves by a wireless transmission system as an index and a behavioral evaluation method (See, for example, Non-Patent Documents 13 and 24 to 26) using the optimal listening level adjusting method, were adopted. Since the spontaneous brain wave measurement by the wireless transmission system generates no mechanical vibration noise and the test human subject needs not lie on his or her head on the bed during measurement, the presentation sound can be made to easily reach a wide region of the body surface by making the test human subject take a sitting or standing posture. In this case, according to the experiments of the present implemental example, the average value of the α2 band component powers of the spontaneous brain waves (hereinafter referred to as α-EEG) recorded from seven electrodes in the central parieto-occipital region was particularly used as an electrophysiological index of the hypersonic effect. The background is based on the fact that the index is parallel to a change in the bloodstream in the deep brain tissues caused by a sound that contains the superhigh frequency component (HFC) (See, for example, Non-Patent Document 11).

As the result of the experiments, the fact that the hypersonic effect was generated when the superhigh frequency component (HFC) was presented to the human body surface including the head excluding the air conduction auditory system in contrast to the fact that the hypersonic effect was not generated when only the superhigh frequency component (HFC) was selectively presented was indicated as a coincidental result of the measurement index based on the two independent principles described above. The result suggests that it is difficult to establish a model in which only the already-known air conduction auditory system is singly concerned and the participation of other reception and response systems is denied with regard to the human reception response to an aerial vibration that abundantly contains the superhigh frequency component (HFC) exceeding the upper limit of the audible range observed in the hypersonic effect.

Next, the experimental method and the test human subject are described below. Healthy Japanese test human subjects participated in the experiments of brain waves and behaviors. Data of the number, the sexes, and the ages of the test human subjects who have participated in each experiment are shown in the chapter of the results. None of the test human subjects had clinical histories of neurological or psychiatric disorders. Written consents of all the test human subjects were obtained before the experiments. All the test human subjects had gotten accustomed and familiar to the actual sounds of the musical instruments used as sound sources.

Next, the sound source and the presenting system are described below. A traditional gamelan music of “GAMBANG KUTA” of Indonesia and Bali was used as a sound stimulus. The sound source abundantly contains the superhigh frequency component (HFC) having a remarkable fluctuation structure and has track records in generating a hypersonic effect through the past experiments. A bi-channel sound presenting system (See, for example, Non-Patent Documents 15 and 26) was used to present the sound stimulus. The sound was separated and filtered into an audible range component (LFC) and a superhigh frequency component (HFC) by high-pass and low-pass filters (CF-6FH and CF-6FL produced by NF Corporation residing at City of Yokohama in Japan) having an attenuation factor of 80 db/octave and a frequency pass-band ripple of ±1 dB with a frequency of 22 kHz set as a crossover frequency, and the frequency components were independently amplified, and then, they were presented separately or simultaneously via the earphones 334 and 334 or the loudspeaker systems 330 and 330. Conventionally, in the typical sound presenting system that has been used to present a sound for sound quality evaluation, the full-range sound containing the superhigh frequency component (HFC) is presented as an unfiltered sound source signal that has passed through an all-pass circuit. In contrast to this, a superhigh frequency component (HFC) free sound from which the high frequency is removed has been presented as a sound source signal that has passed through a low-pass filter (See, for example, Non-Patent Documents 10 and 16). Therefore, the signal of the audible range component (LFC) is to be presented through separate circuits of which the transmission characteristics of the frequency responses, the group delay frequency responses and so on are mutually difficult. In addition, it is possible that a cross modulation distortion exerts different influences on the audible range component (LFC) between both conditions. Therefore, even if a certain difference is detected between the sound that contains the superhigh frequency component (HFC) and the sound that does contain the component, it is difficult to eliminate the possibility that the difference is attributed not to the effect of the addition of the superhigh frequency component (HFC) but to the difference in the audible range component (LFC). According to the bi-channel presenting system (See, for example, Non-Patent Document 26) invented and developed by the present inventor and others and used in the present experiments, these problems are theoretically prevented.

Next, the configuration of the system of FIG. 36 is described below. In FIG. 36, like components are denoted by like reference numerals.

Referring to FIG. 36, a signal source disk (e.g., a recording medium such as DVD-ROM or DVD-R) in which the signal data of a prescribed hypersonic sound has preparatorily been recorded is set in a player 301, and the signal data of the hypersonic sound is reproduced. The signal data is subjected to D/A conversion and amplification in the preamplifier 302, and then, it is inputted to the high-pass filter (HPF) 311 and the low-pass filter (LPF) 312 of a left channel circuit 310 and a right channel circuit 320. The left channel circuit 310 and the right channel circuit 320 are similarly constituted by including the high-pass filter (HPF) 311, the low-pass filter (LPF) 312, four switches SW1, SW2, SW3 and SW4, an earphone amplifier 313 configured by including an HFC channel earphone amplifier 313a and an LFC channel earphone amplifier 313b, and a power amplifier 314 configured by including an HFC channel power amplifier 314a and an LFC channel power amplifier 314b. In both the channel circuits 313 and 314, an electrical signal of the superhigh frequency component (HFC) outputted from the high-pass filter 311 is outputted to a tweeter earphone device 334a of the earphone 334 via the switch SW1 and the HFC channel earphone amplifier 313a and outputted to a tweeter 331 of the loudspeaker system 330 via the switch SW3 and the HFC channel power amplifier 314a. Moreover, an electrical signal of the audible range component (LFC) outputted from the low-pass filter 312 is outputted to a full-range earphone device 334b for audible range reproduction of the earphone 334 via the switch SW2 and the LFC channel earphone amplifier 313b and outputted to a full-range speaker 332 and a woofer 333 for audible range reproduction via the switch SW4, the LFC channel power amplifier 314b and a power distribution network 335 of the loudspeaker system 330.

In this case, one pair of loudspeaker systems 330 and 330 are placed at both the right and left sides of the test human subject 340, and one pair of earphones 334 and 334 are inserted in the external auditory meatuses of both the ears of the test human subject 340. Depending on the following experimental conditions, the head 341 of the test human subject 340 is substantially totally covered with a full-face helmet 350, and the substantial whole body other than the head 341 of the test human subject 340 is substantially totally covered with an acoustically-insulated overall body coat 360. Moreover, depending on the following experimental conditions, the switches SW1, SW2, SW3 and SW4 are turned and or off. In this case, one pair of loudspeaker systems 330 and 330 are placed in positions located at a distance of 20.0 meters from the ears of the test human subject 340. Moreover, an insertion type earphone 334 with no ear pad originally developed was used. An auditory meatus insertion portion of the earphone 334 forms a casing structure of a thickness of about two to three millimeters by an injection mold of a rigid plastic, and both the right and left channels have respective two vibration generating earphone devices 334a and 334b for the superhigh frequency component (HFC) and the audible range component (LFC).

FIGS. 37A to 37D show power spectrums such that an aerial vibration actually reproduced by using the bi-channel presenting system of FIG. 36 are recorded by a microphone (Model 4939 produced by B&K) in the position of the test human subject. The average power spectrum of all the musical pieces used analyzed for 200 seconds by an FFT analyzer (produced by ONO SOKKI) is shown. The test human subjects were (had been or already) instructed to push a button when he or she felt a sense different from the soundless state at any point without being limited to the auditory sense, and only the superhigh frequency component (HFC) used for the experiments was presented. As a result, it was confirmed that none of the test human subjects was able to specify a difference to the soundless state in every case where the superhigh frequency component (HFC) was presented from any of the loudspeaker systems 330 and 330 and the earphones 334 and 334. This fact satisfactorily agrees with the knowledge that the human being cannot recognize the elastic vibration in the frequency band exceeding 20 kHz as a sound (See, for example, Non-Patent Documents 6, 20 and 23).

Brain wave experiments and behavioral experiments were each constituted of four sub-experiments. That is, the experimental conditions of the four sub-experiments are as follows.

(1) Both of the audible range component (LFC) and the superhigh frequency component (HFC) are presented via the loudspeaker systems 330 and 330.

(2) Both of the audible range component (LFC) and the superhigh frequency component (HFC) are presented via the earphones 334 and 334.

(3) The audible range component (LFC) is presented via the earphones 334 and 334, and the superhigh frequency component (HFC) is presented via the loudspeaker systems 330 and 330.

(4) The audible range component (LFC) is presented via the earphones 334 and 334, and the superhigh frequency component (HFC) is presented via the loudspeaker systems 330 and 330. However, the head 341 and the body surface of the test human subject 340 are covered with the full-face helmet 350 and the acoustically-insulated coat 360 that are sound insulation materials so that the portions are not exposed to the superhigh frequency component (HFC).

Two conditions were compared with each other in all the experiments. That is, the conditions are the full-range state condition (hereinafter referred to as an FRS condition) in which the audible range component (LFC) and the superhigh frequency component (HFC) are presented, and an LFC single condition in which only the audible range component (LFC) is presented. All the experiments were conducted in an acoustically isolated room. Special attentions were paid to the environment around the test human subject 340 in order to prevent uncomfortableness.

Next, the measuring method of EEG is described below. In each of the experiments, two trials P, Q were conducted in the order of the trial P, the trial Q, the trial Q and the trial P at inter-trial intervals of several minutes with regard to each of the FRS condition and the LFC single condition. The FRS condition and the LFC single condition were each distributed into the trial P and the trial Q or the trial Q and the trial P for each test human subject, and the distributing manner was balanced in terms of count values among the test human subjects. In each of the trials P, Q, sound presentations such that all the musical pieces were repeated two times and continued for 400 seconds were performed. In this case, the test human subjects 340 were instructed to naturally open their eyes. The brain waves were recorded by the filter setting of 1 to 60 Hz (−3 dB) with an earlobe connection as a reference electrode from twelve electrodes (electrode names: Fp1, Fp2, F7, Fz, F8, C3, C4, T5, Pz, T6, O1, and O2) on the scalp based on the international 10-20 method by using WEE-6112 Model telemetry system in order to minimize the constraint level to the test human subjects 340 and served as the objects of frequency component analyses. The power of each electrode was obtained by FFT at a sampling frequency of 256 Hz with a frequency resolution of 0.5 Hz for an analytical period of two seconds with an overlap of one second. Thereafter, the square root of the power of the 10.0 to 13.0 Hz band component at each electrode was calculated as an equivalent potential of the α2 band brain waves. In order to remove variations among the test human subjects, the data of each electrode was normalized by a value averaged throughout all the analytical periods, all the electrodes and all the conditions of each test human subject. After excluding the interval including the artifact (defective portion), data obtained from seven electrodes (electrode names: C3, C4, T5, Pz, T6, O1, and O2) in the central parieto-occipital region were averaged, and the average value was used as α-EEG for comparison between the two conditions. It is disclosed that the index is significantly correlated to the activity of the whole neural network at the deep brain region considered to be the neural base of the hypersonic effect (See, for example, Non-Patent Document 11).

Since the elapsed time data of the brain waves exhibits an apparent delay to the sound presentation (See, for example, Non-Patent Document 15), statistical evaluations of the difference between the FRS condition and the LFC single condition were conducted by a t-test correspondent to the entire period of 400 seconds, the latter half 200 seconds and the last 100 seconds. Moreover, a statistic t-value when the intensity of the α2 band component at each electrode was compared between both the conditions was converted into a z-value that was not influenced by the degree of freedom, and values at 2565 lattice points were calculated by linear interpolation on the basis of the value (See, for example, Non-Patent Documents 5 and 22). By forming an equi-potential color map on the basis of the data, a distribution of a change in the a band component on the scalp was also examined.

Next, a comfortable listening level is described below. In each of the experiments, every two sessions were conducted at inter-trial intervals of several minutes for each of the FRS condition and the LFC single condition, and the order was counterbalanced between the test human subjects. One session was constituted of five trials, each of which corresponds to the presentation of a sound sample for 200 seconds. In one session, an identical one of either the FRS condition or the LFC single condition was consistently presented. The listening volume level was measured as an equivalent sound pressure level or an equivalent noise level (equivalent continuous A-weighted sound pressure level) [unit: LAeq] by using an integrated noise meter (Model LA-5111 produced by ONO SOKKI). It is specially noted that the measured value of the equivalent noise level is not influenced by the existence of the superhigh frequency component (HFC) of not lower than 22 kHz since only the equivalent continuous sound pressure level (LAeq) of the frequency component of not higher than 20 kHz is measured according to the measurement method. In the first session, the test human subjects listened to the sound at a fixed volume. The sound volume level corresponded to 79.5 dB (LAeq) when the sound was presented via the loudspeaker systems 330 and 330, and a level felt subjectively at the same level was set when the sound was presented via the earphones 334 and 334. In the subsequent three sessions, the test human subjects were instructed to freely adjust the sound volume to a level felt subjectively the most comfortable. The volume adjustment was performed by remotely controlling an electric fader (electric volume controller: PGFM3000 Model produced by Penny and Giles of United Kingdom) inserted between the player 301 and the preamplifier 302 by an up-and-down switch. When the test human subjects adjusted the sound volume, neither visual nor tactual clue information was given. Subsequently, at the final trial, the test human subjects listened to the music at a volume that the test human subjects had finally adjusted at the previous session. The listening volume at the final trial measured as described above was set as CLL. These experiments were conducted under double blind conditions. That is, one experimenter took charge of the presentation of sound stimuli, and another experimenter who was not informed of the presentation conditions took charge of teaching to the test human subjects and the measurement of the listening volume level. The test human subjects did not know which of the FRS condition and the LFC single condition each session corresponded to. Statistical evaluations were made by using the correspondent t-test.

Next, the EEG experiment results are described below. When the audible range component (LFC) and the superhigh frequency component (HFC) were presented to the test human subjects 340 (five men and seven women with ages of 25 to 51 years) via the loudspeaker systems 330 and 330 under the FRS condition, it was confirmed that α-EEG was significantly increased as compared with the LFC single condition and the hypersonic effect was generated (See the left side graph of FIG. 38A and FIG. 39). The increase in α-EEG became more remarkable toward the latter half of the sound presentation period (the significance probability p=0.17 for the total 400 seconds, the significance probability p=0.047 for the latter half 200 seconds, and the significance probability p=0.021 for the last 100 seconds). This coincides with the past report of the present inventor and others reporting that the development and the disappearance of the hypersonic effect are accompanied by a time delay (See, for example, Non-Patent Document 15).

When both the components of the audible range component (LFC) and the superhigh frequency component (HFC) were presented limitedly to the ears via the earphones 334 and 334 (test human subjects: six men and nine women with ages of 25 to 65 years), no difference was recognized in α-EEG between the FRS condition and the LFC single condition (See the left side graph of FIG. 38B and FIG. 40. The significance probability p=0.45 for the total 400 seconds, the significance probability p=0.88 for the latter half 200 seconds, and the significance probability p=0.41 for the last 100 seconds). In contrast to this, when the audible range component (LFC) was presented via the earphones 334 and 334 and the superhigh frequency component (HFC) was presented mainly to the head and the body surface on the front side of the body via the loudspeaker systems 330 and 330 (seven men and eight women with ages of 25 to 65 years), α-EEG was significantly increased for the latter half of the presentation time on the FRS condition as compared with the LFC single condition (See the left side graph of FIG. 38C and FIG. 41. The significance probability p=0.054 for the total 400 seconds, the significance probability p=0.029 for the latter half 200 seconds, and the significance probability p=0.0020 for the last 100 seconds). On the other hand, when the heads 341 and the body surfaces of the test human subjects 340 (five men and eight women with ages of 25 to 65 years) were shielded from exposure to the superhigh frequency component (HFC) presented via the loudspeaker systems 330 and 330 by using the acoustically insulated full-face helmet 350 and the acoustically-insulated overall body coat 360, an increase in α-EEG on the FRS condition was remarkably suppressed (See the left side graph of FIG. 38D and FIG. 42. The significance probability p=0.42 for the total 400 seconds, the significance probability p=0.64 for the latter half 200 seconds, and the significance probability p=0.47 for the last 100 seconds). These data indicate that the hypersonic effect is generated only when the superhigh frequency component (HFC) is presented so as to reach the head 341 and/or the body surface.

Next, the behavioral experiments and the experimental results are described below. The behavioral measurements using the comfortable listening level CLL coincided with the results of the brain wave experiments. When both the audible range component (LFC) and the superhigh frequency component (HFC) were presented to the test human subjects (five men and five women with ages of 25 to 65 years) via the loudspeaker systems 330 and 330 (See the right side graph of FIG. 38A) or when the audible range component (LFC) and the superhigh frequency component (HFC) were presented to the test human subjects 340 (five men and five women with ages of 31 to 65 years) via the earphones 334 and 334 and the loudspeaker systems 330 and 330, respectively (See the right side graph of FIG. 38C), the test human subjects 340 spontaneously largely adjusted the sound volume for comfortable listening on the FRS condition as compared with the LFC single condition. In contrast to this, when both the audible range component (LFC) and the superhigh frequency component (HFC) were presented to the test human subjects 340 (three men and six women with ages of 25 to 50 years) via the earphones 334 and 334, the test human subjects adjusted the listening level to the same volume on the FRS condition and the LFC single condition (See the right side graph of FIG. 38B. The significance probability p=0.96). When the audible range component (LFC) and the superhigh frequency component (HFC) were presented to the test human subjects 340 (four men and five women with ages of 34 to 65 years) shielded from exposure to the superhigh frequency component (HFC) via the earphones 334 and 334 and the loudspeaker systems 330 and 330, respectively, an increase in the comfortable listening level CLL on the FRS condition was remarkably suppressed (See the right side graph of FIG. 38D, and the significance probability p=0.27).

Next, the experimental results described above are considered below. In the present experiments, it was examined whether the possibility of the concern of the reception and response system other than the air conduction auditory system in the generation of the phenomenon could be denied as a first step to clarify the generation mechanism of the hypersonic effect. Therefore, by presenting the audible range component (LFC) and the superhigh frequency component (HFC) to a wide region of the body surface including the head 341 of the test human subject 360 via the loudspeaker systems 330 and 330 and selectively from the ears only to the air conduction system via the earphones 334 and 334 in various combinations, the state in which the hypersonic effect was developed was examined. Both the two measurement and evaluation methods of mutually different principles selected as methods of high adaptability to the unique conditions required by the experiments, i.e., the α2 band power (α-EEG) measurement method of the spontaneous brain waves recorded from the electrodes at the central parieto-occipital region and the comfortable listening level evaluation method of the behavioral evaluation index produce clear cut results, which have been hard to achieve in the preliminary investigations by using a PET measurement apparatus and an fMRI apparatus and consequently support the propriety of the selection of the methods in the present experiments.

The intracerebral portion having a neural activity correlated to the power of the occipital dominant rhythm of the brain waves is roughly divided into three (See, for example, Non-Patent Document 19). The first is the activity of the cerebral cortex that is the direct potential generation source of the α wave, and the activity of the occipital visual cortex indicating a negative correlation to the power of the α wave correspond to it. The second is the activity of the cortex-subcortex loop directly related to the rhythm formation although it is not a direct potential generation source of the α wave, and the thalamus corresponds to it. The third is a portion reflecting a functional link that exerts indirect influence on the appearance of the alpha wave, and the limbic system and the brain stem are considered to correspond to it. The change in α-EEG used in the examination of the present implemental example is considered to be related to the latter two. When the simultaneous measurement data of the brain waves and the amount of cerebral blood flow (See, for example, Non-Patent Document 15) that the present inventor and others previously reported was analyzed again by a principal component analysis (See, for example, Non-Patent Document 11), a neural network expanding to the prefrontal region and the anterior cingulate gyrus around the deep brain regions of the thalamus, the brain stem and the hypothalamus was extracted as the first principal component indicating the most remarkable change in the amount of cerebral blood flow between the FRS condition and the LFC single condition. The intensity of the first principal component of the cerebral blood flow indicated a statistically significant positive correlation to the potential of the α2 band recorded from each of the seven electrodes (electrode names: C3, C4, T5, Pz, T6, O1, and O2) ranging from the central region to the parieto-occipital region of the brain wave components measured simultaneously and also indicated a significant positive correlation to the average value of them (See, for example, Non-Patent Document 11). The remarks also coincide with the past report of the present inventor and others (See, for example, Non-Patent Documents 15 and 18) and other reports (See, for example, Non-Patent Document 7). Further, the remarks do not conflict with the remarks of the activation of the thalamus and the brain stem by a sound that abundantly contains the superhigh frequency component (HFC) reported so far as a neuro-physiological base of the hypersonic effect by the present inventor and others. Therefore, it is appropriate to consider that the hypersonic effect detected by the brain wave index used in the present implemental example reflects the activation of the deep brain neural network including the brain stem and the thalamus to a considerable extent. These cerebral regions are considered to induce approach actions by inducing a pleasant sensation via a reward system (See, for example, Non-Patent Document 21) since the monoamine nerve system is projected on various regions in the brain including the prefrontal region (See, for example, Non-Patent Document 17).

The comfortable listening level CLL is an index used for detecting a slight difference in the sound quality such that the test human subject cannot be conscious of it or simply verbally express the same (See, for example, Non-Patent Documents 3 and 12). A fundamental strategy of the measurement is that the test human subject behaves to receive a more preferable stimulation at a larger sound volume. Therefore, it can be considered that the experimental results using the comfortable listening level CLL of the test human subject's behaving to receive a sound containing the superhigh frequency component (HFC) at a larger volume, i.e., by a larger quantity reflect the activities of the reward system of the brain in a certain manner. The explanation satisfactorily coincides with the results of the brain wave experiments. On the other hand, it may be possible to explain that the superhigh frequency component (HFC) has a certain depression effect and the effect is produced only when the depressive matter (i.e., the audible range component (LFC) in the present implemental example) is simultaneously presented. The possibility could not be made clear from the experiments of the present implemental example.

An important point in the configuration of the experiments of the present implemental example resides in an attention to the specificity that the hypersonic effect is not developed singly by the superhigh frequency component (HFC) but developed by an interaction of the superhigh frequency component (HFC) with the audible range component (LFC). On the basis of this fact, responsive reactions under the FRS condition in which the superhigh frequency component (HFC) and the audible range component (LFC) are simultaneously presented and under the LFC single condition in which the audible range component (LFC) is singly presented were compared with each other under the conditions that the presence or absence of the participation of the air conduction system or other systems were clearly reflected. The test human subjects could not feel a sound even when the superhigh frequency component (HFC) was presented via either the loudspeaker systems 330 and 330 or the earphones 334 and 334. Nevertheless, under the conditions that both the superhigh frequency component (HFC) and the audible range component (LFC) were reproduced via the loudspeaker systems 330 and 330 and both the components are presented to a wide range of the body surface that might have other reception and response systems in parallel with the ordinary air conduction auditory system, the results that the power of the α2 band was increased statistically significantly and the larger comfortable listening volume was selected statistically significantly as compared with such a case that only the audible range component (LFC) was similarly presented via the loudspeakers, and the development of the hypersonic effect was confirmed. This coincides with the past report (See, for example, Non-Patent Documents 13 to 15 and 24 to 26).

On the other hand, when both the superhigh frequency component (HFC) and the audible range component (LFC) were selectively presented only to the air conduction auditory system via the earphones 334 and 334, the development of the hypersonic effect was not recognized by either one of the two indexes. The condition is an ideal setting to purely present the audible range component (LFC) and the superhigh frequency component (HFC) only to the air conduction auditory system. If the hypersonic effect is induced by the participation of only the air conduction auditory system, the development of the hypersonic effect is expected to be observed in an ideal state corresponding to it. Nevertheless, the fact that the development of the hypersonic effect is not recognized at all leads to an important reservation to the possibility of the reception and response of the air conduction auditory system to the superhigh frequency component (HFC).

In contrast to the above, when the superhigh frequency component (HFC) was presented to the whole body via the loudspeaker systems 330 and 330 in the state in which the audible range component (LFC) was selectively presented only to the air conduction auditory system via the earphones 334 and 334, the development of the hypersonic effect was observed statistically significantly with either one of the applied two indexes. The earphones 334 and 334 used in the experiments have an insertion type casing structure of a thickness of about two to three millimeters by injection molding of a rigid plastic and almost completely prevent the superhigh frequency component (HFC) sent to the atmosphere via the loudspeaker systems 330 and 330 from entering the auditory meatuses penetrating the casings of the earphones 334 and 334. Therefore, it is impossible that the superhigh frequency component (HFC) reach the air conduction auditory system. Moreover, under the condition, the superhigh frequency component (HFC) and the audible range component (LFC) separately pass through the pneumatic circuits of the atmosphere and the auditory meatuses, respectively, which are mutually isolated. Therefore, a hypothesis that the superhigh frequency component (HFC) and the audible range component (LFC) are brought in mutual contact in the atmosphere or the auditory meatuses consequently leading to some physical interactions and a hypothesis that the audible range component (LFC) modified by it causes the hypersonic effect via the auditory nerve system are hard to hold.

On the other hand, in the experiments, the clear development of the hypersonic effect is recognized only when the superhigh frequency component (HFC) is presented not from the air conduction auditory system but to the human body surface including the head while the audible range component (LFC) is presented to the air conduction auditory system. This fact supports firstly the fact that the presentation of HFC to the air conduction auditory system is not always indispensable as the condition of the hypersonic effect development and secondly the fact that similarly presenting the superhigh frequency component (HFC) to the human body surface other than the air conduction system is at least effective for the development of the hypersonic effect.

In the experiments of the same setting, when the superhigh frequency component (HFC) sent off via the loudspeaker systems 330 and 330 is highly attenuated by placing a soundproofing material in a position immediately before the component reaches the body of the test human subject to disturb the arrival of the component at the body surface, the development of the hypersonic effect is remarkably suppressed. This fact leads to a hypothesis that it is indispensable to make HFC reach directly to the human body surface in order to develop the hypersonic effect. Furthermore, when the superhigh frequency component (HFC) reaches slightly to the human body surface though it is largely attenuated by the soundproofing material in the experiments, there is a tendency that both the a wave and the comfortable listening volume are slightly increased in a state corresponding to it, and it is also worth paying attention to the fact that the possibility of the quantity of HFC reaching the test human subject concerned in the intensity of the development of the hypersonic effect is suggested. This fact does not conflict with the past report of the present inventor and others (See, for example, Non-Patent Document 25) that the superhigh frequency component (HFC) is transformed depending on its quantity and the hypersonic effect is more intensely generated when the superhigh frequency component (HFC) is boosted.

Although the test human subjects were highly insulated from the superhigh frequency component (HFC) under the experimental conditions, but the insulation from the atmosphere is not so perfect. In particular, the intake of the surrounding atmosphere by aspiration is not disturbed at all. This fact is unignorable in the point that the effect of making it difficult to hold the hypothesis that the superhigh frequency component (HFC) takes actions on the chemical substances in the atmospheric to thereby induce a non-biological phenomenon of a change in the chemical composition of the atmospheric components and the development of the hypersonic effect as a reflection of the phenomenon.

If the knowledges are generalized, the unknown fact that the materials supporting the hypothesis that the hypersonic effect induced by an unsteady sound abundantly containing the superhigh frequency component (HFC) exceeding the upper limit of the audible range to a human being was developed singly by the participation of the already-known air conduction auditory system could not be obtained within the range of the experiments of the present implemental example and an explanation can be made by reserving the hypothesis was discovered. The various experimental facts discovered here cannot be explained by the hypothesis of the single participation of the air conduction auditory system, while the whole can be explained with almost no contradiction by supposing the existence of a certain reception and response system that is located on the body surface including the head or has a window. Therefore, it can be considered that staying in the frame to pursue the mechanism of the development of the hypersonic effect regarding limitedly to the single participation of the already-known air conduction auditory system not only has significant limitations but also accompany the risk of overlooking the essential matters.

Although it is out of the range of the experiments of the present implemental example to specifically fix what sort of mechanism not belonging to the already-known air conduction auditory system is concerned in the reception and transformation of the superhigh frequency component (HFC), it is possible to promote the future examinations while viewing the possibility of the participation of various biological systems. For the implemental example, the frequency response regions of the peripheral receptor Meissner corpuscle and Pacinian corpuscle of the somatosensory system that is the nerve system to carry mechanical vibration information presented to the human body surface are estimated to be 5 to 80 Hz and 80 to 600 Hz, respectively (See, for example, Non-Patent Document 4), there may be a possibility that the already-known receptors have an unknown reactivity to the superhigh frequency vibration exceeding the human audible range.

Moreover, it has recently been reported that a healthy individual and a patient who has lost his or her auditory sense due to the functional disorder of the inner ear can recognize the superhigh frequency components exceeding the audible range modulated by an audio signal by bone conduction as ultrasonic hearing (See, for example, Non-Patent Document 9). The possibility that such a bone-conducting auditory sense system exerts some influences on the development of the hypersonic effect cannot be denied.

More lately, it is being discovered that mechanoreceptor channels also exist in the general nonsensory cells other than the receptor of the sensorineural system and have cellular responsiveness to the external mechanical stimulations (See, for example, Non-Patent Document 2), and such a mechanical stimulation reception ability is attracting attention as a fundamental function to support the extensive vital phenomena. In particular, Sogabe et al. succeeded in identifying the mechanosensitive channel gene having generality in eukaryotic cells (See, for example, Non-Patent Document 8). Therefore, particular attentions should be paid to the possibilities that the superhigh frequency component (HFC) as an aerial vibration exerts influences on changes in the state of the somatic cells themselves (intracellular information propagation system, genetic control of gene expression, metabolic adjustment, enzyme reaction, membrane penetration, molecular diffusion, etc.) via the certain mechanosensitive channels, and the information exerts modificatory influences on the reception of the audible range sound by being transmitted to the brain via the nerve cells or chemical messenger systems including the internal secretion and immune systems and so on. This does not conflict also with the way of thinking that the influences of the superhigh frequency vibration exerted on the living body presently widely applied in the medical field are on the background of the mechanisms other than the neurological function, the effect of hyperthermia caused by slight mutations of the particles that constitute the living body, formation of cavitation and microstreaming and various physical and chemical reactions accompanying them (See, for example, Non-Patent Document 1).

In conclusion, the experimental results suggest that the development of the hypersonic effect is observed only when a certain unknown information channel other than the air conduction auditory system is activated. Moreover, the possibility that one or more demand mechanisms that have not yet been identified are participating should not be ignored. These results do not conflict with the two-dimensional perceptual model that the superhigh frequency vibration component exceeding the audible range modificatorily acts by activating the deep brain region via a certain non-auditory system channel when the component is presented simultaneously with the audible range vibration component and induces the hypersonic effect, which has been proposed by the present inventor and others, and support the model.

### Implemental Example 2

In the implemental example 2, comparison results by experiments with the PET measurement apparatus of FIG. 1 according to the first preferred embodiment and the prior art PET measurement apparatus of FIG. 3 are described below.

In the implemental example 2, the PET measurement apparatus of FIG. 1 according to the first preferred embodiment and serves as a water-cooled PET measurement apparatus according to the second preferred embodiment was used. In order to reduce the noise vibration propagating from the PET measurement apparatus to the test human subject, the entire surface of the main unit of the measurement apparatus was covered with a vibration insulating material 10a made of a commercially available foamed polyurethane resin plate, and after the upper surface of the bed 11, or the test human subject supporting apparatus was covered with a vibration insulating member 11a similarly made of the foamed polyurethane resin plate, a mattress of an appurtenance of the PET measurement apparatus was laid on it. The loudspeakers S1 and S2 for presenting an audible range sound and a sound of a superhigh frequency component (HFC) exceeding the audible range according to the experimental purpose were placed in positions corresponding to the neighborhoods of the feet of the test human subject in the vicinity of the bed 11. The test human subject position was adjusted so that the depth of the head of the test human subject entering the cavity at the center of the measurement apparatus became minimized as far as possible within a range in which the measurement could be performed to make the sound waves presented via the loudspeakers S1 and S2 directly reach a wide range of the body inclusive of the head and face of the test human subject and to reduce the constraint feeling by securing a wide field of vision of the test human subject.

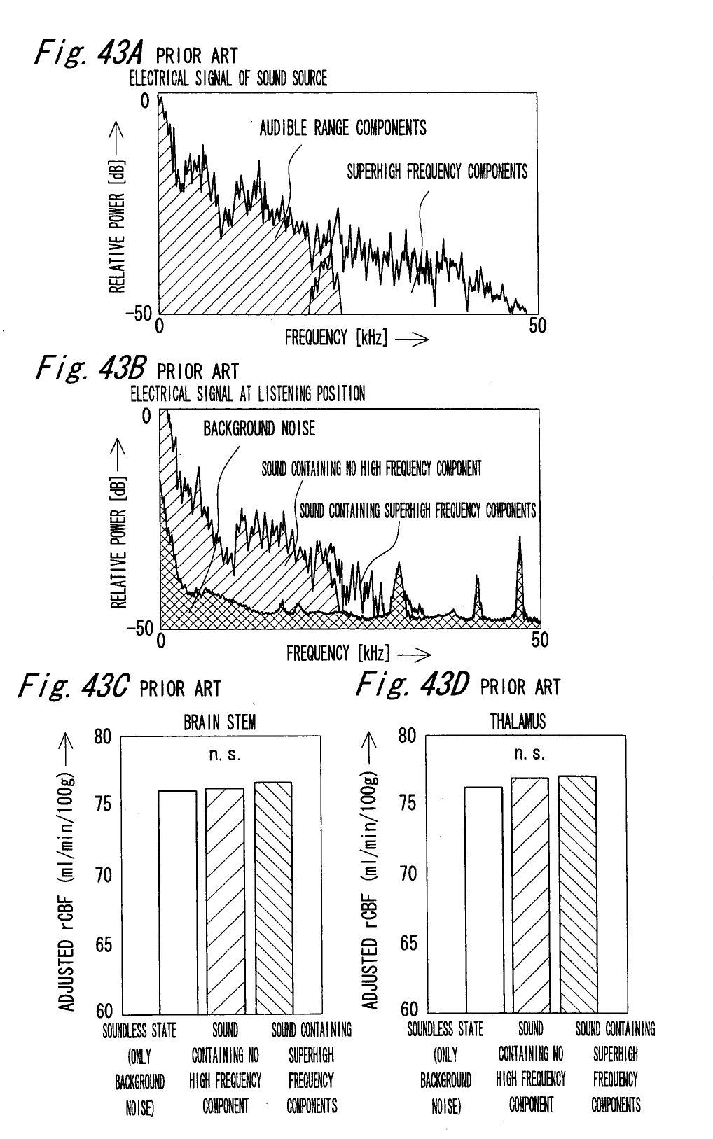

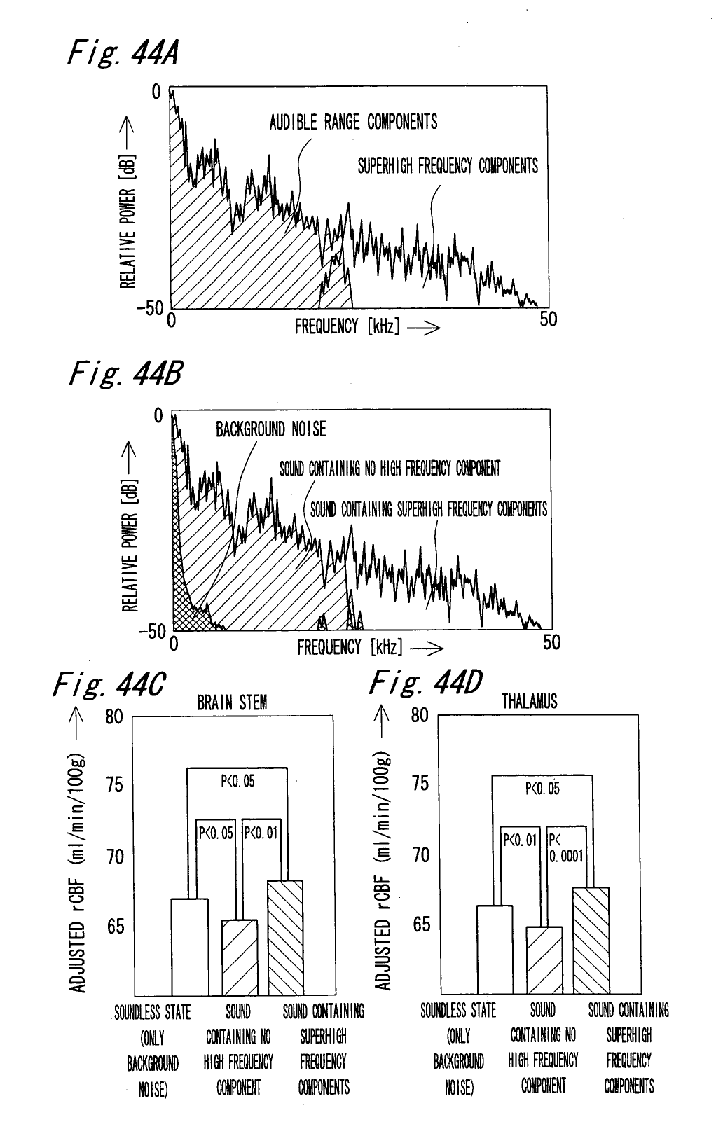

FIGS. 43A to 43D show experimental results of the PET measurement apparatus according to the prior art example. FIG. 43A is a spectrum chart of the electrical signal of the sound source used for the experiments. FIG. 43B is a spectrum chart of the electrical signal in the listening position of the experiments. FIG. 43C is a graph showing an adjusted rCBF with respect to various sounds in the brain stem of the test human subject. FIG. 43D is a graph showing an adjusted rCBF with respect to various sounds in the thalamus of the test human subject. FIGS. 44A to 44D show experiments by the experimental results of the PET measurement apparatus of FIG. 1 according to the first preferred embodiment. FIG. 44A is a spectrum chart of the electrical signal of the sound source used for the experiments. FIG. 44B is a spectrum chart of the electrical signal in the listening position of the experiments. FIG. 44C is a graph showing an adjusted rCBF with respect to various sounds in the brain stem of the test human subject. FIG. 44D is a graph showing an adjusted rCBF with respect to various sounds in the thalamus of the test human subject.

The power spectrum and the cerebral blood flow of a sound in each test human subject listening position were measured and analyzed in such a case that a sound containing a superhigh frequency component (HFC) was presented to a test human subject 12, such a case that a sound containing no superhigh frequency component (HFC) was presented and a case of only the background noise without any sound presentation, by using the PET measurement apparatus 10A (prototype) according to the first preferred embodiment of FIG. 1 intended for examining the brain region related to the hypersonic effect as one implemental example of sensibility measurement. As a result, in the prototype PET measurement apparatus 10A according to the first preferred embodiment, as shown in FIG. 44B, the level of the background noise was lower than that of the prior art example of FIG. 3, and the band component was limited to the low frequency or the audible range. Therefore, the degree of contamination of the superhigh frequency component (HFC) region of the presentation sound reproduced from the electrical signal was low, and the distinction of the spectrum structure depending on a difference between the presence and absence of the superhigh frequency component (HFC) was definitely maintained in the actual measurement data of the power spectrum of the sound to which the test human subject listened. According to the cerebral blood flow data corresponding to it, as shown in FIGS. 44C and 44D, a significant difference was found in the amount of bloodstream on every condition in the regions belonging to the thalamus and the brain stem in the brain core.

When similar measurements are performed by using the PET measurement apparatus 10 according to the prior art example of FIG. 3, the sound reproduced from the electrical signal is contaminated by a noise vibration including the superhigh frequency component (HFC) generated from the measurement apparatus as shown in FIG. 43B. The contamination due to the superhigh frequency vibration attributed to the apparatus is remarkable in either of the condition in which the sound containing the superhigh frequency component (HFC) is presented and the condition in which the sound containing no superhigh frequency component (HFC) is presented is significant, and the structures of the power spectrums are extremely closer to each other between the conditions, and the difference is minute. As shown in FIGS. 43C and 43D, the bloodstream at the brain core is increased almost uniformly in each condition by reflecting it, indicating that the neural activities in the regions have been consistently activated regardless of the conditions, and it is impossible to find a significant difference in every condition in a manner similar to that of such a case that the measurement is performed by using the prototype PET measurement apparatus 10A according to the first preferred embodiment. As described above, it was indicated that the inventive type effectively functioned in measuring the brain functions related to the phenomena that tend to receive the influences of noises and vibrations generated from the measurement apparatus.

### Fourteenth Preferred Embodiment

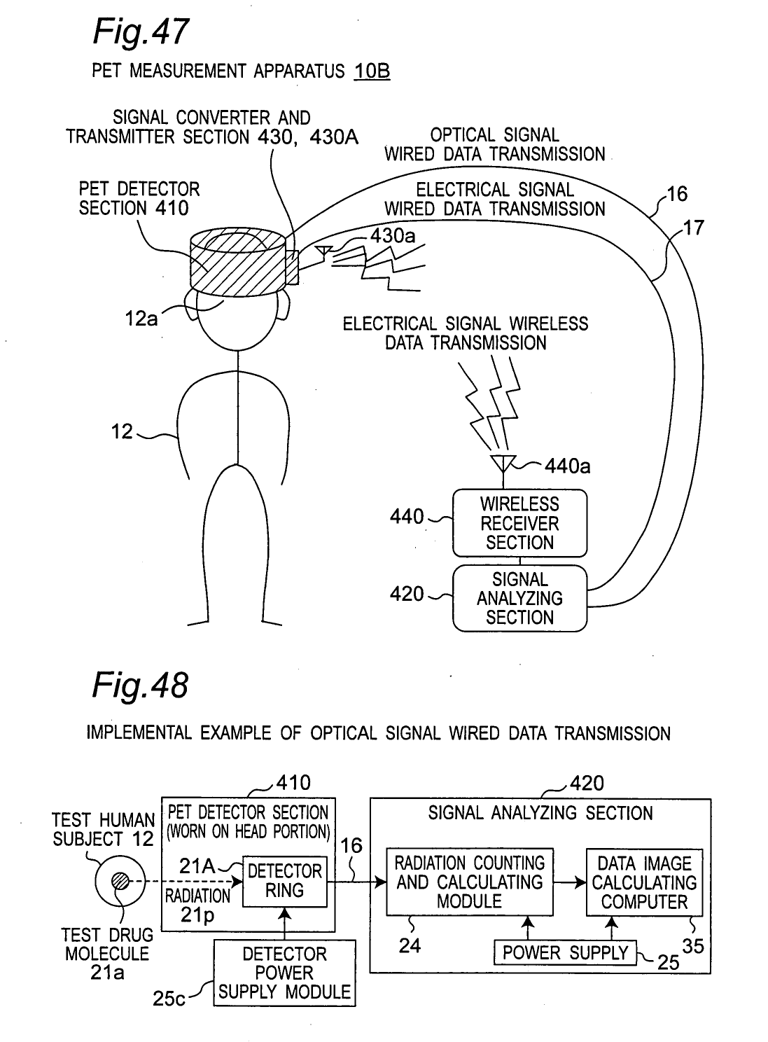

FIG. 47 is a block diagram showing a configuration of a PET measurement apparatus 10B according to the fourteenth preferred embodiment of the present invention. In the PET measurement apparatus 10B of FIG. 47, a PET detector section 410 that is a detection sensor section and a signal converter and transmitter section 430 or 430A are integrally formed and worn and fixed on the head 12a of a test human subject 12. It is acceptable to support the section only by the head 12a of the test human subject 12 or support the section by a movable arm attached to a wall or the like so that the weight does not become a load on the test human subject 12. Information of radiation detected by the PET detector section 410 is outputted intact as an optical signal or photoelectrically converted into an electrical signal, and the signal is transmitted to a radiation counting and calculating module 24 in a signal analyzing section 420 placed remotely by a cable or wirelessly. In this case, an optical fiber cable 16 is used in the case of optical signal wired data transmission or transmitted by a wired signal cable 17 in the case of electrical signal wired data transmission or transmitted by an antenna 430a of the signal converter and transmitter section 430 or 430A and an antenna 440a of a wireless receiver section 440 in the case of electrical signal wireless data transmission.

FIG. 48 is a block diagram showing an implemental example in the case of the optical signal wired transmission in the PET measurement apparatus 10B of FIG. 47. Referring to FIG. 48, a radiation 21p radiated from a test drug molecule 21a in the test human subject 12 is detected by a detector ring 21A in the PET detector section 410 worn on the head 12a, and information of the detected radiation is transmitted to the radiation counting and calculating module 24 of the signal analyzing section 420 via the optical fiber cable 16. The radiation counting and calculating module 24 counts and calculates the inputted information, and then, a data image calculating computer 35 executes the prescribed image processing described above. It is noted that the detector ring 21A is supplied with a power from a prescribed detector power supply module 25c.

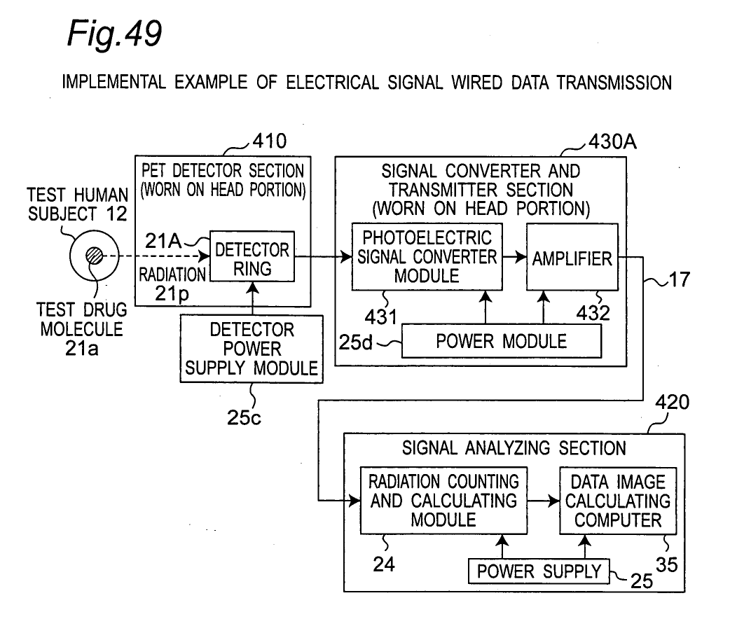

FIG. 49 is a block diagram showing an implemental example in the case of the electrical signal wired transmission in the PET measurement apparatus 10B of FIG. 47. Referring to FIG. 49, the radiation 21p radiated from the test drug molecule 21a in the test human subject 12 is detected by the detector ring 21A of the PET detector section 410 worn on the head 12a. The information of the detected radiation is inputted to a photoelectric signal converter module 431 in the signal converter and transmitter section 430A worn on the head 12a, and then, it is photoelectrically converted into an electrical signal. The electrical signal is amplified by an amplifier 432, and then, it is transmitted to the radiation counting and calculating module 24 of the signal analyzing section 420 via the wired signal cable 17. The radiation counting and calculating module 24 counts and calculates the inputted information, and then, the data image calculating computer 35 executes the prescribed image processing described above. It is noted that the photoelectric signal converter module 431 and the amplifier 432 are supplied with a power from a power supply module 25d.

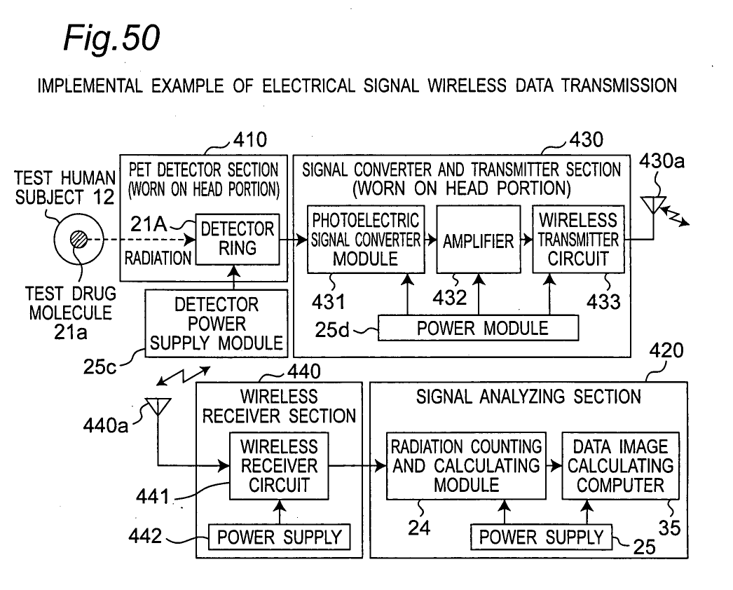

FIG. 50 is a block diagram showing an implemental example in the case of the electrical signal wireless transmission in the PET measurement apparatus 10B of FIG. 47. Referring to FIG. 50, the radiation 21p radiated from the test drug molecule 21a in the test human subject 12 is detected by the detector ring 21A in the PET detector section 410 worn on the head 12a. The information of the detected radiation is inputted to the photoelectric signal converter module 431 of the signal converter and transmitter 430 worn on the head 12a, and then, it is photoelectrically converted into an electrical signal. The electrical signal is amplified by the amplifier 432, and then, it is modulated into a radio signal by the wireless transmitter circuit 433. The radio signal is radiated from the antenna 430a toward the antenna 440a of the wireless receiver section 440. It is noted that the photoelectric signal converter module 431, the amplifier 432 and the wireless transmitter circuit 433 are supplied with powers from the power supply module 25d. The radio signal received by the antenna 440a of the wireless receiver section 440 is demodulated into an electrical signal by a wireless reception circuit 441, and then, it is transmitted to the radiation counting and calculating module 24 in the signal analyzing section 420. The radiation counting and calculating module 24 counts and calculates the inputted information, and then, the data image calculating computer 35 executes the prescribed image processing described above. It is noted that the wireless receiver circuit 441 is supplied with a power from a power supply 442.

In the conventional PET measurement apparatus, the test human subject 12 lies on the bed and puts his or her body in the cylindrical cavity in which the detection sensor of the PET measurement apparatus is placed. At this time, the apparatus and the body of the test human subject 12 are mutually separated and independent, and therefore, the measurement cannot be performed if the test human subject 12 moves. Moreover, an error is sometimes produced in the measurement by the slight movement of the head 12a. According to the present invention, by integrating the apparatus with the test human subject 12 by mounting and fixing only the PET detector section 410 and the signal converter and transmitter 430 or 430A in a helmet shape to the head 12a of the test human subject 12, the measurement is not disturbed even if the test human subject 12 moves, making it possible to largely reduce the constraint in the movement of the test human subject. In particular, by transmitting the detection signal wirelessly or by a sufficiently thin cable, measurement of the brain activities becomes possible in a constraint state. In addition, it becomes possible to prevent an error from occurring in the measurement due to the slight movement of the head 12a and to largely improve the measuring accuracy.

In the conventional PET measurement apparatus of FIG. 4, the PET measurement apparatus is provided with the appurtenances of the radiation counting and calculating module 24, the calculating module power supply 25, the apparatus main unit power supply controlling module 22 and so on besides the detector ring. In order to cool heat generated from these modules, the outside air is introduced by the cooling air supply fans 41, and then, the air is discharged as warm exhaust to the outside. Therefore, ultra-wideband vibration noises are generated particularly by mechanisms including these cooling systems. In the present invention, by placing the radiation counting and calculating section in a remote place sufficiently separated from the test human subject, the vibration noises generated by the radiation counting and calculating apparatus are prevented from reaching the body of the test human subject. This makes it possible to largely improve the measurement accuracy of the relation between the state in which the vibration that is the original object to be measured and the brain activity.

Since the area of the body of the test human subject 12 covered with the PET detector section 410 and the signal converter and transmitter 430 or 430A is limited to a narrow range of the head 12a, the exposure area of the body of the test human subject 12 is increased, and the range in which the vibration is applied is expanded.

In the conventional PET measurement apparatus, the test human subject 12 has been constrained on the bed, and a great mental stress is generated in the test human subject 12. Therefore, this has been an obstruction to make it extremely difficult to measure the brain activities related to the human positive mental state such as comfortability sensation and an aesthetic sense. However, adopting a non-constraint type makes it possible to largely reduce the mental stress and to accurately measure the brain activities related to the positive mental state. It becomes possible to wear a detection sensor of the scalp surface potential (brain wave) on a helmet-shaped cap integrated with the PET detector section 410 of the PET measurement apparatus. This makes it possible to perform simultaneous measurements of PET and brain waves in such a state that the test human subject can move in a non-constraint manner.

Moreover, it becomes possible to mount the vibration presenting system inside the ring of the detection sensor section of PET measurement and to present a presentation vibration to the head. This makes it possible to apply a vibration also to the unexposed head during the PET measurement, and the regions in which the vibration transmission is disturbed by the PET measurement become almost eliminated.

### Fifteenth Preferred Embodiment

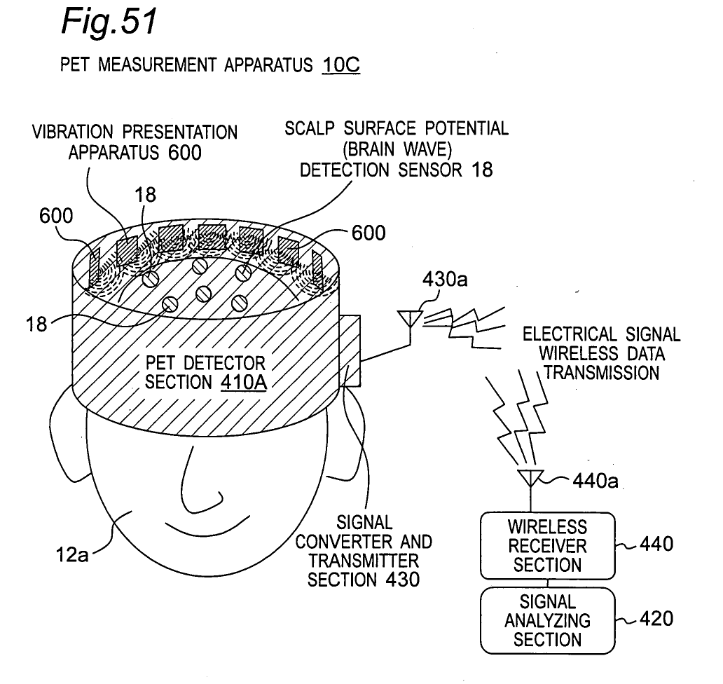

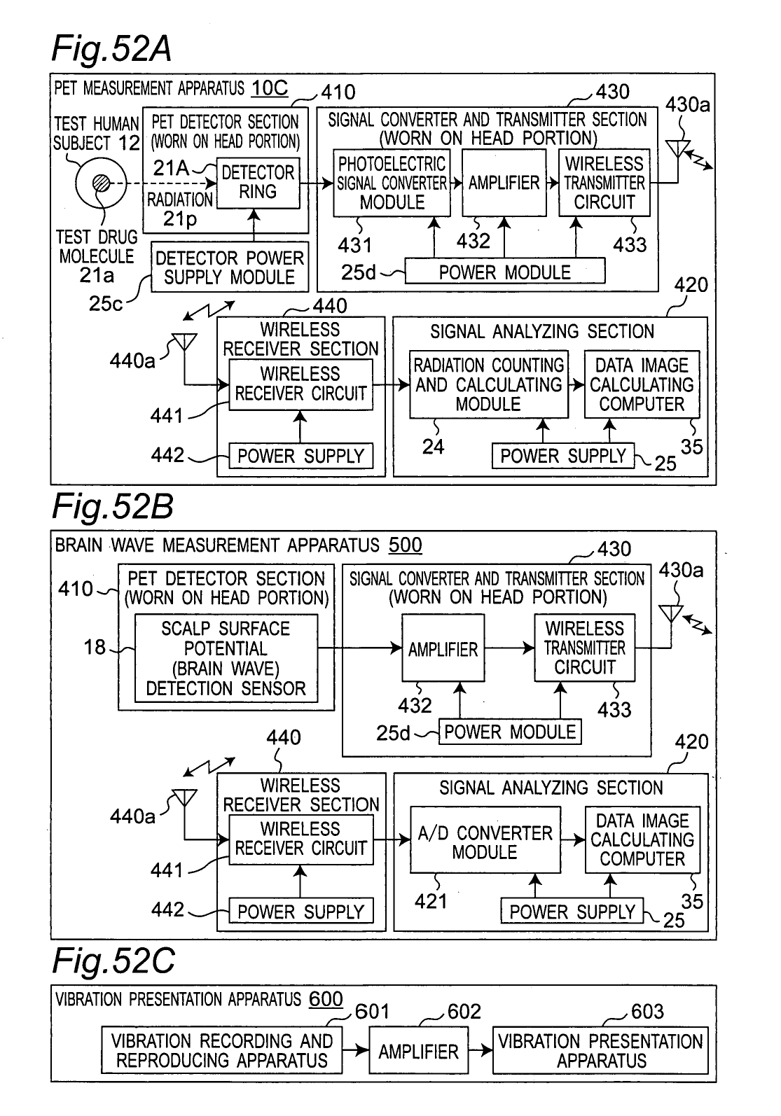

FIG. 51 is a block diagram showing a configuration of a PET measurement apparatus 10C according to the fifteenth preferred embodiment of the present invention. FIG. 52A is a block diagram showing a detailed configuration of the PET measurement apparatus 10C of FIG. 51. FIG. 52B is a block diagram showing a detailed configuration of a brain wave measurement apparatus 500 of FIG. 51. FIG. 52C is a block diagram showing a detailed configuration of a vibration presenting system 600 of FIG. 51. The PET detector section 410A according to the fifteenth preferred embodiment is characterized by further including a plurality of vibration presenting systems 600 that present a superhigh frequency vibration or a high frequency supra-perceptive vibration (meaning a vibration containing a superhigh frequency component that exceeds the audible range of, for example, 20 kHz and ranges up to about 500 kHz and has the so-called hypersonic effect) and a plurality of scalp surface potential (brain wave) detection sensors 18 in positions located in the vicinity of an upper portion of the head 12a.

Referring to FIG. 51, the scalp surface potential (brain wave) detection sensors 18 were worn on a helmet-shaped cap or the like integrated with the PET detector section 410A of PET measurement. With this arrangement, simultaneous measurement of PET and the brain waves can be performed in such a state that the test human subject 12 can move in a non-constraint manner. Moreover, a plurality of vibration presenting systems 600 are worn on the inside of the ring of the PET detector section 410A of PET measurement or in other places, and a superhigh frequency vibration or a high frequency supra-perceptive vibration for presentation can be presented to the head 12a. This makes it possible to apply the vibration also to the unexposed head 12a during the PET measurement, and the regions in which the vibration transmission is disturbed by the PET measurement become almost eliminated.

Referring to FIG. 52A, a PET measurement apparatus 10C of a similar configuration is shown. In the brain wave measurement apparatus 500 of FIG. 52B, the PET detector section 410 includes the scalp surface potential (brain wave) detection sensors 18, and the information detected by the detection sensors 18 is inputted to a wireless transmitter circuit 433 via an amplifier 432 of a frequency converter section 430 in a manner similar to that of the case of the PET detection information and transmitted to a wireless receiver section 440 and a signal analyzing section 420. The vibration presenting system 600 of FIG. 52C is constituted by including a vibration recording and reproducing apparatus 601 that records and reproduces a superhigh frequency vibration or a high frequency supra-perceptive vibration, an amplifier 602 that amplifies the reproduced vibration and a vibration presenting system 603 that outputs and presents the amplified vibration.

### Sixteenth Preferred Embodiment

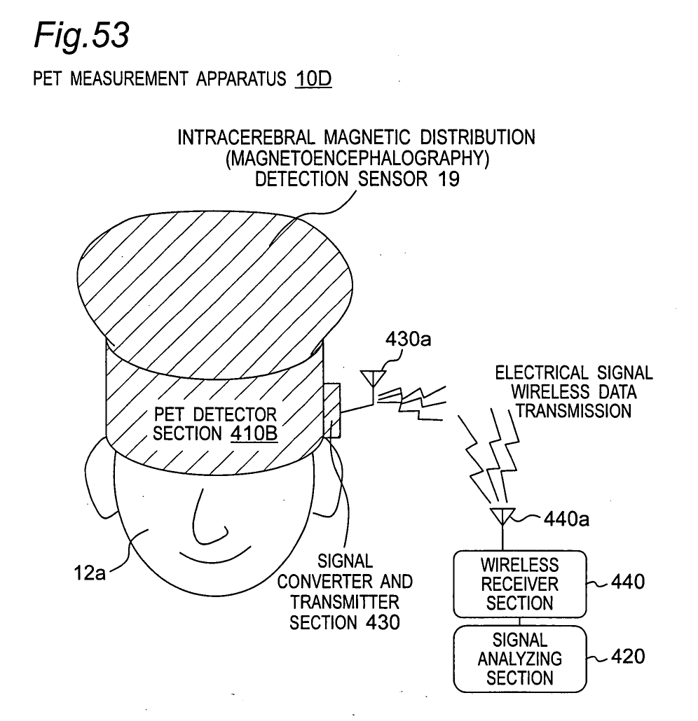

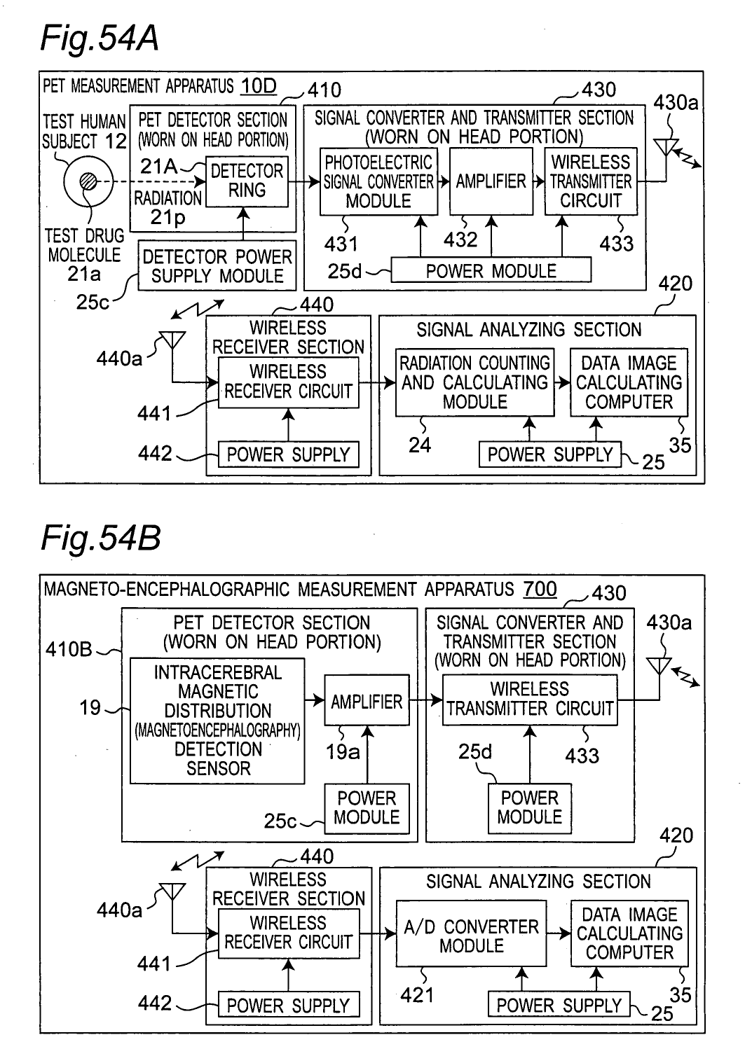

FIG. 53 is a block diagram showing a configuration of a PET measurement apparatus 10D according to the sixteenth preferred embodiment of the present invention. FIG. 54A is a block diagram showing a detailed configuration of the PET measurement apparatus 10D of FIG. 53. FIG. 54B is a block diagram showing a detailed configuration of a magneto-encephalographic measurement apparatus 700 of FIG. 53. The PET measurement apparatus 10D of FIG. 53 and FIGS. 54A to 54B is characterized in that an intracerebral magnetic distribution (magneto-encephalography) detection sensor 19 is provided in place of the scalp surface potential (brain wave) detection sensors 18 of the PET measurement apparatus 10C of FIG. 51. The magneto-encephalographic measurement apparatus 700 of FIG. 54B is similar to the fifteenth preferred embodiment except for the provision of the intracerebral magnetic distribution (magneto-encephalography) detection sensor 19 and an amplifier 19a in the PET detector section 410B.

As described above, by concurrently wearing the intracerebral magnetic distribution detection sensor 19 on a helmet-shaped cap or the like integrated with the PET detector section 410B of PET measurement, simultaneous measurement of PET and the magneto-encephalography can be performed in the state in which the test human subject 12 can move in a non-constraint manner.

### Seventeenth Preferred Embodiment

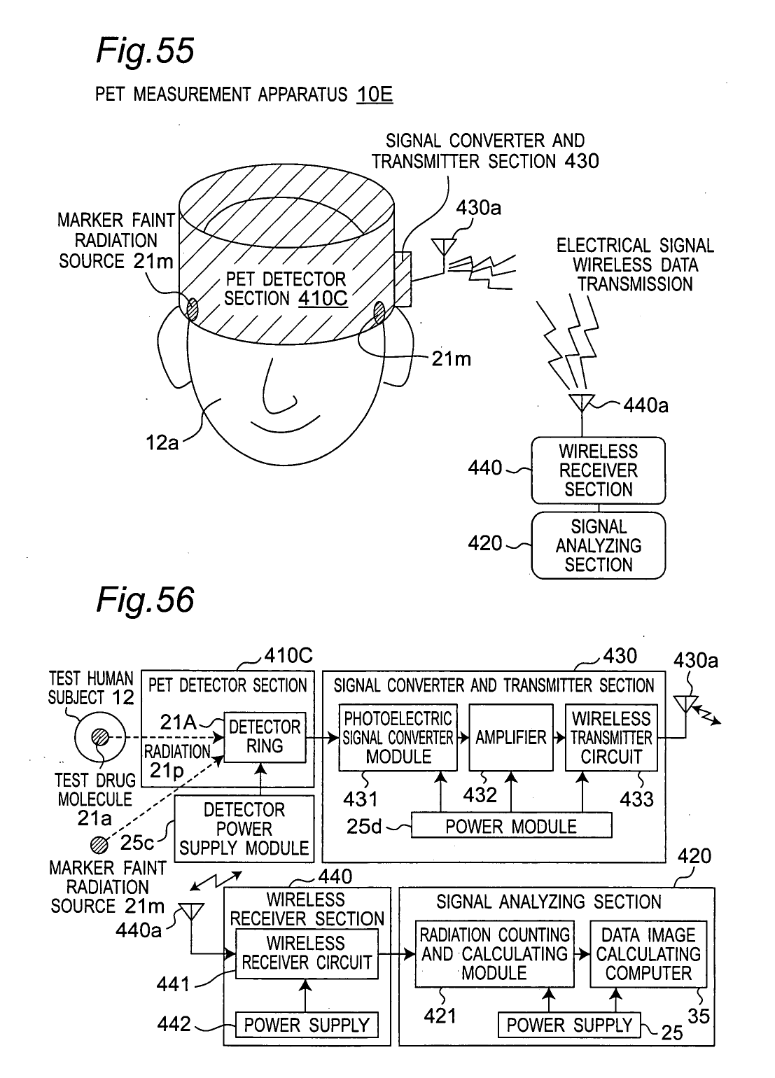

FIG. 55 is a block diagram showing a configuration of a PET measurement apparatus 10E according to the seventeenth preferred embodiment of the present invention. FIG. 56 is a block diagram showing a detailed configuration of the PET measurement apparatus 10E of FIG. 55. Referring to FIG. 55, a PET detector section 410C of the PET measurement apparatus 10E is characterized by including marker faint radiation sources 21m in a plurality of prescribed positions of a head wrap section. Referring to FIG. 56, radiations from the marker faint radiation sources 21m are detected together with a radiation from the test drug molecule 21a by the detector ring 21A and outputted to a photoelectric signal converter module 431.

Therefore, by wearing the faint radiation sources 21m on the head 12a of the test human subject 12 during PET measurement, it becomes possible to associate an anatomical image with an image imaged by the PET measurement apparatus 10E. In the conventional PET apparatus, the anatomical image and the image imaged by the PET measurement apparatus have often been associated with each other by simultaneously performing CT imaging. The present invention needs to make the portion worn on the head 12a compact and lightweight, and it is impossible to perform the CT imaging since only the PET detector section 410C and the signal converter and transmitter 430 are worn on the head 12a of the test human subject 12. Accordingly, by wearing the marker faint radiation sources 12m of 68 Ge/68 Ga or the like on the head 12a of the test human subject 12, the positional association with the anatomical image can be achieved.

### Eighteenth Preferred Embodiment

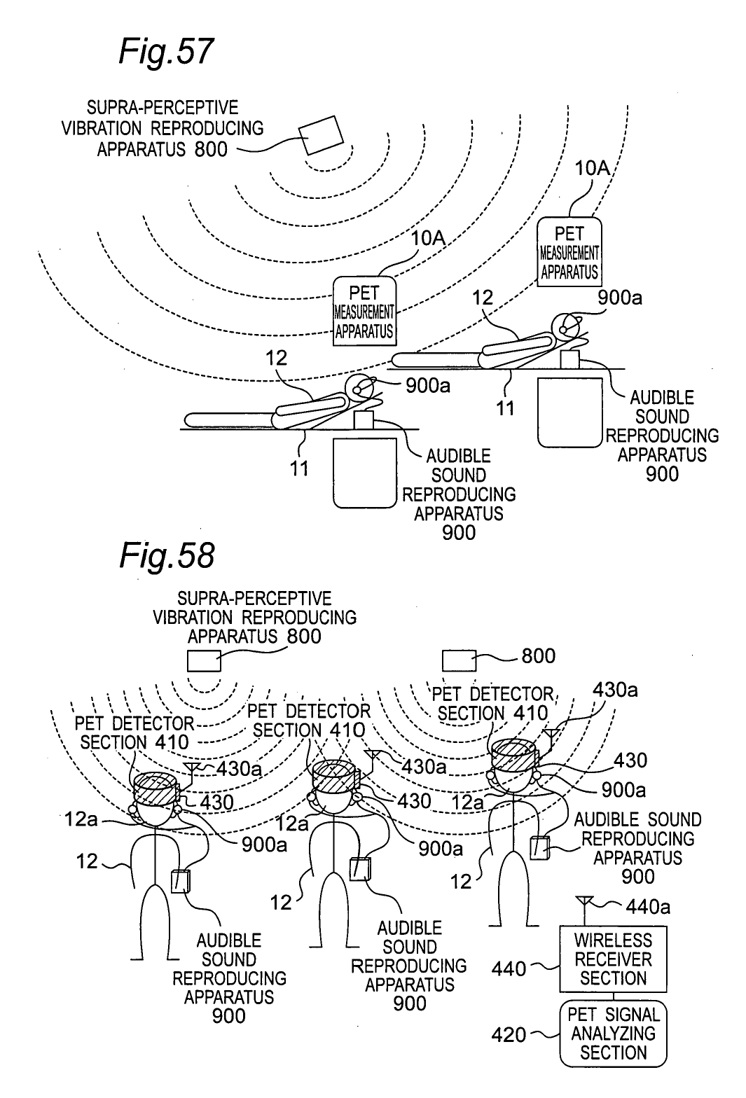

FIG. 57 is a block diagram showing such a configuration that a plurality of test human subjects 12 are subjected to PET measurement by a PET measurement apparatus 10A by using a high frequency supra-perceptive vibration reproducing apparatus 800 according to the eighteenth preferred embodiment of the present invention. That is, FIG. 57 shows an implemental example of PET measurement intended for a plurality of test human subjects 12 in a public space. A high frequency supra-perceptive vibration is reproduced from the high frequency supra-perceptive vibration reproducing apparatus 800 or the like installed in a public space and applied to the human body surfaces of the test human subjects 12. At this time, the reproduced high frequency supra-perceptive vibration becomes common to all the test human subjects 12. Moreover, by reproducing an audible sound by an audible sound reproducing apparatus 900 such as a portable music player, each test human subject listens to the sound by, for example, a headphone 900a. At this time, the test human subjects 12 may listen to mutually different favorite music and the like. This makes it possible to experimentally verify the combinational effects of the common high frequency supra-perceptive vibration and the individual audible sounds.

### Nineteenth Preferred Embodiment

FIG. 58 is a block diagram showing such a configuration that a plurality of test human subjects 12 are subjected to PET measurement by a PET detector section 410 by using a high frequency supra-perceptive vibration reproducing apparatus 800 according to the nineteenth preferred embodiment of the present invention. That is, FIG. 58 also shows an implemental example of PET measurement intended for a plurality of test human subjects 12 in a public space. A high frequency supra-perceptive vibration is reproduced from the high frequency supra-perceptive vibration reproducing apparatus 800 or the like installed in a public space and applied to the human body surfaces of the test human subjects 12. At this time, the reproduced high frequency supra-perceptive vibration becomes common to all the test human subjects 12. Moreover, by reproducing an audible sound by an audible sound reproducing apparatus 900 such as a portable music player, each test human subject listens to the sound by, for example, a headphone 900a. At this time, the test human subjects 12 may listen to mutually different favorite music and the like. This makes it possible to experimentally verify the combinational effects of the common high frequency supra-perceptive vibration and the individual audible sounds. In the implemental example of FIG. 58, the test human subjects 12 can freely move since the PET detector section 410 is used.

### Twentieth Preferred Embodiment

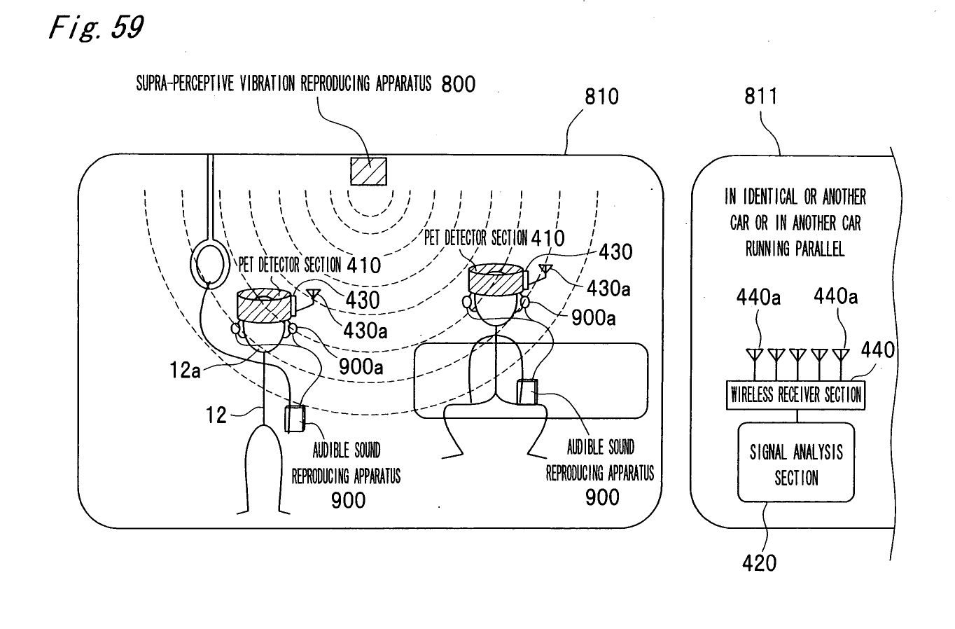

FIG. 59 is a block diagram showing such a configuration that a plurality of test human subjects 12 are subjected to PET measurement in a train car by using a high frequency supra-perceptive vibration reproducing apparatus 800 according to the twentieth preferred embodiment of the present invention. FIG. 59 shows an implemental example of PET measurement intended for a plurality of persons in the train car. Referring to FIG. 59, a high frequency supra-perceptive vibration is reproduced from the high frequency supra-perceptive vibration reproducing apparatus 800 or the like installed in the train car and applied to the human body surfaces of the plurality of test human subjects 12 in the train car. At this time, the reproduced high frequency supra-perceptive vibration becomes common to all the test human subjects 12. At this time, the test human subjects 12 may listen to mutually different favorite music and the like by using audible sound reproducing apparatuses 900 such as portable music players. At this time, the signal analyzing section 420 of the PET measurement apparatus is installed in an identical or another train car or in another train car that is running parallel. This makes it possible to experimentally verify the combinational effects of the common high frequency supra-perceptive vibration and the individual audible sounds.

### Twenty-First Preferred Embodiment

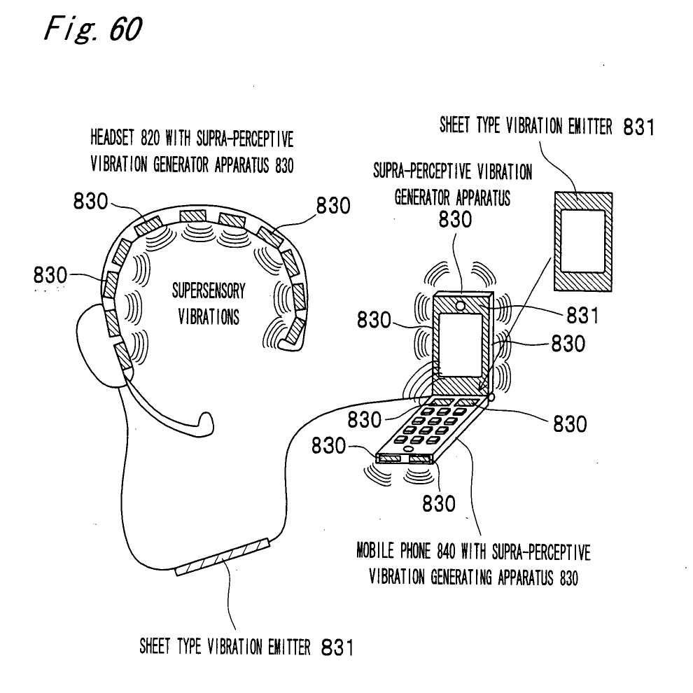

FIG. 60 is an appearance diagram showing a configuration of a headset 820 with a high frequency supra-perceptive vibration generator apparatus 830, a sheet type vibration emitter 831 and a mobile phone 840 with a high frequency supra-perceptive vibration generator apparatus 830 according to the twenty-first preferred embodiment of the present invention. FIG. 60 shows a general view of the headset 820 and the mobile phone 840 provided with the high frequency supra-perceptive vibration generator apparatus 830 and the sheet type vibration emitter (wound around a headphone code or stuck on the surface of the mobile phone 840) 831. A high frequency supra-perceptive vibration signal stored in a memory in the high frequency supra-perceptive vibration reproducing apparatus 830 is reproduced as a high frequency supra-perceptive vibration into the air through a microamplifier and a vibration emitter, and the high frequency supra-perceptive vibration can be applied to the human body surface of the user of the mobile phone or a person located in the neighborhood of the user. At this time, the vibration emitter or the sheet type vibration emitter 831 that reproduces the high frequency supra-perceptive vibration may be built in the mobile phone 840 or built in the headset 820 attached to it. Moreover, a high frequency supra-perceptive vibration signal may be generated by processing or interpolating an audible sound signal, wirelessly transmitted from the outside or distributed by communications besides being stored in the memory. At this time, the user of the portable communication apparatus and others are able to evade from negative influences due to listening only to the audible range sound even when listening to a music, a broadcasting sound, voices or the like within the audible range and to concurrently enjoy the hypersonic effect by virtue of the coexistence of the music, broadcasting sound, voices or the like within the audible range with the high frequency supra-perceptive vibration.

### Twenty-Second Preferred Embodiment

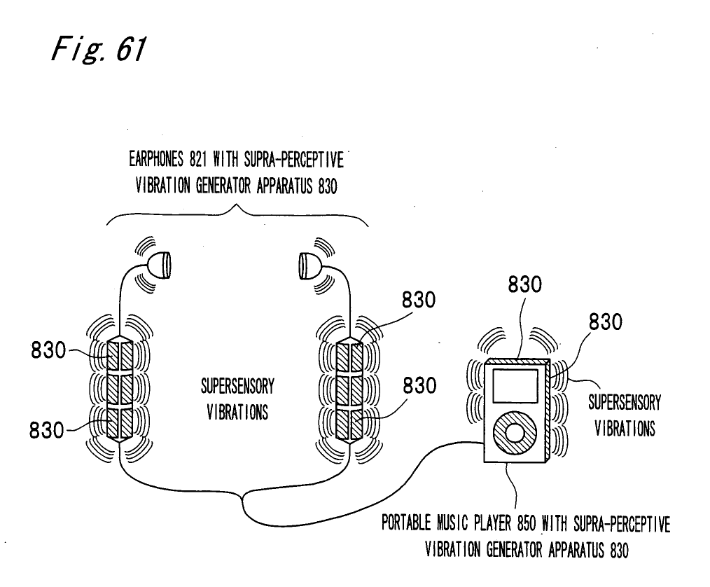

FIG. 61 is an appearance diagram showing a configuration of an earphone 821 with a high frequency supra-perceptive vibration generator apparatus 830 and a portable music player 850 with a high frequency supra-perceptive vibration generator apparatus 830 according to the twenty-second preferred embodiment of the present invention. FIG. 61 shows a general view of the portable music player 850 or a portable information terminal apparatus, which is provided with the high frequency supra-perceptive vibration generator apparatus 830. A high frequency supra-perceptive vibration signal stored in a memory in the high frequency supra-perceptive vibration reproducing apparatus 830 is reproduced as a high frequency supra-perceptive vibration into the air through a microamplifier and a vibration emitter by the high frequency supra-perceptive vibration reproducing apparatus 830, making it possible to apply the high frequency supra-perceptive vibration to the whole body of the user of the portable music players 850 or the like or persons located in the surroundings. At this time, the vibration emitter that reproduces the high frequency supra-perceptive vibration may be built in the portable music player 850 or the like or built in an outer wall of the earphone attached to it or a cable portion on the way. Moreover, the high frequency supra-perceptive vibration signal may be generated by processing or interpolating an audible sound signal, wirelessly transmitted from the outside or distributed by communications besides being stored in the memory. At this time, the users of the portable music player 850 or the like and others are able to evade from negative influences due to listening only to the audible range sound even when listening to a music, a broadcasting sound, voices or the like within the audible range and to concurrently enjoy the hypersonic effect by virtue of the coexistence of the music, broadcasting sound, voices or the like within the audible range with the high frequency supra-perceptive vibration.

### Twenty-Third Preferred Embodiment

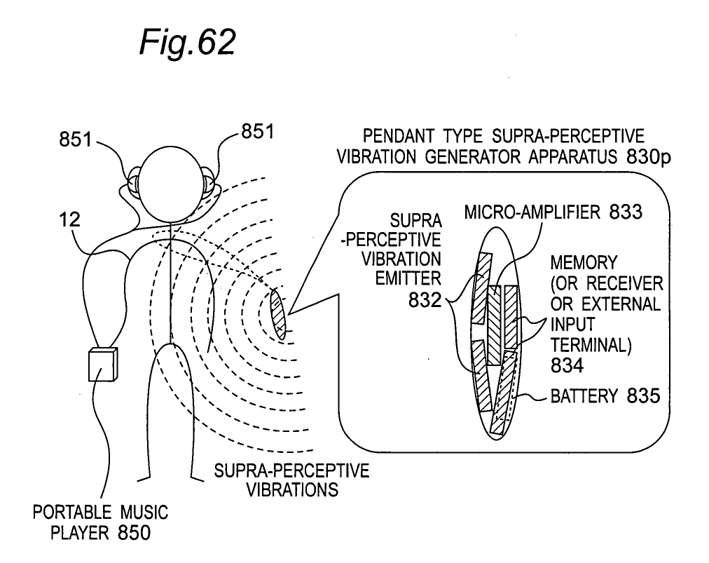

FIG. 62 is an appearance diagram showing a configuration of a pendant type high frequency supra-perceptive vibration generator apparatus 830p according to the twenty-third preferred embodiment of the present invention. FIG. 62 shows a use example of the high frequency supra-perceptive vibration generator apparatus 830p utilizing an accessory such as a pendant. A high frequency supra-perceptive vibration signal inputted from a memory (or a receiver or an external input terminal) 834 in the high frequency supra-perceptive vibration reproducing apparatus 830p is reproduced as a high frequency supra-perceptive vibration through a microamplifier 833 and a supra-perspective vibration emitter 832 by the high frequency supra-perceptive vibration reproducing apparatus 830p, making it possible to apply the high frequency supra-perceptive vibration to the human body surface of the person who wears the accessory. At this time, the person who wears the accessory is able to evade from negative influences due to listening only to the audible range sound even when listening to a music, a broadcasting sound, voices or the like in the audible range and to concurrently enjoy the hypersonic effect by virtue of the coexistence of the music, a broadcasting sound, voices or the like within the audible range with the high frequency supra-perceptive vibration.

### Twenty-Fourth Preferred Embodiment

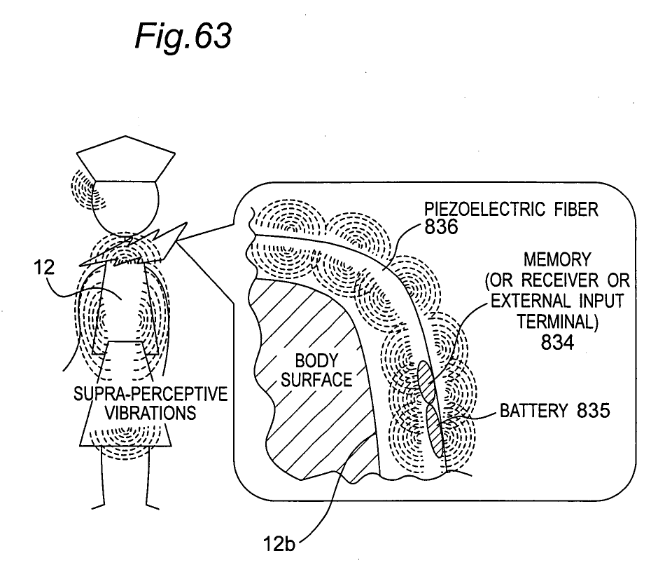

FIG. 63 is an appearance diagram showing a configuration of a high frequency supra-perceptive vibration generator apparatus using a piezoelectric fiber 836 according to the twenty-fourth preferred embodiment of the present invention. FIG. 63 shows one example of the high frequency supra-perceptive vibration generator apparatus in which the piezoelectric fiber 836 having a piezoelectric effect is woven as a vibration emitter into an accessory of a fiber material such as clothing or a scarf. A high frequency supra-perceptive vibration signal, which is stored in a memory 834 or received wirelessly or by a cable or externally inputted, is reproduced as a high frequency supra-perceptive vibration into the air through a microamplifier and a vibration emitter driven by a battery 835, making it possible to apply the high frequency supra-perceptive vibration to the whole body of the person who wears the clothing or the accessory or persons located in the supporting. It is noted that the memory 834 and the battery 835 are formed woven into the piezoelectric fiber 836. At this time, the wearer of the clothing or the accessory and others are able to evade from negative influences due to his ore her listening to a music, a broadcasting sound, voices or the like falling within the audible range by using a portable digital player or the like and to concurrently enjoy the hypersonic effect by virtue of interactions of the music, a broadcasting sound, voices or the like within the audible range with the high frequency supra-perceptive vibration.

### Twenty-Fifth Preferred Embodiment

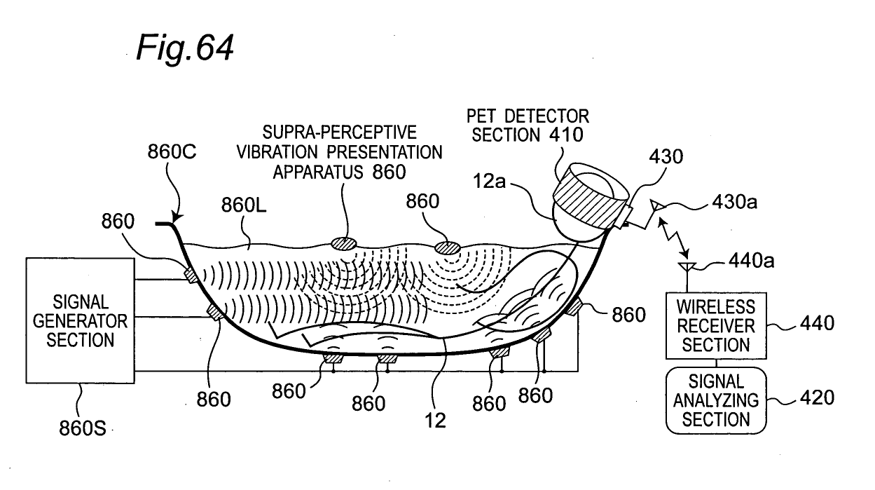

FIG. 64 is a block diagram showing a configuration of a high frequency supra-perceptive vibration presenting system 860 for a test human subject 12 in a bathtub 860C according to the twenty-fifth preferred embodiment of the present invention. FIG. 64 shows electronic equipment used when measurement is performed by using a PET measurement apparatus provided with a PET detector section 410, or an apparatus for applying a high frequency supra-perceptive vibration from the high frequency supra-perceptive vibration reproducing apparatus 860 to the human body surface of the test human subject 12 via a liquid 860L (the liquid, which is normally a hot water, may be a liquid other than the hot water) in a bathtub or the bathtub 860C. A signal generator apparatus 860S presents a high frequency supra-perceptive vibration to the test human subject 12 by generating a prescribed high frequency supra-perceptive vibration and outputting the vibration to a plurality of high frequency supra-perceptive vibration presenting systems 860. The PET detector section 410 is worn on the head 12a of the test human subject 12, and PET measurement is performed. The information is received from an antenna 430a of the signal converter and transmitter section 430 by a wireless receiver section 440 via an antenna 440a and subjected to signal analysis by a signal analyzing section 420.

Although it is general that the medium of the high frequency supra-perceptive vibration or the superhigh frequency vibration to be applied is a gas such as air in the present preferred embodiment, the medium may be a liquid or a solid in a manner similar to that of the present preferred embodiment. By effectively applying the superhigh frequency vibration exceeding the upper limit of the audible range to the human body surface for integration with the audible range sound existing in the space where the user is located, the hypersonic effect is effectively produced in the user. Moreover, it is acceptable that no medium exists and the superhigh frequency vibration is applied directly via the body surface. Moreover, the superhigh frequency vibration generator apparatus may be singly used in a home, a public facility or the like without being limited to the time of PET measurement.

### Twenty-Sixth Preferred Embodiment

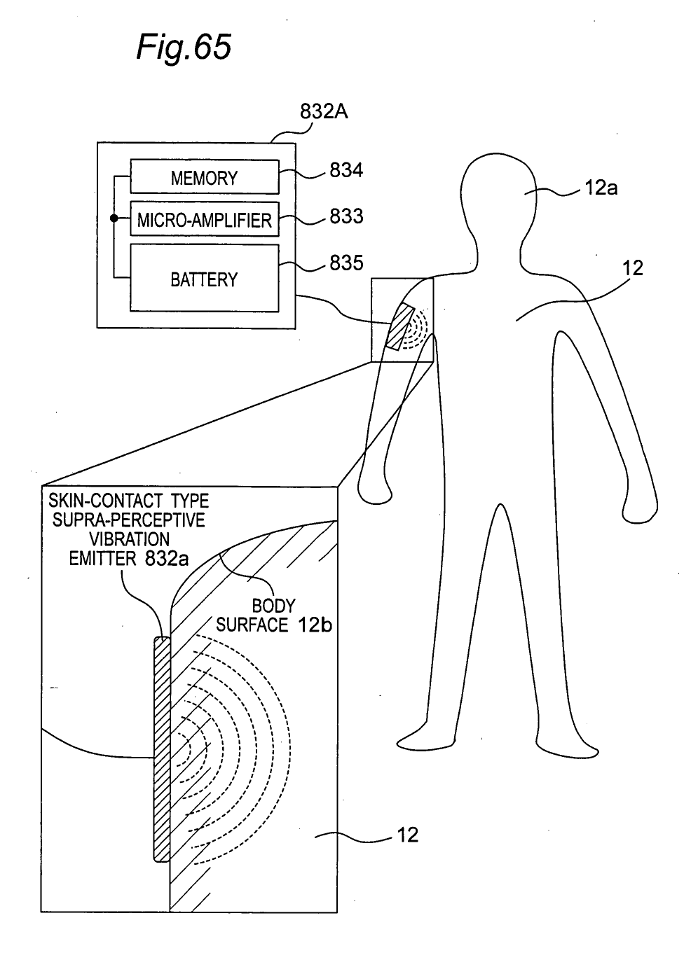

FIG. 65 is an appearance diagram showing a configuration of a high frequency supra-perceptive vibration generator apparatus 832A employing a skin-contact type superhigh frequency emitter 832a according to the twenty-sixth preferred embodiment of the present invention. FIG. 65 shows an apparatus for transmitting a high frequency supra-perceptive vibration to the skin not via the air by wearing the high frequency supra-perceptive vibration generator apparatus 832A in close contact with the skin. In the high frequency supra-perceptive vibration reproducing apparatus 832A, a high frequency supra-perceptive vibration signal, which is stored in a memory 834 or received wirelessly or by a cable or externally inputted, is amplified and transmitted by a cable or wirelessly through a microamplifier 833. The apparatus is implemented by fixing the skin-contact type superhigh frequency emitter 832a, which is a film-shaped vibration generator apparatus such as a compact actuator or a piezoelectric device, directly closely to the human body surface 12b of the skin or the like by a plaster, a supporter or the like, and the high frequency supra-perceptive vibration signal is transmitted directly to the skin. At this time, the test human subject 12 who is the wearer is able to evade from negative influences due to his or her listening to a music, a broadcasting sound, voices or the like falling within the audible range by using a portable digital player or the like and to concurrently enjoy the hypersonic effect by virtue of interactions of the music, a broadcasting sound, voices or the like within the audible range with the high frequency supra-perceptive vibration.

### Twenty-Seventh Preferred Embodiment

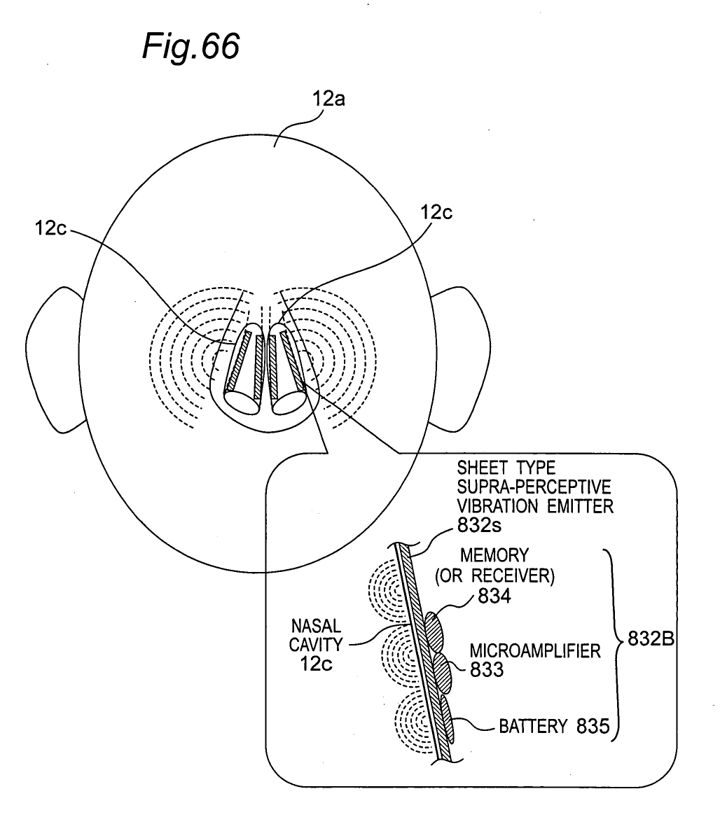

FIG. 66 is an appearance diagram and a sectional view showing a configuration of a high frequency supra-perceptive vibration generator apparatus 832B using a sheet type supra-perspective vibration emitter 832s inserted in the nasal cavities 12c of a test human subject 12 according to the twenty-seventh preferred embodiment of the present invention. FIG. 66 shows a high frequency supra-perceptive vibration reproducing apparatus 832B for transmitting the high frequency supra-perceptive vibration to the inside of the body such as the nasal cavities 12c of the test human subject 12 not via the air. The high frequency supra-perceptive vibration generator apparatus 832B is implemented by inserting the sheet type supra-perspective vibration emitter 832s, which is a film-shaped vibration generator apparatus such as a compact actuator or a piezoelectric device, into the body and closely fixing the same through the microamplifier 833, which amplifies and transmits a vibration signal that is stored in the memory 834 or received wirelessly or by a cable or externally inputted, and the vibration is transmitted directly to the inside of the body. With this arrangement, the high frequency supra-perceptive vibration can be efficiently transmitted to the test human subject 12. It is noted that the insertion portion may be the oral cavity, aural cavity, rectum, female genital organ or the like.

### Twenty-Eighth Preferred Embodiment

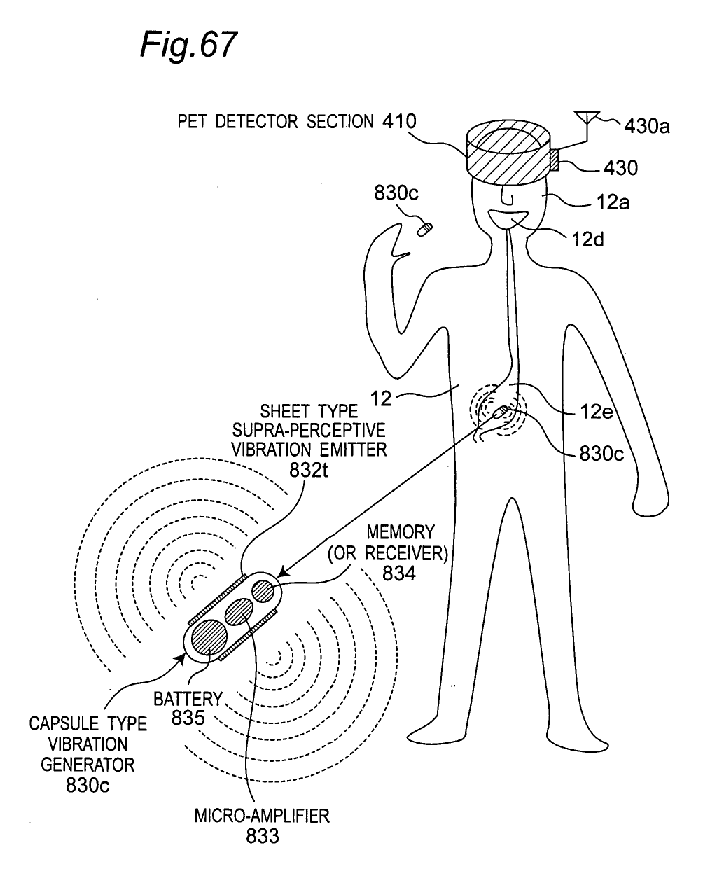

FIG. 67 is an appearance diagram and a sectional view showing a configuration of a capsule type vibration generator system 830c used by being administered in the body of a test human subject 12 according to the twenty-eighth preferred embodiment of the present invention. FIG. 67 shows the capsule type vibration generator system 830c that generates a vibration in the body while passing through the gullet, belly and intestines inside the body by being put and swallowed through the mouth of the test human subject 12 under PET measurement by the PET detector section 410. A vibration signal, which is stored in the memory 834 placed inside the generator apparatus 830c or received wirelessly or by a cable or externally inputted, is transmitted through a microamplifier 833 that amplifies and transmits a vibration by being driven by a battery 835 to generate a vibration from a vibrating surface by a sheet type supra-perspective vibration emitter 832t and transmit the vibration to the inside of the body.

### Twenty-Ninth Preferred Embodiment

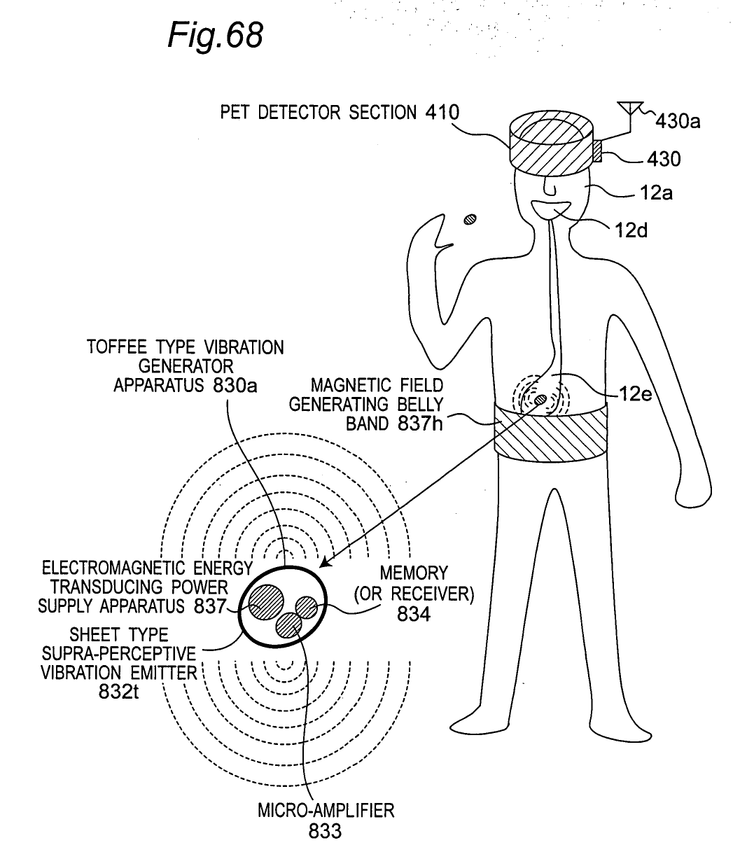

FIG. 68 is an appearance diagram and a sectional view showing a configuration of a toffee type vibration generator system 830a used by being administered in the body of the test human subject 12 according to the twenty-ninth preferred embodiment of the present invention. FIG. 68 shows the toffee type vibration generator system 830a that generates a vibration in the body while passing through the gullet, belly and intestines inside the body by being put and swallowed through the mouth of the test human subject 12 under PET measurement by the PET detector section 410. At this time, a magnetic field is generated by applying a magnetic field from the outside of the body by, for example, a magnetic field generating belly band 837h that generates the magnetic field by supplying an ac power to an electromagnetic coil without using any battery as a power supply, and an electromagnetic energy is generated while the toffee passes through the inside of the body to supply the power. A vibration signal, which is stored in the memory 834 placed in the toffee type vibration generator system 830a or received wirelessly or by a cable or externally inputted, is transmitted through a microamplifier 833 that amplifies and transmits a vibration by being driven by an electromagnetic energy transducing power supply apparatus 837 to generate a vibration from the sheet type supra-perspective vibration emitter 832t and transmit the vibration to the inside of the body. It is noted that the surface of the toffee type vibration generator system 830a is covered with the sheet type supra-perspective vibration emitter 832t, and the memory 834, the electromagnetic energy transducing power supply apparatus 837 and the microamplifier 833 are built in the system.

### Thirtieth Preferred Embodiment

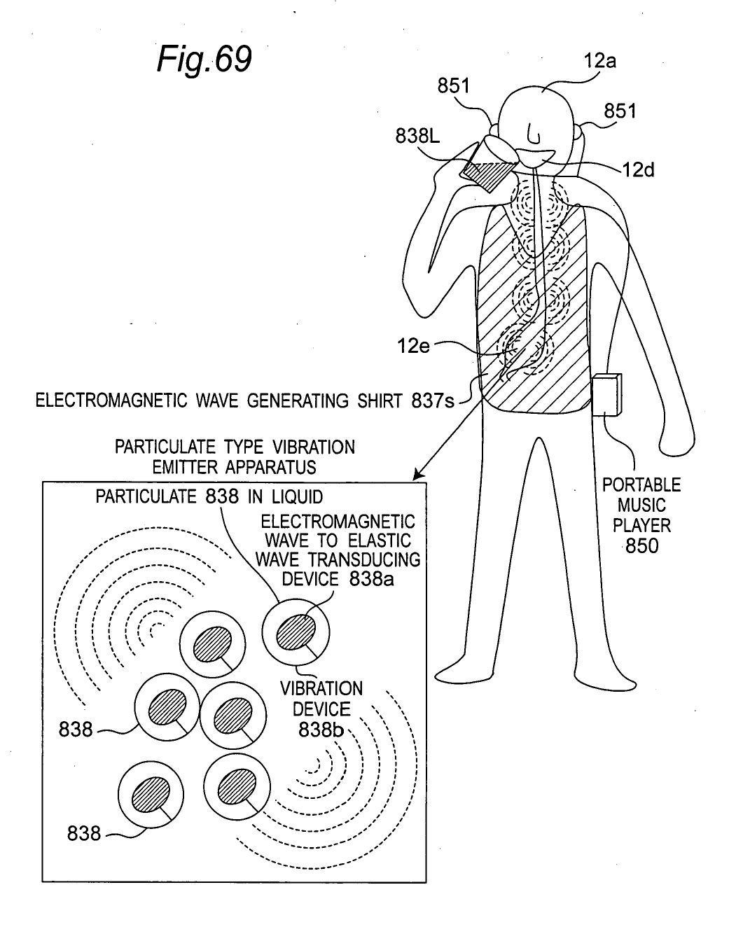

FIG. 69 is an appearance diagram and a sectional view showing a configuration of a particulate type vibration emitter system used by being administered in the body of the test human subject 12 according to the thirtieth preferred embodiment of the present invention. FIG. 69 shows the particulate type vibration presenting system that generates a vibration in the body while passing through the gullet, belly and intestines inside the body by putting and swallowing a liquid 838L constituted of numbers of particulates 838 through the mouth. The test human subject 12 listens to a favorite music by a portable music player 850 and a headphone 851 and wears, for example, an electromagnetic field generating shirt 837s that generates electromagnetic waves. Moreover, the particulates 838 in the liquid are constituted by covering an electromagnetic wave to elastic wave transducer device 838a, which transduces the applied electromagnetic waves into elastic waves, and outputs the waves to a vibration device 838b, with the vibration device 838b. As described above, an elastic vibration is generated by the electromagnetic wave to elastic wave transducer device 838a placed in the particulate by applying electromagnetic waves from the outside of the body as described above, and a high frequency supra-perceptive vibration or a superhigh frequency vibration is generated from the vibration device 838b to transmit the vibration to the inside of the body. It is noted that the vibrations presented in the twenty-first to thirtieth preferred embodiments may be any kinds of elastic vibrations including a low frequency vibration without being limited to the high frequency supra-perceptive vibration.

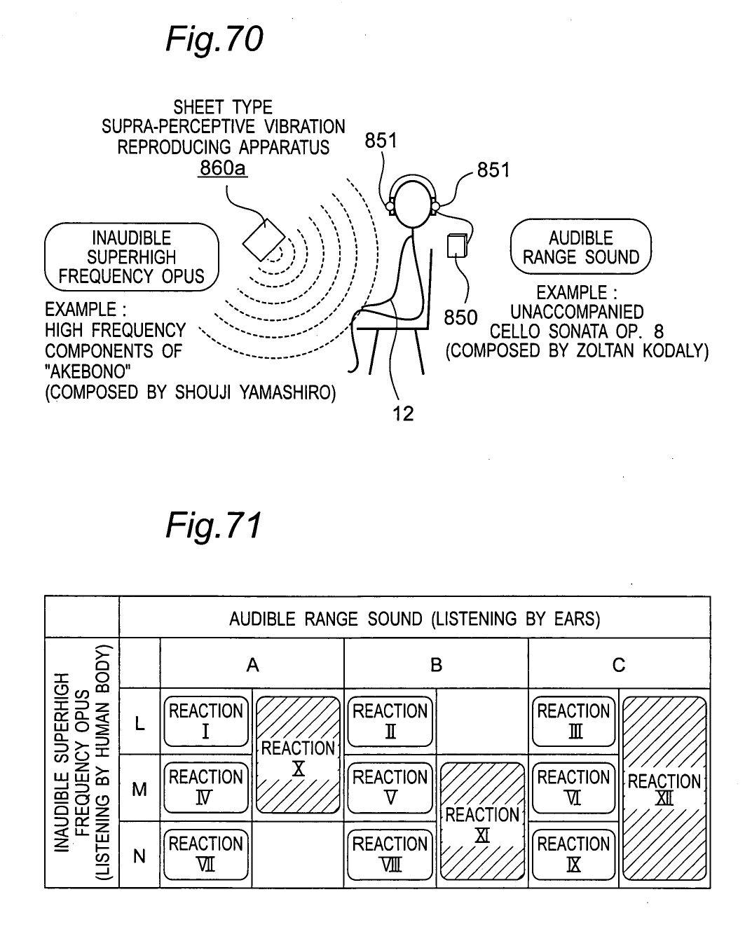

FIG. 70 is a general view showing one example of a superhigh frequency reproducing apparatus 860a according to the implemental example 3 of the present invention, and FIG. 71 is a view showing a relation between an aural listening audible range music by ears and a corporal listening inaudible superhigh frequency opus by human body according to the implemental example 3 of FIG. 70. The implemental example 3 is an example in which a vibration is constituted of a plurality of different vibration sources. The audible range music is reproduced by an audible sound reproducing apparatus 850 via a headphone 851. On the other hand, the inaudible superhigh frequency music is reproduced by the superhigh frequency reproducing apparatus 860a. As shown in FIG. 71, various combinations of the audible range music and the superhigh frequency opus music are possible, and respective reactions are generated. Moreover, since the superhigh frequency music does not influence the audibility, it is also possible to ovelappedly reproduce plural music. This fact generates further reactions. The combination of music of such a conception, it becomes possible to generate reactions to huge numbers of kinds of music in the listener.

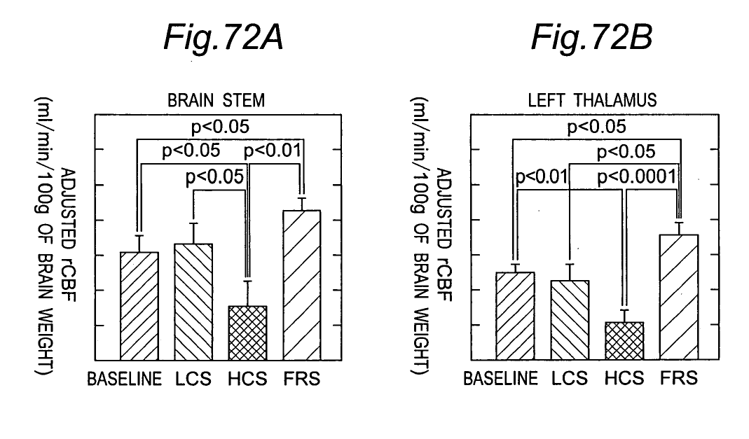

FIG. 72A is a graph showing an adjusted rCBF value in the brain stem, or the experimental results in the implemental example 3 of FIG. 70, and FIG. 72B is a graph showing an adjusted rCBF value in the left thalamus, or the experimental results in the implemental example 3 of FIG. 70.

That is, FIGS. 72A and 72B are graphs showing an amount of regional cerebral blood flow when a sound containing each frequency component is presented, measured by the experiments conducted by the present inventor and others. In this case, FIG. 72A shows the amount of regional cerebral blood flow in the position of the brain stem, and FIG. 72B shows the amount of regional cerebral blood flow in the position of the left thalamus. Referring to FIGS. 72A and 72B, the baseline represents such a case that no sound is presented. LCS (Low Cut Sound) represents such a case that only a sound of the superhigh frequency components (components exceeding approximately 22 kHz) is presented excluding the audible range components (components up to approximately 22 kHz). HCS (High Cut Sound) represents such a case that a sound of only the audible range component (component up to approximately 22 kHz) is presented excluding the superhigh frequency component (component exceeding approximately 22 kHz). FRS (Full Range Sound) presents such a case that both the superhigh frequency component and the audible range component are simultaneously presented.

As is apparent from FIGS. 72A and 72B, it can be understood that the amount of the regional cerebral blood flow is significantly lowered in the brain stem and the left thalamus when the sound only of the audible range component is presented excluding the superhigh frequency component as compared with such a case that no sound is presented.

The nucleuses of the most important vital functions related to the maintenance of life concerning aspiration, blood pressure, blood sugar regulation and so on are intensively distributed in the brain stem, and evaluations of the activities of the brain stem are the decisive keys also for the determination of brain death. Moreover, the nucleus of the autonomic nerve system that controls the activities of the internal organs of the whole body, the nucleus of the fundamental activities of the living thing, the nucleus of the circadian rhythm of sleep and awakening and the like also exist in the brain stem. It is considered that the reticular activating system of the brain stem plays the adjustive roles of the activity level of the whole brain. On the other hand, the thalamus is an aggregate of the nerve nucleuses existing in the deep brain region and plays an important role as a base to process sensory input signals from the whole body including the visual and auditory senses and relay them to the cerebral cortex. Moreover, the thalamus receives and integrates signals from the cerebral cortex, the limbic system and so on and plays an important role as a fundamental base to generalize the control systems of the whole body such as the endocrine system and the autonomic nerve system via the hypothalamus. The phenomenon that the amount of bloodstream is lowered in the deep brain regions such as the brain stem and the thalamus when a sound of only the audible range component is presented excluding the superhigh frequency component is considered to be in a risky state for the human existence and health.

### Thirty-First Preferred Embodiment

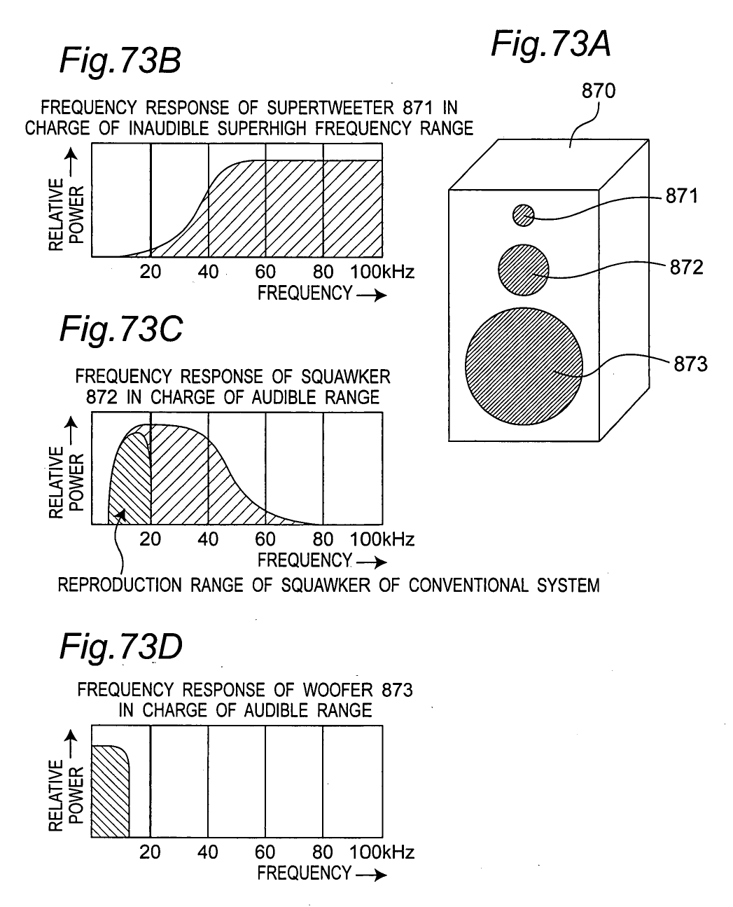

FIG. 73A is an appearance diagram showing a configuration of a loudspeaker 870 used in the thirty-first preferred embodiment of the present invention. FIG. 73B is a graph showing a frequency response of the supertweeter 871 in charge of an inaudible superhigh frequency range of FIG. 73A. FIG. 73C is a graph showing a frequency response of a squawker 872 in charge of an audible range of FIG. 73A. FIG. 73D is a graph showing a frequency response of a woofer 873 in charge of an audible range of FIG. 73A.

The embodiments of FIGS. 73A to 73D show implemental examples of the band division of the loudspeaker 870, which secures the generation of the high frequency supra-perceptive vibration and concurrently facilitates confirmation of the normal action by the human auditory sense with doubled high frequency supra-perceptive vibration generator apparatuses. The loudspeaker 870 is configured by including the supertweeter 871, the squawker 872 and the woofer 873.

It is generally difficult to achieve satisfactory characteristics in a range from a low band to a high band by one unit regarding the loudspeaker unit for transducing an electrical signal into aerial vibration, and a multi-way loudspeaker system, in which the total band is divided into two to four bands and units having functions appropriate for the respective bands take charge of the bands, is practically adopted. In the case of the loudspeaker intended for the hypersonic effect when the system is adopted, the listener cannot comprehend whether or not the supertweeter 871 taking charge of the high frequency supra-perceptive vibration is normally functioning since the listener cannot perceive the vibration. Accordingly, there is a problem that the risk of generating negative effects such as a reduction in the amount of bloodstream in the brain core cannot be detected in the case of a failure at the worst. Therefore, a safety measure to prevent the generation of the negative effects even if the supertweeter 871 fails in a situation in which the human being cannot cope with it during sleep or the like is needed. As a safety measure to solve the problem, a speaker unit having a satisfactory response in the band up to 50 kHz capable of preventing at least such a negative influence is provided for the speaker unit that takes charge of the highest frequency band in charge of the audible range, and totally two units inclusive of the supertweeter 871 take charge of the generation of the high frequency supra-perceptive vibration, preventing the occurrence of the risk of the lack of the high frequency supra-perceptive vibration even if either one of the speaker units fails.

This makes it possible to protect the listener from the negative influence due to the nonexistence of the high frequency supra-perceptive vibration even if the supertweeter 871 that is the loudspeaker taking charge of the super-audible range fails at the worst. Furthermore, this helps to easily detect and cope with modulations in the super-audible range since the modulations of the squawker 872 are accompanied by sound modulations in the audible range and perceived by the human auditory sense even in the absence of special equipment for monitoring the presence or absence of the vibration in the high frequency supra-perceptive region. That is, the squawker 872 is configured so as to be able to reproduce the components in the audible range of about 8 kHz to the high frequency supra-perceptive region or the superhigh frequency region of about 50 kHz as shown in FIG. 73C. Furthermore, with regard to the reproduction band of the supertweeter 871 that is the loudspeaker taking charge of the super-audible range, by making the supertweeter take charge of the band including the audible band even though the level is low as shown in FIG. 73B, the sound can be recognized as acoustic modulations by the human auditory sense.

### Thirty-Second Preferred Embodiment

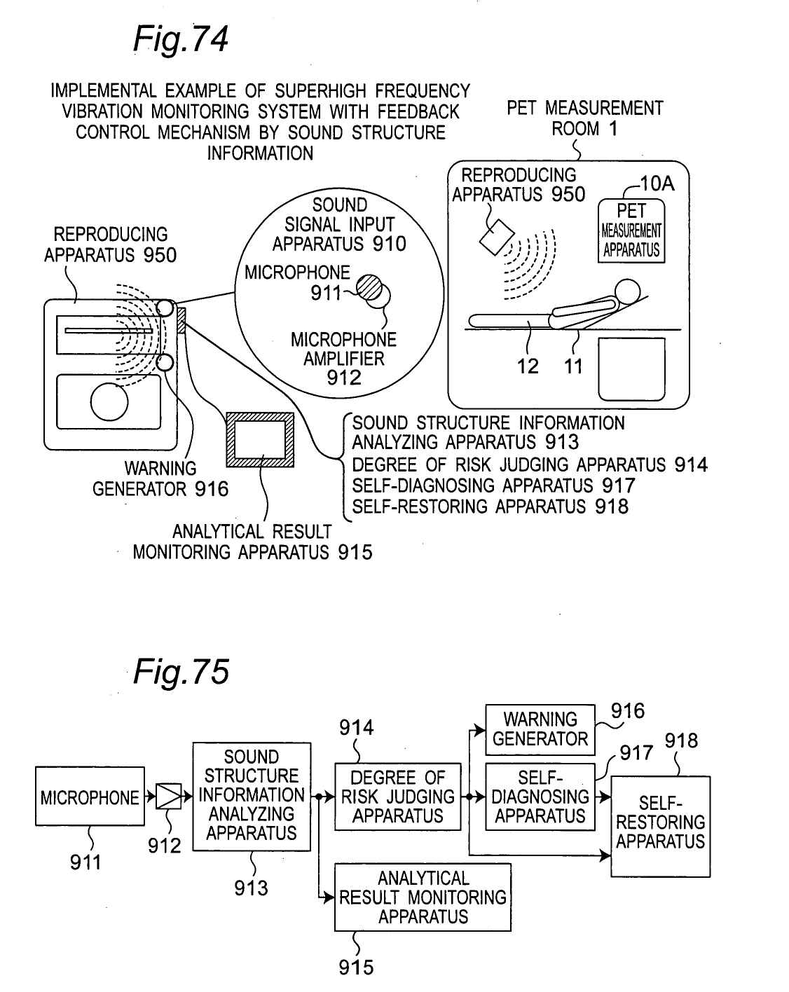

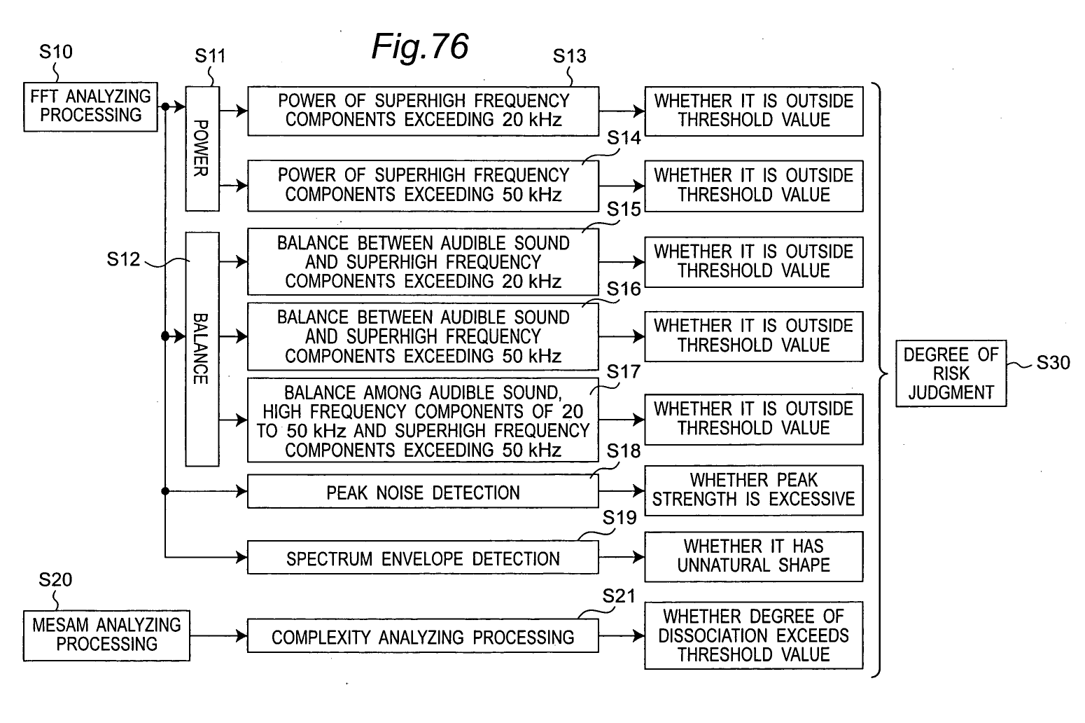

FIG. 74 is a block diagram showing an implemental example of the superhigh frequency vibration monitoring system including a feedback control mechanism by sound structure information according to the thirty-second preferred embodiment of the present invention. FIG. 75 is a block diagram showing a detailed configuration of the superhigh frequency vibration monitoring system of FIG. 74. FIGS. 76 to 78 are flow charts showing a detailed processing of the superhigh frequency vibration monitoring system of FIG. 74.

The present preferred embodiment is related to the sound structure information monitor and the feedback system and intended to adjust the vibration reproducing levels of the audible range and the high frequency supra-perceptive region by confirming a situation in which the high frequency supra-perceptive vibration is generated and feeding the analytical results of the acoustic structure back to a high frequency supra-perceptive vibration reproducing apparatus 950. The embodiment is configured by including a microphone 911 that is placed in the vicinity of the high frequency supra-perceptive vibration reproducing apparatus 950 of the PET measurement room 1 in which the test human subject 12 is subjected to PET measurement by the PET measurement apparatus 10A and records the surrounding environmental sound, an analyzing apparatus 913 and so on for analyzing the acoustic structure of the recorded data and a monitoring apparatus 915 for displaying the analytical results. The monitoring apparatus 915 displays, for example, an FFT spectrum for viewing the average of the frequency structure, a maximum entropy spectrum array for visually displaying the time change of the frequency structure, an ME spectrum one-order differential cumulative variation that become an index of the complexity of the sound structure, the one-order differential cumulative variations and so on. With this arrangement, the listener and the user can confirm the structure of the unperceivable high frequency supra-perceptive vibration. This fact helps to prevent in advance the occurrence of a negative influence such as a decline in the cerebral blood flow when a trouble occurs in the generation of the high frequency supra-perceptive vibration. Moreover, it helps to appreciate stable enjoyment of the hypersonic effect by virtue of the concurrent existence of music in the audible range, an environmental sound, a broadcasting sound, voices or the like with the high frequency supra-perceptive vibration.

Referring to FIG. 74, the reproducing apparatus 950 includes a sound signal input apparatus 910 as configured by including the microphone 911 and a microphone amplifier 912, a sound structure information analyzing apparatus 913, a degree of risk judging apparatus 914, a self-diagnosing apparatus 917, a self-restoring apparatus 918, a warning generator 916 and an analytical result monitoring apparatus 915. Referring to FIG. 75, a sound signal is converted into an electrical signal by the microphone 911, and then, it is inputted to the sound structure information analyzing apparatus 913 via the microphone amplifier 912. The sound structure information analyzing apparatus 913 analyzes the sound structure information of the inputted sound, and outputs the analytical results to the degree of risk judging apparatus 914 and the analytical result monitoring apparatus 915. The degree of risk judging apparatus 914 judges the degree of risk on the basis of the analytical results of the inputted sound information, and outputs the judgment result to the warning generator 916, the self-diagnosing apparatus 917 and the self-restoring apparatus 918. The concrete processing is described below with reference to FIGS. 76 to 78.

The processing of FIG. 76 is executed by the sound structure information analyzing apparatus 913 and the degree of risk judging apparatus 914. Referring to FIG. 76, an FFT (Fast Fourier Transform) analyzing process (S10) is executed to execute power detection (S11), component power balance detection (S12), peak noise detection (S18) and spectrum envelope detection (S19). It is determined during the power detection (S11) whether or not the power of the superhigh frequency components exceeding 20 kHz (S13) is outside the range of a prescribed threshold value to judge the degree of risk (S30), and it is determined whether or not the power of the superhigh frequency components exceeding 50 kHz (S14) is outside the range of a prescribed threshold value to judge the degree of risk (S30). Moreover, it is determined during the component power balance detection (S12) whether or not a balance (component ratio) between the audible sound and the high frequency components exceeding 20 kHz is outside the range of a prescribed threshold value to judge the degree of risk (S30), and it is determined whether or not a balance (component ratio) between the audible sound and the superhigh frequency components exceeding 50 kHz is outside the range of a prescribed threshold value to judge the degree of risk (S30). A balance (component ratio) among the audible sound, the high frequency components of 20 to 50 kHz and the superhigh frequency components exceeding 50 kHz is outside the range of a prescribed threshold value to judge the degree of risk (S30). Further, it is determined during the peak noise detection (S18) whether or not the intensity of the peak is excessive exceeding a prescribed level to judge the degree of risk (S30). Furthermore, it is determined during the spectrum envelope detection (S19) whether or not the envelope has a preparatorily stored natural shape or whether it has an unnatural shape to judge the degree of risk (S30). Furthermore, a MESAM analysis process (S20) is executed to execute a complexity analyzing process (S21), and it is determined whether the degree of dissociation from a prescribed reference exceeds a prescribed threshold value to judge the degree of risk (S30). In the processing of FIG. 76, the degree of risk is judged on the basis of a plurality of judgments.

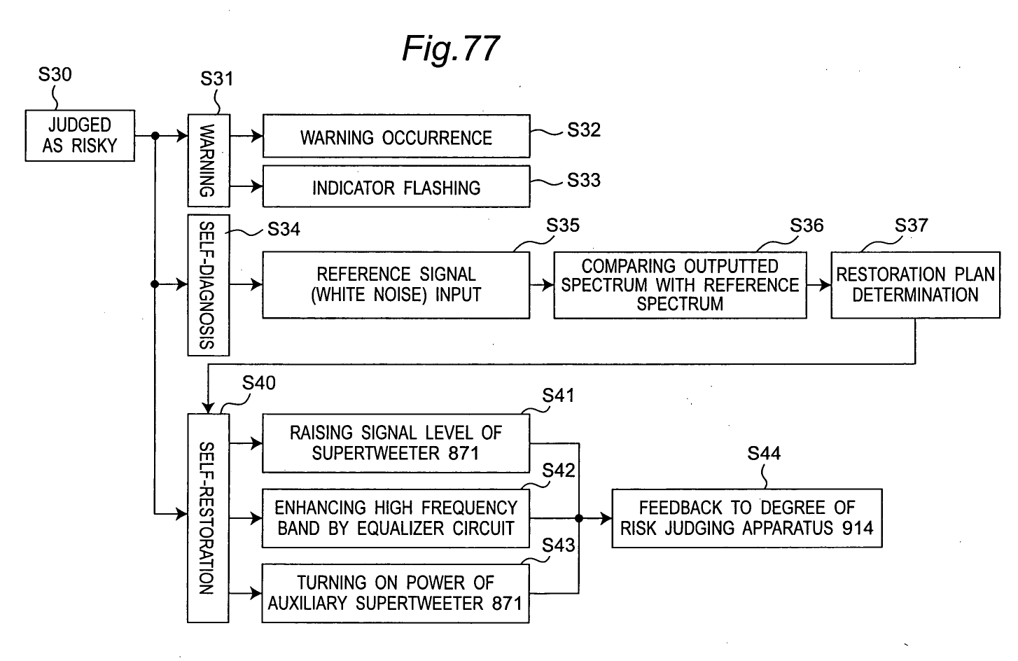

Referring to FIG. 77, when it is judged to be risky (S30), warning is issued (S32) and an indicator flashes (S33) in a warning process (S31). Moreover, in a self-diagnosing process (S34), a reference signal that is white noise is inputted via the microphone 911 (S35), and the spectrum of the outputted sound signal is compared with a prescribed reference spectrum. A restoring policy is determined on this basis (S37), and the following self-restoring process (S40) is executed. Moreover, it is acceptable to execute the following self-restoring process (S40) when it is judged to be risky (S30). In the self-restoring process, the signal level of the supertweeter 871 is raised by a prescribed level (S41), the high frequency band is boosted by a prescribed level by an equalizer circuit (S42), and the power of an auxiliary supertweeter 871 is turned on (S43). After the self-restoring process is executed, a feedback is made to the degree of risk judging apparatus 914 to judge the degree of risk again.

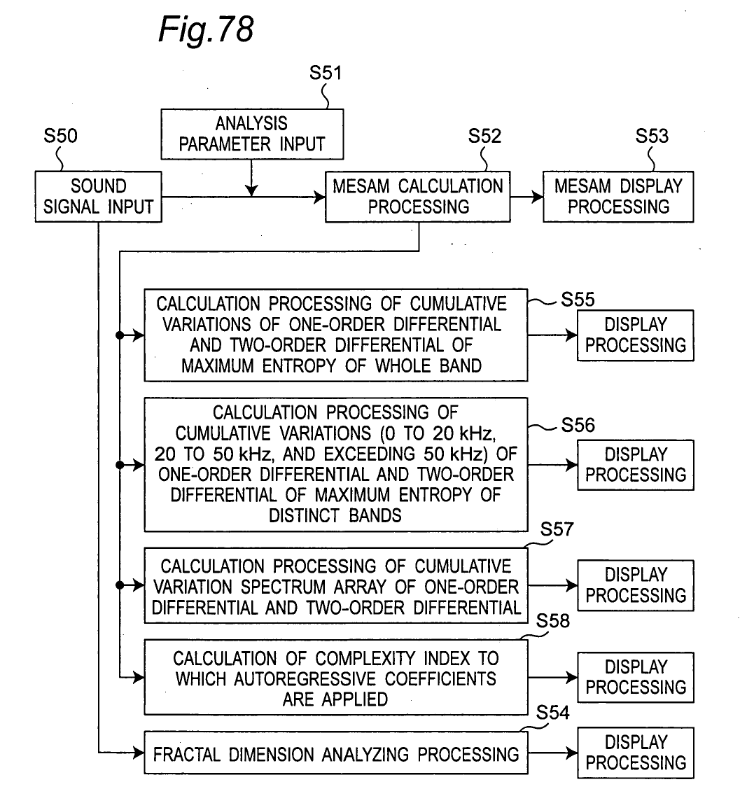

FIG. 78 shows processing related to the input of the sound signal and processing concerning the calculation and display processing therefor. A sound signal is inputted (S50), a prescribed analysis parameter is inputted (S51), and MESAM calculation processing (S52) and display processing (S53) therefor are executed. Moreover, a fractal dimension analysis processing (S54) is executed, and display processing therefor is executed. Further, the following various calculation processings are executed in the MESAM calculation processing (S52).

(1) A calculation processing (S55) of the cumulative variations of the one-order differential and two-order differential of the maximum entropy spectrum of the whole band is executed, and display processing therefor is performed.

(2) A calculation processing (S56) of the cumulative variations (0 to 20 kHz, 20 to 50 kHz, and exceeding 50 kHz) of the one-order differential and the two-order differential of the maximum entropy spectrum of distinct bands is executed, and display processing therefor is performed.

(3) A calculation processing (S57) of the cumulative variation spectrum array of the one-order differential and the two-order differential is executed, and display processing therefor is performed.

(4) A calculation processing (S58) of the complexity index to which autoregressive coefficients are applied is executed, and display processing therefor is performed.

### Thirty-Third Preferred Embodiment

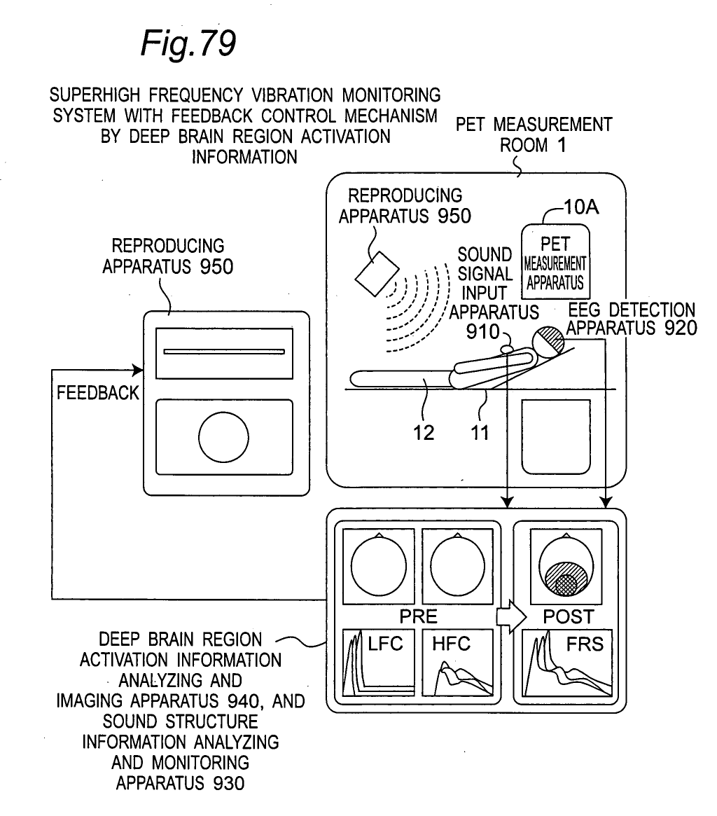

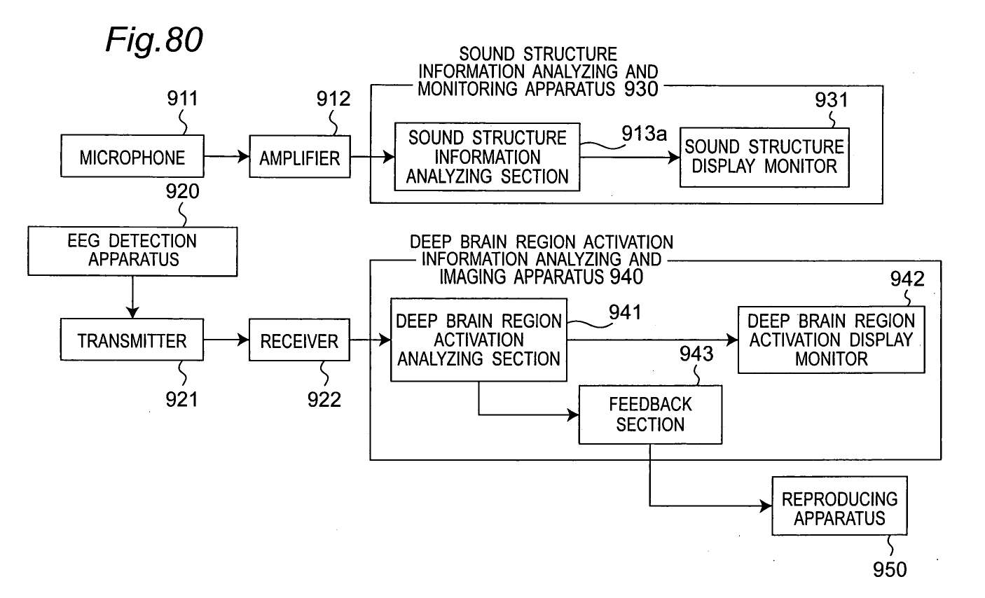

FIG. 79 is a block diagram showing an implemental example of a superhigh frequency vibration monitoring system including a feedback control mechanism by deep brain region activation information according to the thirty-third preferred embodiment of the present invention. FIG. 80 is a block diagram showing a detailed configuration of the superhigh frequency vibration monitoring system of FIG. 79. FIGS. 79 and 80 show a preferred embodiment of the deep brain region activation information monitoring and feedback system. The present preferred embodiment is intended to adjust the vibration reproducing levels of the audible range and the high frequency supra-perceptive region by confirming the situation of the activation of the deep brain region and feeding the result back to the high frequency supra-perceptive vibration reproducing apparatus 950 and includes a sound input apparatus 910 that is placed in the vicinity of the test human subject 12 in the PET measurement room 1 and records the surrounding environmental sound, an EEG detection apparatus 920 for deriving a deep brain region activation index, a deep brain region activation information analyzing and imaging apparatus 940 for analyzing the deep brain region activation index, a sound structure information analyzing and monitoring apparatus 930 for displaying the analytical results and an apparatus for feeding it back to the reproducing apparatus 950. This helps to prevent in advance the occurrence of negative influences such as a decline in the cerebral blood flow. Otherwise, it helps stable enjoyment of the hypersonic effect.

Referring to FIG. 80, a sound signal reproduced by the reproducing apparatus 950 is converted into an electrical signal by the microphone 911, and then, it is inputted to a sound structure information analyzing part 913a of a sound structure information analyzing and monitoring apparatus 930 via an amplifier 912. The sound structure information analyzing part 913a analyzes the sound structure information of the inputted reproduction sound signal, and then, displays the sound structure on a sound structure monitor apparatus 931. Moreover, information of the deep brain region activation index outputted by an EEG detection apparatus 920 is transmitted by a transmitter 921, and then, it is received by a receiver 922 and inputted to a deep brain region activation analyzing part 941 of the deep brain region activation information analyzing and imaging apparatus 940. The deep brain region activation analyzing part 941 analyzes the information of the inputted deep brain region activation index, displays the analytical results on a deep brain region activation display monitor 942 and feeds the information back to a reproducing apparatus 950 via a feedback section 943. As a result, by controlling the reproduction parameters of the reproducing apparatus 950 on the basis of the analytical results of the information of the deep brain region activation index, the occurrence of negative influences such as a decline in the cerebral blood flow can be prevented in advance.

### Thirty-Fourth Preferred Embodiment

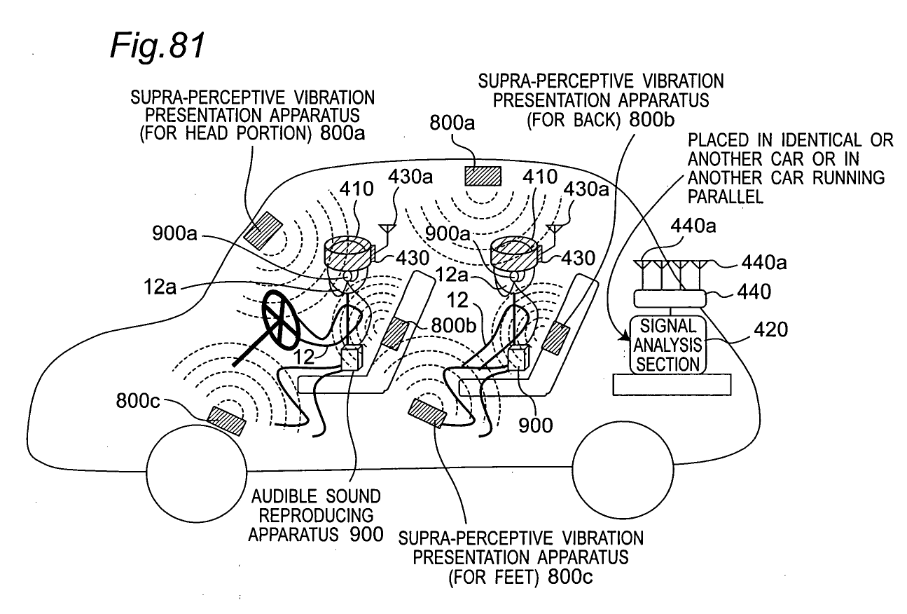

FIG. 81 is a block diagram showing a configuration when a plurality of test human subjects 12 are subjected to PET measurement in a car by using high frequency supra-perceptive vibration reproducing apparatuses 800a, 800b and 800c according to the thirty-fourth preferred embodiment of the present invention. Although the preferred embodiment in the train car has been described in the twentieth preferred embodiment of FIG. 59, the present preferred embodiment is a preferred embodiment of PET measurement intended for the test human subjects 12 located in a car. Referring to FIG. 81, vibrations are presented from the high frequency supra-perceptive vibration presenting systems 800a, 800b and 800c installed in the car and applied to the regions of the faces, bodies, backs and so on of the persons located in the car. These presentation or generator apparatuses may present an identical vibration source or concurrently use different vibration sources. At this time, the persons located in the car may listen to mutually different favorite audible sounds by using audible sound reproducing apparatuses 900 that are portable players or the like. At this time, the signal analyzing section 420 is installed in an identical or another car or in another car that is running parallel. The vibration to be reproduced may be a vibration that is not in the high frequency supra-perceptive region.

### Thirty-Fifth Preferred Embodiment

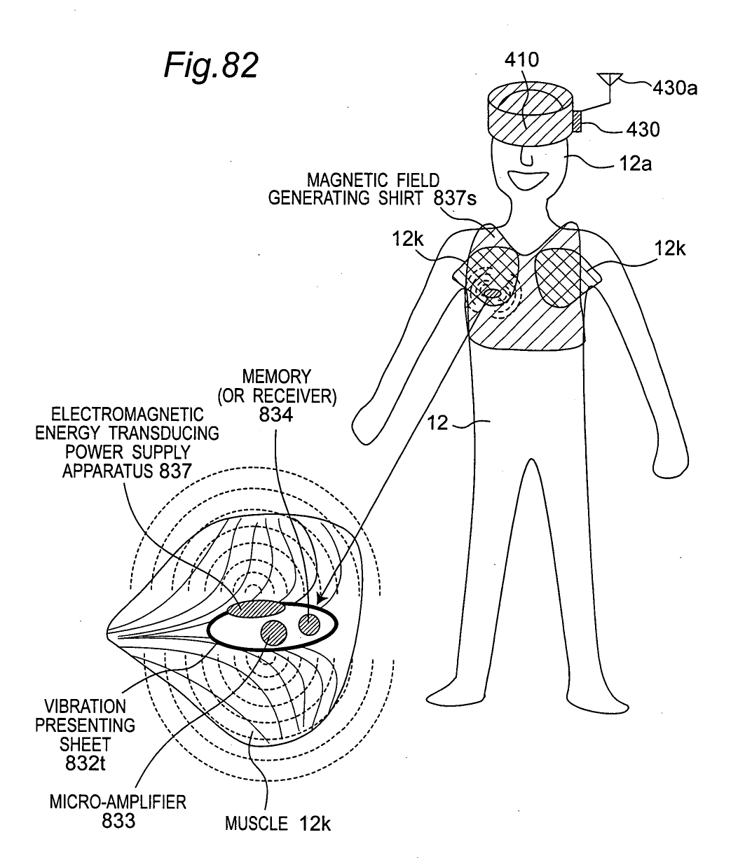

FIG. 82 is an appearance diagram and a sectional view showing a configuration of a vibration presenting system embedded in a muscle 12k of a test human subject 12 according to the thirty-fifth preferred embodiment of the present invention. In the present preferred embodiment, an embedded type vibration presenting system that generates a vibration in the body by being embedded in the muscle 12k of the test human subject 12 of a living body or the like is disclosed. In this case, by embedding a battery as a power supply alongside in the apparatus or applying a magnetic field from the outside of the body by using, for example, a magnetic field generating shirt 837s or the like, the magnetic field is transduced into electricity by an electromagnetic energy transducing power supply apparatus 837 to supply a power. A vibration is generated from a sheet type supra-perspective vibration emitter 832t via a microamplifier 833 that amplifies and transmits a vibration signal stored in a memory 834 placed in the apparatus (or externally inputted wirelessly or by a cable), and the vibration is transmitted to the inside of the body via the muscle 12k. It is noted that the target place of embedment is not limited only to the muscle 12k but allowed to be internal organs, inside body fluids, bones and so on.

### Thirty-Sixth Preferred Embodiment

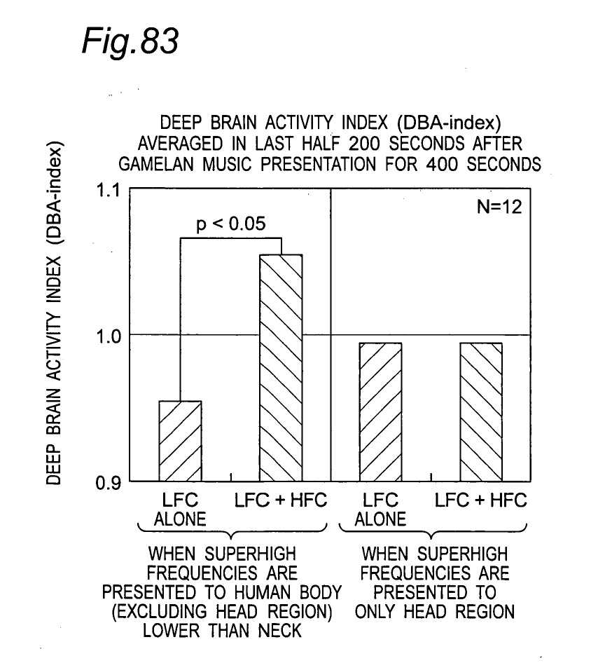

FIG. 83 is a graph of an implemental example according to the thirty-sixth performed embodiment of the present invention, showing measurement results of the deep brain activity index (DBA-index) averaged in last half 200 seconds after presentation for 400 seconds when a gamelan music containing a superhigh frequency is presented to the human body (excluding the head) lower than the neck and when the gamelan music including a superhigh frequency is presented only to the head. In the present implemental example, a gamelan music that abundantly contained a high frequency component was used as a sound presented for 400 seconds, and brain waves were measured when the superhigh frequency component (HFC) of not lower than 22 kHz was

(1) presented only to the human body (excluding the head) lower than the neck of the test human subject (LFC+HFC)/not presented (only LFC), and

(2) presented only to the head of the test human subject (LFC+HFC)/not presented (only LFC)

while an audible sound (LFC) of not higher than 22 kHz was presented consistently to the auditory sense system.

The living body component regions to which the sound is not presented are covered so as not to be exposed to the presentation in a manner similar to that of a preferred embodiment described in detail later. An average value of the brain wave α2 band (10 to 13 Hz) obtained from seven electrodes (electrode names: C3, C4, T5, T6, Pz, O1, and O2) in the central parieto-occipital region was assumed to be a “deep brain activity index (DBA-index)” and compared between the conditions. It is described that the index is significantly correlated to the activation of the whole neural network of the fundamental brain of the regions that bears the fundamental functions of the brain including the brain stem, the thalamus and the hypothalamus, which are considered to be the neural base of the hypersonic effect (See, for example, Non-Patent Document 11).

In the above case of (1), a significant increase was observed in the (LFC+HFC) condition than in the LFC single condition. On the other hand, no significant difference was observed in the above case of (2). The results showed the possibility that the presentation of the superhigh frequency component to the human body was the necessary condition to develop the hypersonic effect. From the discovery, it is expected that the development of the hypersonic effect is made to be easily induced by devising the apparatus that effectively presents the superhigh frequency vibration to the human body which is usually covered with clothing or the like and to which the aerial vibration is hard to reach.

### Thirty-Seventh Preferred Embodiment

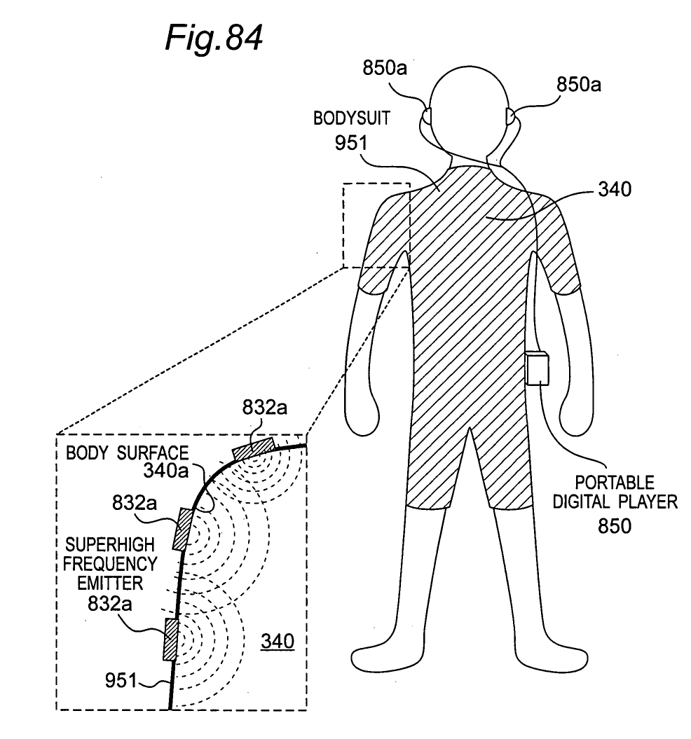

FIG. 84 is an appearance diagram and a sectional view of a vibration presenting system of a bodysuit 951 that has a plurality of superhigh frequency emitters 832a according to the thirty-seventh preferred embodiment of the present invention. Referring to FIG. 84, by wearing the bodysuit type clothing constituted of the bodysuit 951 in which a number of superhigh frequency emitters 832a are embedded closely on the skin or body surface 340a of a test human subject 340, a superhigh frequency vibration can be extremely effectively transmitted to the human body (excluding the head) of the test human subject 340.

In the superhigh frequency emitters 832a, a high frequency supra-perceptive vibration signal, which is stored in a memory or received wirelessly or by a cable or inputted from an external circuit, is amplified by a microamplifier or the like, and a vibration is generated by a film-shaped vibration generator apparatus such as a compact actuator or a piezoelectric element. By embedding the superhigh frequency emitters 832a as described above in the bodysuit-shaped clothing that is worn directly closely on the body (excluding the head), the high frequency supra-perceptive vibration is effectively transmitted to the human body. At this time, the test human subject 340 who is the wearer can effectively enjoy the hypersonic effect by an interaction with the high frequency supra-perceptive vibration even when listening to a music, a broadcasting sound, voices or the like that fall within the audible range frequencies by using a portable digital player 850, an earphone 850a or the like.

### Thirty-Eighth Preferred Embodiment

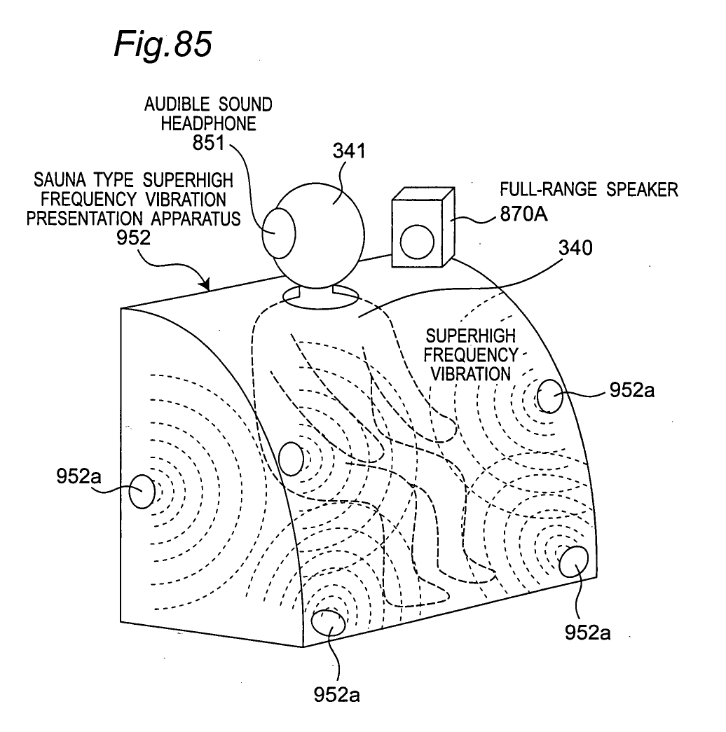

FIG. 85 is an appearance diagram of a sauna type vibration presenting system having a plurality of superhigh frequency emitters 952a according to the thirty-eighth preferred embodiment of the present invention. In the thirty-eighth preferred embodiment, by an entry into a sauna type superhigh frequency vibration presenting system 952 in which a number of superhigh frequency emitters 952a are placed, a superhigh frequency vibration can be extremely effectively showered on the body (excluding the head). A number of superhigh frequency emitters 952a in the sauna are similar to those of the preferred embodiment described above. In this case, the test human subject 340 who enters the sauna can effectively enjoy the hypersonic effect by an interaction with the high frequency supra-perceptive vibration to the human body even when listening to a sound falling within the audible range frequencies by using an audible sound headphone 851 or the like or receiving a vibration perceived as a sound by the air conduction auditory system including the head by using a full-range speaker 870A or the like.

### Thirty-Ninth Preferred Embodiment

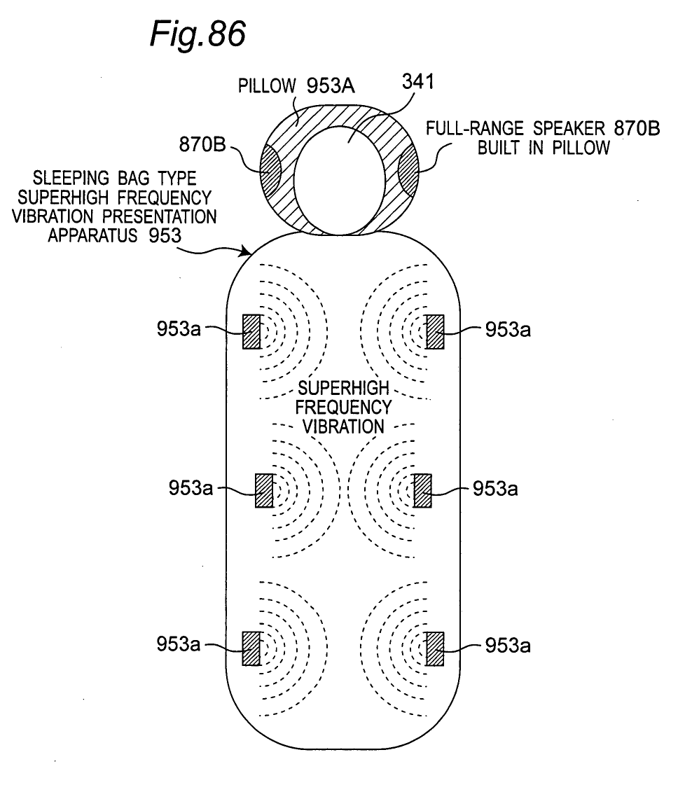

FIG. 86 is an appearance diagram of a sleeping bag type vibration presenting system having a plurality of superhigh frequency emitters 953a according to the thirty-ninth preferred embodiment of the present invention. In the thirty-ninth preferred embodiment, by sleeping in a sleeping bag type superhigh frequency vibration presenting system 953 in which a number of superhigh frequency emitters 953a are placed, the superhigh frequency vibration can be transmitted extremely effectively to the human body even during the sleep. A number of superhigh frequency emitters 953a in the sleeping bag are similar to those of the preferred embodiments described above. In this case, the test human subject 340 who is in the sleeping bag has only his or her head exposed and able to effectively enjoy the hypersonic effect by an interaction with the high frequency supra-perceptive vibration to the human body (excluding the head) even when listening to a sound falling within the audible range frequencies by using a headphone (not shown) or receiving a vibration perceived as a sound by the air conduction auditory system including the head by using a full-range speaker 870A built in a pillow or the like built in a pillow 953A.

### Fortieth Preferred Embodiment

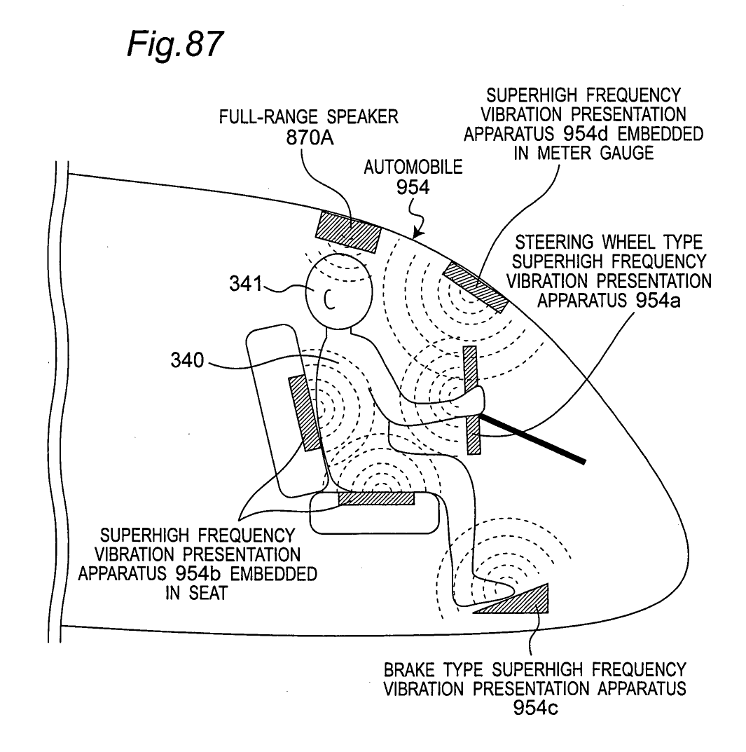

FIG. 87 is a partially removed appearance diagram of a driver's seat of a car 954 having a plurality of superhigh frequency vibration presenting systems 954a to 954d according to the fortieth preferred embodiment of the present invention. In the fortieth preferred embodiment, by driving a car 954 (this may be the vehicle of a locomotive, a train, an ocean vessel, an aircraft, a manned rocket or the like besides the car) in the driver's seat or a cockpit in such a state that a number of superhigh frequency vibration presenting systems 954a to 954d are placed, a superhigh frequency vibration can be effectively presented to the human body. The superhigh frequency vibration presenting systems 954a to 954d effectively present the superhigh frequency vibration to the human body (preferably excluding the head) by generating the superhigh frequency vibration by the vibration generator apparatus in a manner similar to that of the preferred embodiments described above. In this case, the driver can effectively enjoy the hypersonic effect by an interaction with the high frequency supra-perceptive vibration even when listening to music, a broadcasting sound, voices or the like falling within the audible range frequencies by using a general loudspeaker or a headphone. This can be expected to promote the psychosomatic health of the driver, maintain the awakening level and exalt the driving safety. The apparatus may be placed at the crew's room, the crew's seat, the passenger's room and passenger's seat without being limited to the driver's seat and the cockpit.

### Forty-First Preferred Embodiment

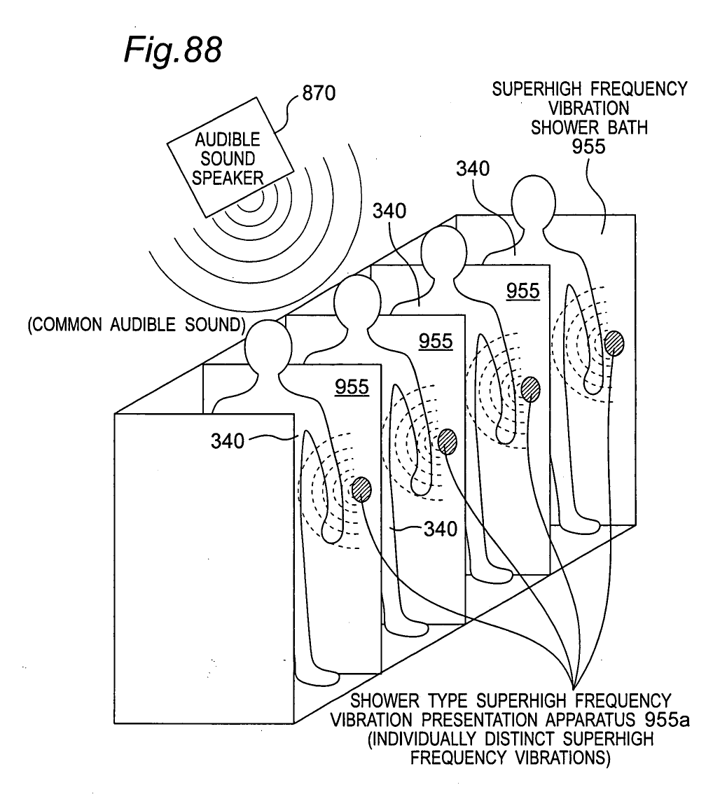

FIG. 88 is an appearance diagram and a sectional view of a plurality of shower type vibration presenting systems according to the forty-first preferred embodiment of the present invention. In the forty-first preferred embodiment, a plurality of persons can get showers of favorite superhigh frequency vibrations in high frequency vibration shower rooms 955 in a shower room type facility used by the persons. Referring to FIG. 88, a superhigh frequency vibration presenting system 955a placed in each of the high frequency vibration shower room 955 can effectively shower on the body (preferably excluding the head) with a superhigh frequency vibration signal selected by the user from a number of kinds of superhigh frequency vibration signals stored in a memory. At this time, the user listens to common audible range music, a broadcasting sound, voices or the like from a general audible sound loudspeaker 870. The user can effectively enjoy the hypersonic effect by an interaction of those audible sounds with the high frequency supra-perceptive vibration. It is noted that the user may listen to the individual favorite audible sounds by bringing a portable player or the like instead of listening to the common audible sound.

### Forty-Second Preferred Embodiment

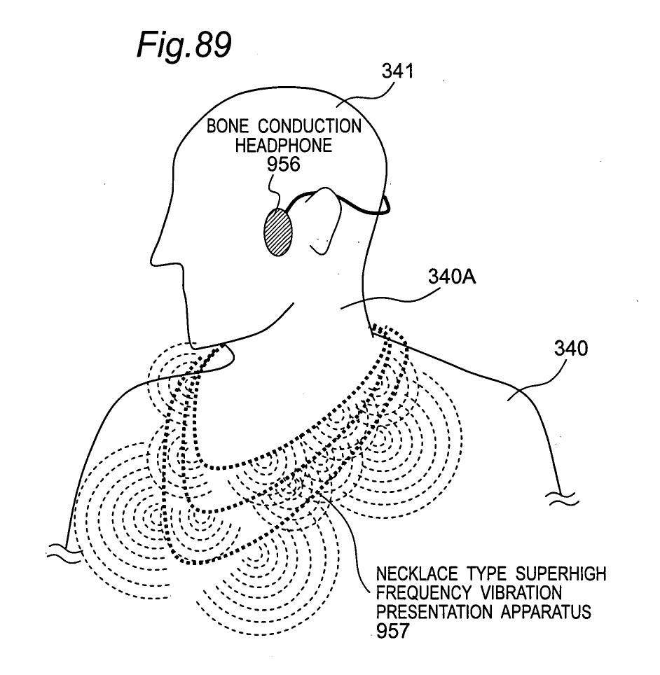

FIG. 89 is an appearance diagram of a bone-conducting headphone 956 and a necklace type superhigh frequency vibration presenting system according to the forty-second preferred embodiment of the present invention. In the forty-second preferred embodiment, a superhigh frequency vibration can be applied to the human body (preferably excluding the head) by a necklace type superhigh frequency vibration presenting system 957 embedded in an accessory such as a necklace concurrently with applying a vibration perceivable as a sound by the bone-conducting headphone 956. The applying apparatus by bone conduction is merely required to be an apparatus that can transmit the vibration to the bone-conducting auditory sense system instead of the headphone type. Moreover, the apparatus that applies the superhigh frequency vibration may be another apparatus that can apply the superhigh frequency vibration to the living body component region including at least one part of the body (excluding the head). In this case, the wearer can effectively enjoy the hypersonic effect by an interaction with the high frequency supra-perceptive vibration simultaneously presented to the human body even when listening to music, a broadcasting sound, voices or the like by using only the bone-conducting auditory system with the bone-conducting headphone 956.

### Forty-Third Preferred Embodiment

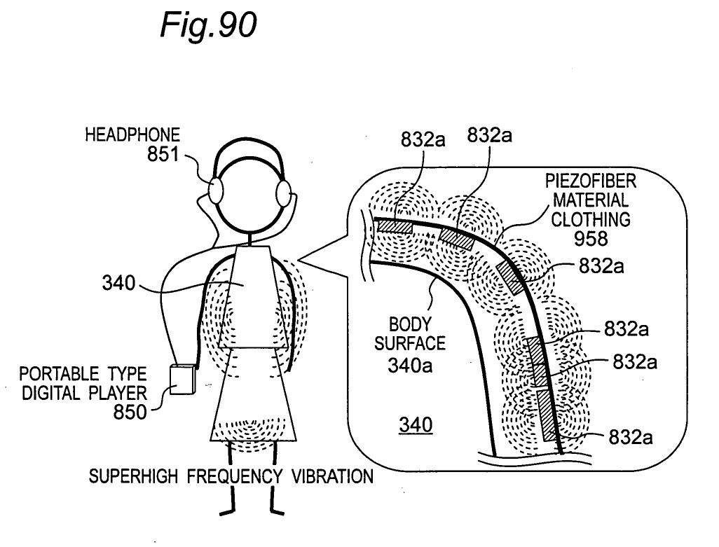

FIG. 90 is an appearance diagram and a sectional view of a piezoelectric fiber material clothing type superhigh frequency vibration presenting system according to the forty-third preferred embodiment of the present invention. In the forty-third preferred embodiment, the superhigh frequency vibration can be applied to the human body (excluding the head) extremely effectively by wearing a clothing 958 utilizing a piezoelectric fiber material that has a piezoelectric effect on the body (excluding the head). A superhigh frequency vibration signal, which is stored in a memory or received wirelessly or by a cable or externally inputted, is amplified by a microamplifier or the like and reproduced as a superhigh frequency vibration through a high frequency emitter 832a of the piezoelectric fiber woven into the material of the clothing, making it possible to effectively apply the superhigh frequency vibration to the human body (excluding the head) of the wearer of the clothing. In this case, the wearer can effectively enjoy the hypersonic effect by an interaction with the high frequency supra-perceptive vibration to the human body even when listening to a sound falling within the audible range frequencies by using a headphone 851 or the like or receiving a vibration perceived as a sound by the air conduction auditory system including the head by using a full-range speaker (not shown) or the like.

### Implemental Examples of Vibration Application Portion and Vibration Applying Apparatus

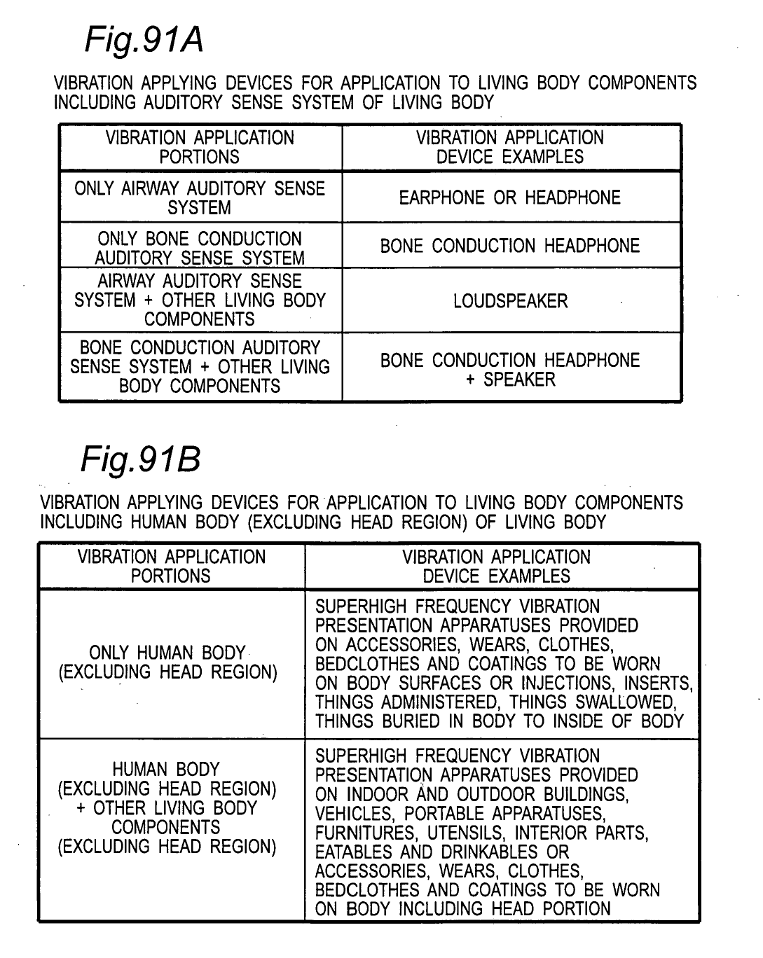

FIGS. 91A and 91B are views showing vibration application portions to which vibration is to be applied by each vibration applying apparatus according to the present invention and vibration applying apparatus examples corresponding to them.

Referring to FIG. 91A, the vibration applying apparatus applies a vibration that has a frequency component in the audible range perceived as a sound by the auditory sense system of the living body to living body component regions including the auditory sense system of the living body. Although the vibration application portion is mainly only the air conduction auditory system or only the bone-conducting auditory system, the vibration may be applied to other living body component regions in addition to them. On the other hand, referring to FIG. 91B, the vibration applying apparatus applies a vibration having a superhigh frequency component exceeding the audible range that is not perceivable as a sound by the auditory sense system of the living body to living body component regions (excluding the head) including at least part of the body (excluding the head) of the living body. Although the vibration application portion is mainly only at least part of the body (excluding the head), the vibration may be applied to other living body component regions (excluding the head) in addition to it. In the most preferable embodiment, according to the measurement results of FIG. 83, by applying the vibration that has the frequency component within the audible range perceived as a sound by the auditory sense system of the living body to the living body component regions including the auditory sense system of the living body and simultaneously applying the vibration that has the superhigh frequency component exceeding the audible range unperceivable as a sound by the auditory sense system of the living body to at least part (including body surfaces or skins of the hands and feet, such as only the chest, only the back, only the palm or the like) of the body (excluding the head) of the living body, the hypersonic effect can be effectively enjoyed by the mutual interaction of the two kinds of vibrations.

Although the test human subject 12 is a human being in each of the preferred embodiments described above, the subject may be a living body such as an animal. Moreover, it is acceptable to integrally form the apparatuses according to the preferred embodiments described above at need or to form them as an identical apparatus or an identical system.

### INDUSTRIAL APPLICABILITY

As described in detail above, the vibration presenting system of the present invention includes a first vibration applying device for applying a vibration that is generated by a first vibration source and has frequency components within the audible range perceivable as a sound by the auditory sense system of the living body to the auditory sense system of the living body, and a second vibration applying device for applying a vibration that is generated by a second vibration source different from the first vibration source and has superhigh frequency components exceeding the audible range unperceivable by the auditory sense system of the living body to a living body component region other than the auditory sense system of the living body. By presenting the two kinds of vibrations preferably simultaneously to the living body by using the two vibration applying devices, a hypersonic effect can be effectively enjoyed by the mutual interaction.

Moreover, the vibration presenting system of the present invention includes a first vibration applying device for applying a vibration that has frequency components within the audible range perceivable as a sound by the auditory sense system of the living body to living body component regions including the auditory sense system of the living body, and a second vibration applying device for applying a vibration that has superhigh frequency components exceeding the audible range that is unperceivable as a sound by the auditory sense system of the living body to living body component regions (excluding the head) including at least part of the body (excluding the head) of the living body. By presenting the two kinds of vibrations preferably simultaneously to the living body by using the two vibration applying devices, a hypersonic effect can be effectively enjoyed by the mutual interaction.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A vibration presenting system comprising:
a first vibration applying device for applying a vibration that is generated by a first vibration source and has frequency components within an audible range perceivable as a sound by an auditory sense system of a living body to the auditory sense system of the living body; and
a second vibration applying device for applying a vibration that is generated by a second vibration source different from the first vibration source and has superhigh frequency components exceeding the audible range unperceivable by the auditory sense system of the living body to a living body component region other than the auditory sense system of the living body.

2. The vibration presenting system as claimed in claim 1,
wherein the living body component region other than the auditory sense system of the living body is a body surface of the living body.

3. The vibration presenting system as claimed in claim 2,
wherein the body surface of the living body includes a head of the living body.

4. The vibration presenting system as claimed in claim 1,
wherein a cerebral blood flow of the fundamental brain, which is a region in charge of fundamental functions of a brain including a brain stem, a thalamus and a hypothalamus of the living body, increases when the vibration that has the frequency components within the audible range is applied by the first vibration applying device to the auditory sense system of the living body and applying the vibration that has the superhigh frequency components exceeding the audible range is applied by the second vibration applying device to the living body component region regions other than the auditory sense system of the living body, as compared with such a case that no vibration is applied by the first vibration applying device and the second vibration applying device, and
while the cerebral blood flow of the fundamental brain of the living body is lowered when the vibration that has the frequency components within the audible range is applied by the first vibration applying device to the auditory sense system of the living body and the vibration that has the superhigh frequency components exceeding the audible range is not applied by the second vibration applying device to the living body component region other than the auditory sense system of the living body, as compared with such a case that no vibration is applied by the first vibration applying device and the second vibration applying device.

5. The vibration presenting system as claimed in claim 1,
wherein the first vibration applying device applies an distinct vibration to a plurality of living bodies, and the second vibration applying device applies a common vibration to the plurality of living bodies.

6. The vibration presenting system as claimed in claim 1,
wherein the second vibration applying device simultaneously applies a plurality of kinds of vibrations.

7. The vibration presenting system as claimed in claim 1,
wherein the second vibration applying device is provided at one of indoor and outdoor buildings, vehicles, portable equipments, accessories, wears, clothes, bedclothes, furniture, utensils, interior parts, eatables and drinkables, coatings, injections into a body, inserts into a body, things administered into a body, things swallowed into one of a body, and things embedded in a body.

8. The vibration presenting system as claimed in claim 1,
wherein the second vibration applying device applies the vibration to the living body via a prescribed medium in one of a direct manner and an indirect manner.

9. The vibration presenting system as claimed in claim 1,
wherein at least one of the first vibration source and the second vibration source generates a vibration on the basis of one of (a) one of data and a signal that is stored in a memory unit, and (b) one of data and a signal received from outside by one of a wireless line and a wired line.

10. The vibration presenting system as claimed in claim 1, further comprising:
a detecting and analyzing device for detecting the vibrations applied by the first vibration applying device and the second vibration applying device, analyzing structures of detected audible range frequency components and superhigh frequency vibration components, and outputting the analytical results; and
a first controlling device for judging a degree of risk of a decline in the cerebral blood flow of the fundamental brain of the living body, and then, performing one of outputting a warning on the basis of the judgment results, and controlling the first and second vibration applying devices.

11. The vibration presenting system as claimed in claim 1, further comprising:
a measuring device for measuring a responsive reaction of the living body that responds to the vibration applied to the living body by the first vibration applying device and the second vibration applying device;
an analyzing device for analyzing the responsive reaction measured by the measuring device and outputs the analytical result; and
a second controlling device for judging a degree of risk of a decline in the cerebral blood flow of the fundamental brain of the living body, and then, performing one of outputting a warning on the basis of the judgment results, and controlling the first and second vibration applying devices.

12. The vibration presenting system as claimed in claim 1,
wherein the first vibration applying device prevents a risk of a decline in the cerebral blood flow of the fundamental brain of the living body when a trouble occurs in the second vibration applying device by further generating at least a partial component of the vibration that has the superhigh frequency components exceeding the audible range and applying the component to the living body.

13. The vibration presenting system as claimed in claim 1,
wherein the second vibration applying device allows the living body to recognize by auditory that a trouble has occurred in the second vibration applying device by further generating at least a partial component of the frequency components that have a frequency range in the audible range, thereby preventing a risk of a decline in the cerebral blood flow of the fundamental brain of the living body.

14. A vibration presenting system comprising:
a first vibration applying device for applying a vibration that has frequency components within an audible range perceivable as a sound by an auditory sense system of a living body to living body component regions including the auditory sense system of the living body; and
a second vibration applying device for applying a vibration that has superhigh frequency components exceeding the audible range unperceivable as a sound by the auditory sense system of the living body to living body component regions (excluding a head) including at least part of the body (excluding the head) of the living body.

15. The vibration presenting system as claimed in claim 14,
wherein activity of the fundamental brain, which is a region in charge of fundamental functions of a brain including a brain stem, a thalamus and a hypothalamus of the living body, is increased by applying the vibration that has the superhigh frequency components exceeding the audible range to at least part of the body (excluding the head) of the living body by the second vibration applying device.

16. The vibration presenting system as claimed in claim 14,
wherein the vibration applied by the first vibration applying device is generated by a first vibration source, and
wherein the vibration applied by the second vibration applying device is generated by a second vibration source different from the first vibration source.

17. The vibration presenting system as claimed in claim 14,
wherein the first vibration applying device applies distinct vibrations to a plurality of living bodies, and the second vibration applying device applies a common vibration to the plurality of living bodies.

18. The vibration presenting system as claimed in claim 14,
wherein the first vibration applying device applies a common vibration to a plurality of living bodies, and the second vibration applying device applies distinct vibrations to the plurality of living bodies.

19. The vibration presenting system as claimed in claim 14,
wherein the first vibration applying device applies distinct vibrations to a plurality of living bodies, and the second vibration applying device also applies distinct vibrations to the plurality of living bodies.

20. The vibration presenting system as claimed in claim 14,
wherein the second vibration applying device simultaneously applies vibrations comprised of a plurality of kinds of vibration sources.

21. The vibration presenting system as claimed in claim 14,
wherein the second vibration applying device is provided at one of indoor and outdoor buildings, vehicles, portable equipment, accessories, wears, clothes, bedclothes, furniture, utensils, interior parts, eatables and drinkables, coatings, injections into a body, inserts into a body, things administered into a body, things swallowed into a body, and things embedded in a body.

22. The vibration presenting system as claimed in claim 14,
wherein the second vibration applying device applies the vibration to the living body via a prescribed medium in one of a direct manner and an indirect manner.

23. The vibration presenting system as claimed in claim 14,
wherein at least one of the first vibration source and the second vibration source generates a vibration on the basis of one of (a) one of data and a signal that is stored in a memory unit, and (b) one of data and a signal received from outside by one of a wireless line and a wired line.
